(19) United States
(12) Patent Application Publication
(10) Pub. No.: US 2004/0216399 A1
(43) Pub. Date: Nov. 4, 2004

(54) Fixing apparatus

(75) Inventors: Keishi Yamada, Yohkaichi-shi (JP); Hiroto Masuda, Yohkaichi-shi (JP); Tetsuji Shirai, Yohkaichi-shi (JP)

Correspondence Address: HOGAN & HARTSON L.L.P., 500 S. GRAND AVENUE, SUITE 1900, LOS ANGELES, CA, 90071-2611, US

(73) Assignee: KYOCERA CORPORATION

(21) Appl. No.: 10/768,718

(22) Filed: Jan. 30, 2004

(30) Foreign Application Priority Data
Jan. 30, 2003 (JP) 2003-021239
Feb. 18, 2003 (JP) 2003-040326
Feb. 26, 2003 (JP) 2003-050048
Feb. 26, 2003 (JP) 2003-050058
Mar. 17, 2003 (JP) 2003-072356
Nov. 27, 2003 (JP) 2003-398221

(51) Int. Cl. E04D 13/18; E04H 14/00; H02N 6/00

(52) U.S. Cl. 52/173.1; 136/244

(57) ABSTRACT

There are included a base rail in an elongated shape fixed to the roof face, a holder supporting member movable in a longitudinal direction of the base rail by being guided by the base rail and a holder fixing member provided at the holder supporting member. Thereby, it is not necessary to accurately fix the base rail to the roof face. Further, the holder supporting member supports a holder for holding an object to be installed and presses a predetermined portion of the holder to the base rail by the holder fixing member. Thereby, fixing of the base rail and the holder supporting member and fixing of the holder supporting member and the holder can be achieved in one motion by one pressing member and the number of steps with regard to attaching the holder can be reduced.

### BACKGROUND OF THE INVENTION

1. Field of the Invention

The present invention relates to a fixing apparatus for installing an object to be installed of a solar cell module for generating power by utilizing solar energy, a solar heat collector utilizing solar heat or the like via a holder.

2. Description of the Related Art

In recent years, with intensified interest in the global environment problem, new energy technologies utilizing natural energies attract attention. As one of the technologies, interest in a system utilizing solar energy is intensified, particularly, spread of a solar power generation system to housings has been accelerated.

According to a solar power generation system, household electric load is reduced by converting solar energy into power to utilize by a solar cell panel constituting a principal constituent element thereof. In housings, a solar cell module is frequently arranged on a roof of a house to utilize and therefore, various structures of attaching a solar cell module on a roof have been devised.

FIG. 56 is a perspective view schematically showing a state of installing a solar cell module 103 on a roof by utilizing a fixing apparatus 110 of a first related art. FIG. 57 is an enlarged perspective view showing a section S1 of FIG. 56. FIG. 58 is a sectional view schematically showing a state of installing the fixing apparatus 110 of the first related art on a tile-roofing 118 and FIG. 59 is a perspective view showing a fixing metal piece 124.

When the solar cell module 103 is fixed to a roof face by using the fixing apparatus 110 of the first related art, an operator firstly fixes a longitudinal piece 101 on the roof and installs a crosspiece 102 thereon. Next, the operator attaches the solar cell module 103 to the crosspiece 102 by a bolt 104.

Specifically when the operator attaches the crosspiece 102 on the longitudinal piece 101, first, the operator attaches a plurality of the longitudinal pieces 101 to fixing metal pieces 124 provided on the roof along a direction x of inclination of the roof. Next, the operator arranges the cross piece 102 orthogonally onto the plurality of longitudinal pieces 101 and fixes the crosspiece 102 to the longitudinal piece 101 by a crosspiece fixing metal piece 125 by using a screw hole 112 or a through hole provided at the longitudinal piece 101. A plurality of screw holes 113 for screwing the solar cell module 103 or through holes are provided on the crosspiece 102 and the solar cell modules 103 are fixed to respective mounting positions.

However, according to the method of the related art, a hole 114 or the like needs to be installed on the side of the solar cell module and there poses a problem that a frame of the solar cell module 103 is difficult to downsize. Further, since the solar cell modules 103 are attached individually, there are a number of fixing portions of the bolts 104 or the like and a number of operational steps is large.

Hence, there has been proposed a method of capable of downsizing the solar cell module 103 and reducing the number of attaching operational steps by attaching two of the solar cell modules 103 over adjacent two of holders 102 arranged at equal intervals in a direction Y orthogonal to a direction X of inclination of the roof referred to as a crosspiece or a transverse holder (refer to, for example, Japanese Unexamined Patent Publication JP-A 2001-144314).

Further, there has been proposed an attaching apparatus and an attaching method capable of easily dealing with various existing roofs, facilitating to deal with rain and facilitating to position in fixing (refer to, for example, Japanese Unexamined Patent Publication JP-A 11-2011).

There has also been proposed a technology of providing solar cell module inserting portions formed in a substantially U-like shape at crosspieces attached on a roof face in parallel and at constant intervals and inserting solar cell modules each of which is not provided with a frame or is provided with a comparatively simple frame to thereby make the frame portions light-weighted (refer to, for example, Japanese Unexamined Patent Publication JP-A 2002-4526).

Further, both of the holder and the solar cell module need to be subjected to a grounding processing and when longitudinal pieces made of a metal are not used, in order to ground the holder and the solar cell module, electric conduction of the crosspieces must be carried out by some method.

Hence, there has been proposed a method of providing a conductive member for grounding to a frame of a solar cell panel and providing coating breaking means for breaking an insulating coating formed on a surface of the frame to achieve electric contact with the conductive member (refer to, for example, Japanese Unexamined Patent Publication JP-A 2000-286438).

The fixing apparatus disclosed in JP-A 2001-144314 is fixed on the roof by fixing metal pieces individually arranged on the roof member and fixed on the roof. The fixing apparatus solidly fixes the solar cell module on the pieces by pinching end portions of the solar cell module mounted over a plurality of the crosspieces by the crosspieces and outer side pinching members. In this case, although a number of steps of fixing to screw the solar cell module can be reduced, the longitudinal pieces 101 as shown in FIG. 56 are not used and therefore, the fixing apparatus is not suitable for being installed on a wavy tile 118 as shown in FIG. 58. This is because an interval of arranging the fixing metal pieces 124 attached to the tile-roofing does not necessarily coincide with a width of the solar cell module 103.

FIG. 60 is an exploded perspective view showing a fixing apparatus 120 of a second related art. According to the fixing apparatus 120 of the second related art, a fixing metal piece 124 and a holder holding portion 116 are used in place of a longitudinal piece. The holder holding portion 116 is provided with a slit 115 for inserting a fixing bolt 124a of the fixing metal piece 124 and a position of a crosspiece 117 constituting a holder can be adjusted by a width of the slit 115. In this case, even on a roof having a stepped difference as in the wavy tile 118 or a slate tile, by moving the position of fixing the crosspiece 117, the interval can be made to coincide with the width of the solar cell module 103, however, in fixing the fixing metal piece 124 and the holder holding member 116, a nut 119 fitted to the fixing bolt 124a is used, further, in fixing the crosspiece 117 constituting the holder to the holder holding member 116, another fixing bolt 121 is used and therefore, the structure is complicated and a number of steps of installing the holder is large. Further, the position of the cross piece 117 can be adjusted only by the short slit width and therefore, in fixing the fixing apparatus 120 on the roof face, accuracy of positioning is needed and there also poses a problem that when the accuracy is poor, the positioning of the fixing apparatus 120 needs to carry out again.

FIG. 61 is a view schematically showing a state of installing the solar cell module 103 on the roof by using the fixing apparatus 120 of the second related art. FIG. 62 is a partial enlarged perspective view of FIG. 61. FIG. 63A is a view schematically showing a first example of installing the solar cell module 103 on the roof by using the fixing apparatus 120 of the related art. FIG. 63B is a view schematically showing a second example of installing the solar cell module 103 on the roof by using the fixing apparatus 120 of the related art. FIG. 63C is a view schematically showing a third example of installing the solar cell module 103 on the roof by using the fixing apparatus 120 of the related art. FIG. 63D is a view schematically showing a fourth example of installing the solar cell module 103 on the roof by using the fixing apparatus 120 of the related art.

According to the fixing apparatus 120 of pinching end portions of the solar cell module 103 as in the second related art, when the end portions are arranged on holder holding members 116, as shown in FIG. 62, there is brought about a portion which cannot fit the solar cell module 103 at a crosspiece 117 by covering a groove portion 123 of the crosspiece 117 by the crosspiece fixing metal piece 125 and as shown in FIG. 61, when there is constituted a solar cell array 127 arranged with a number of the solar cell modules 103 on the roof, the array is amounted thereon such that a clearance is present at a portion of the crosspiece fixing metal piece 125 and an appearance of the roof of the house is deteriorated.

This is particularly conspicuous in arranging the solar cell modules 103 on the roof in a trapezoidal shape, a triangular shape, a shape of a parallelogram or in arranging to combine the solar cell modules 103 having different lengths as shown in FIGS. 63A through 63D. Specifically, when the solar cell modules 103 are mounted on the roof in the trapezoidal shape as shown in FIG. 63A, the solar cell module 103 cannot be mounted on the crosspiece fixing metal piece 25 for fixing the cross piece 117 to the holder holding members 116 and therefore, an appearance of stripping the holder holding members 116 is constituted and further, an area capable of installing the solar cell module 103 is reduced by an area of the roof of the holder holding members 116 as an area which cannot generate power.

Further, although at row b of cross alignment of the solar cell modules 103, as roof area, 3 sheets of the solar cell modules 103 can be mounted, the solar cells 103 cannot be fixed to fit to the crosspieces 117 by riding over the holder holding members 116 and therefore, only 2 sheets thereof can be mounted and the area of capable of installing the solar cell modules 103 on the roof is reduced.

Further, as shown in FIG. 63B, in the case of the roof in the triangular shape, not only row b cannot mount 3 sheets of the solar cell modules 103 but also a space of the roof capable of mounting another sheet above row a is not utilized.

In the case of the roof in the shape of the parallelogram of FIG. 63C, although it is preferable to mount the solar cell modules 103 by respectively shifting rows a through e of the solar cell modules 103 in accordance with an inclination of an inclined side of the roof, the alignment cannot deal therewith.

Further, as shown in FIG. 63D, the above-described problem is posed similarly when the solar cell modules 103, 105 having different sizes are used and it is hampered to constitute an area capable of generating power by an area on the roof or constitute an appearance in accordance with the shape of the roof by inherently mounting to combine the solar cell modules variously.

Further, according to the above-described technologies, it is necessary to previously determine a position of installing the fixing metal piece 124 or the crosspiece 117 and construct the fixing metal piece 124 or the crosspiece 117 in accordance with a positioned position, accuracy of positioning effects a significant influence on later construction, which occasionally brings about time and labor of being obliged to correct a position of the fixing apparatus 120.

Hence, in view of the problems of the related arts, a feature of the invention is to provide a fixing apparatus having a simple structure and reducing a number of steps of fixing and in fixing the fixing apparatus to a building, to dispense with accuracy of positioning and therefore, to eliminate time and labor in correcting a position of the fixing apparatus.

Further, a feature thereof is to be able to alleviate accuracy of attaching a fixing metal piece on a roof such that a position to be arranged with a longitudinal piece is not influenced by a position of the fixing metal piece.

Further, according to the technology disclosed in JP-A 2002-4526, although the solar cell module can be made to be light-weighted since total rigidity is maintained by the crosspiece, since the solar cell module is inserted from an end portion of the roof face, it is necessary to move the solar cell module to a position of installing the solar cell module and a number of steps is increased.

Further, there is a case in which the end portion of the solar cell module is caught by the crosspiece and the operation is difficult to carry out and there also is a concern of destructing the solar cell module.

Further, after arranging the solar cell modules, a specific one of the solar cell module cannot be attached or detached and therefore, in electric wiring in construction or in maintenance, all of the solar cell modules aligned laterally need to shift and a number of steps is required therefor.

Therefore, it is other object of the invention to provide a fixing apparatus facilitating operation of arranging the fixing apparatus on an inclined face, facilitating construction operation by reducing a number of steps of operation and sufficiently ensuring safety.

Further, according to the technology disclosed in JP-A 2000-286438, a new part for grounding needs to provide, a number of parts is increased and further, operation of attaching the part is needed and a number of steps is increased. Particularly, it is very troublesome to attach a small part on the roof and a construction time period is prolonged. Further, the technology brings about a factor of causing an accident of slip and drop of parts and tools.

Therefore, still other feature of the invention is to provide a fixing apparatus constituted by a grounded structure facilitating arranging operation on the roof, having a small number of operational steps and simplifying construction operation without increasing a number of parts.

### SUMMARY OF THE INVENTION

The invention provides a fixing apparatus for fixing an object to be installed which is installed to a building, comprising:

a base connected to the building and formed in an elongated shape;

a support member formed to be movable in a first direction constituting a longitudinal direction of the base by being guided by the base;

a holder formed to be movable in a second direction intersecting with the first direction by being guided by the support member, for holding the object to be installed; and

a displacement hampering member capable of hampering displacement of the support member relative to the base and displacement of the holder relative to the support member.

According to the invention, by arranging the support member above the base in a state of being movable in the longitudinal direction of the base, also the holder supported by the support member can be moved along the longitudinal direction. Thereby, when a base point is determined in attaching the object to be installed, for example, a solar cell module, all of attachment thereafter can be carried out by gauging and accuracy of positioning the base can be alleviated and a number of operational steps can significantly be reduced.

Further, according to the invention, as described above, after fixing the base to the building, a position of the holder can be adjusted in the first direction and the second direction intersecting with the first direction. Thereby, it is not necessary to accurately position the position of fixing the base relative to the building. Further, regardless of the position of fixing the base, the position of the holder can be adjusted. Thereby, operation of fixing the base at the building can be simplified. For example, when the building is a roof and the object to be installed is a solar cell module, by simplifying the operation of fixing the base at the roof face, the operation of fixing the solar cell module above the roof can be simplified.

Further, in the invention, the displacement hampering member fixes the holder to the base by pressing a portion of the holder against the base.

Further, in the invention, the displacement hampering member is connected to the support member and the holder is pinched by the base and the support member by pressing a portion of the holder against the base.

According to the invention, the support member supports the holder mounted to the base, the holder can be fixed to the base by the displacement hampering member provided at the support member and therefore, both of the holder and the support member can be fixed to the base in one motion by fastening a single one of the displacement hampering member. Thereby, a number of steps in attaching the holder can be reduced. Further, since the support member is made to be movable in the longitudinal direction of the base by being guided by the base in the elongated shape fixed to the building, a position of the holder in the longitudinal direction can be adjusted in a wide range. Thereby, in fixing the base to the building, accuracy of positioning is not needed and therefore, time and labor in correcting the position of the base is not needed.

Further, according to the invention, a friction force can be generated between the portion of the holder and the base by the displacement hampering member. Thereby, the displacement of the holder relative to the base can be hampered. Thereby, a structure of fixing the holder and the support member can be made to serve also as a structure of fixing the support member and the base and the structure of the fixing apparatus can be simplified. Further, time and labor in positioning the holder can be reduced.

Further, according to the invention, when the holder is positioned, also the support member for guiding the holder is moved in the first direction. At this occasion, the displacement hampering member is moved along with movement of the holder since the displacement hampering member is connected to the support member. Therefore, it is not necessary to position the displacement hampering member relative to the holder and fixing of the holder and the base can further easily be carried out.

Further, in the invention, peripheral edge portions on both sides of the object to be installed can respectively be held by two of the holders respectively provided with an interval therebetween.

According to the invention, the object to be installed can further firmly be fixed by holding the peripheral edge portions on the both sides of the object to be installed by the holders. Further, as described above, the positions of the holders can be adjusted and therefore, it is possible that in the two holders holding the both sides of the object to be installed, a first base connected with a first holder and a second base connected with a second holder are temporarily fixed to the building and in a state of fixing the first holder to the first base, the second holder can be fixed to the second base in accordance with a width of the peripheral edge portions of the object to be installed which is to be held. Thereby, even when the peripheral edge portions on the both sides of the object to be installed are held by the two holders in this way, a position of the second holder relative to the first holder can be adjusted and therefore, it is not necessary to accurately adjust the position of the second base.

Further, in the invention, the fixing apparatus further comprises an installed object fixing member capable of fixing the object to be installed to the holder.

According to the invention, the object to be installed is fixed to the holder by the installed object fixing member. Thereby, the object to be installed can further firmly be fixed to the building. For example, the installed object fixing member is realized by including a cover member for pinching the object to be installed in cooperation with the holder. Further, it is not necessary to form a bolt hole or the like of fixing the object to be installed to the holder and the object to be installed can be constituted by a small-sized and light-weighted formation.

Further, in the invention, the fixing apparatus further comprises an installed object fixing member for fixing the object to be installed to the holder, wherein the fixing member comprises a cover member brought into contact with the object to be installed from a side opposed to the holder and a pressing member for pressing the cover member to the holder.

According to the invention, by pressing the cover member to the holder by the pressing member, the object to be installed which is to be held by the holder is fixed. The pressing member is realized by, for example, a screw member.

Further, in the invention, the holder is formed with a mounting portion for mounting the object to be installed and a connecting portion provided on a side of the building of the mounting portion and connected to the support member.

According to the invention, the connecting portion is formed on the side of the building of the mounting portion, for example, on a lower side thereof. Thereby, the holder is not formed with a portion of hampering the holder from being mounted owing to formation of the connecting portion and the object to be installed can be mounted over an entire face of the mounting portion. Therefore, a number of the objects to be installed which can be arranged to the building can be increased.

Further, according to the invention, since the holder is constituted by the structure of being attached onto the base by the support member, a solar cell module can be mounted on the holder without closing an opening portion of the holder to be inserted with the solar cell module and an exposed clearance is not produced between the solar cell modules and an appearance of the roof is not deteriorated. Further, an area of the roof by an amount of a clearance by the base is not eliminated from an area capable of being utilized for solar power generation. Further, the solar cell modules can be mounted by being shifted for respective rows in accordance with a shape of the roof in, for example, a trapezoidal shape, a triangular shape, or a shape of a parallelogram and therefore, various arrangements of the solar cell modules can be selected and a rate of an area capable of carrying out solar cell power generation in the same installing face can be promoted. Further, even in a case of arranging to use solar cell modules having different sizes, the case can easily be dealt with.

Further, even in a case of arranging a number of the holders on the base as in a case of constituting a solar cell array using a number of small-sized solar cell modules, since the support member can be moved, the case can deal with arrangement of the holders by any interval (an irregular arrangement having different intervals can be dealt with) and any number of pieces further, since a number of steps of fixing the holders, the displacement hampering members and the solar cell modules is small, an effect of reducing a number of steps of construction is enormous in comparison with those of construction methods of the related arts.

In the invention, the support member is formed with a supporting-member engaging portion in a rail-like shape extended in the second direction, the holder is formed with a holder engaging portion in a rail-like shape provided on a side of the building thereof and engaged with the supporting-member engaging portion and the supporting-member engaging portion and the holder engaging portion are engaged with each other.

Further, according to the invention, the supporting-member engaging portion of and the holder engaging portion are extended in the second direction and engaged with each other. Thereby, the holder is made movable in the second direction in a state of hampering displacement thereof in the first direction relative to the support member.

In the invention, the base comprises a base fixing portion fixed to the building, a base moving portion provided to be movable in the first direction relative to the base fixing portion by being guided by the base fixing portion and connecting the support member, and a base coupling portion capable of hampering displacement of the base moving portion relative to the base fixing portion.

Further, according to the invention, by providing the base fixing portion such that the base moving portion of the base can be moved in the longitudinal direction of the base fixing portion and providing the base coupling portion for hampering displacement between the base fixing portion and the base moving portion, in construction, by temporarily fixing the base fixing portion and the base moving portion, attaching the holder to the base moving portion and thereafter fixing the base fixing portion and the base moving portion by the base coupling portion, positioning at the building can be carried out by moving the holder along with the base moving portion. Thereby, accuracy of positioning the base moving portion is not needed and the construction operation is further simplified. Further, according to the method, also positioning of the base fixing portion relative to the building is not needed.

The invention provides a fixing apparatus for fixing an object to be installed which is installed to a building, comprising:

a base connected to the building;

a holder directly or indirectly connected to the base and mounting the object to be installed;

a cover member pinching the object to be installed in cooperation with the holder;

a screwing member formed to be screwable to the holder for generating a press force for pressing the cover member to the holder by screwing to the holder; and

an interval adjusting member for screwing to retract the screwing member from the holder and moving the cover member to separate from the holder.

According to the invention, even in the case of an object to be installed using a light and thin member for a frame member, for example, a solar cell module, rigidity thereof can be maintained in a state of being attached to the holder. Further, construction operation of an object to be installed, for example, the solar cell module is simplified and attachment and detachment thereof can easily be carried out. Further, even in the case of the solar cell module using a light and thin member for a frame member, the module is not slipped to drop in temporary installation and construction operation can safely be carried out.

In the invention, the interval adjusting member maintains an interval between the cover member and the holder before pressing the cover member by the screw member wider than an interval therebetween after pressing the cover member.

According to the invention, the screw member is screwed to the holder and the cover member is pressed by screwing to the holder. Thereby, the cover member fixes the object to be installed by pressing the object to be installed against the holder. Further, when the screw member is screwed to retract from the holder, the cover member is separated from the holder by screwing to retract the screw member. Thereby, when the object to be installed is removed from the holder, the interval between the holder and the cover member is increased and therefore, operation of removing the object to be installed can easily be carried out.

In the invention, the interval adjusting member comprises a spring member exerting a force in a direction opposed to a direction of the press force on the cover member.

According to the invention, the interval adjusting member can be realized by the spring member provided between the cover member and the holder.

Further, in the invention, the cover member is formed with a contact portion brought into contact with the object to be installed mounted on the holder in a state of separating from the holder to restrain the object to be installed from moving.

According to the invention, even when the cover member is brought into the state of being separated from the holder, the contact portion of the cover member is brought into contact with the object to be installed mounted on the holder. Thereby, the object to be installed which is mounted on the holder can be hampered from being moved unintentionally and in a temporarily fixing stage, the object to be installed can be prevented from being detached from the holder.

Further, according to the invention, the object to be installed, for example, the solar cell module can easily be attached and detached and even when it is necessary to remove the solar cell module for wiring check, maintenance or the like in the temporary installation state, operation can easily be carried out.

In the invention, the interval adjusting member is brought into contact with both of the holder and the cover member to electrically connect the holder and the cover.

According to the invention, by providing the interval adjusting member with a function of electrically conducting the holder and the cover member, the holder and the cover member can be maintained in a conductive state without newly providing an exclusive member and therefore, by grounding only the holder, the cover member can also be grounded.

Further, the invention provides a fixing apparatus for fixing an object to be installed which is installed to a building, comprising:

a base connected to the building;

a holder directly or indirectly connected to the base for mounting the object to be installed;

a cover member for pinching the object to be installed in cooperation with the holder; and

a screw member formed to be screwable to the holder for generating a press force for pressing the cover member to the holder by screwing to the holder,

wherein the cover member is mounted to the holder in a temporarily fixing state of capable of temporarily fixing the object to be installed in cooperation with the holder.

According to the invention, by temporarily fixing the object to be installed by the cover member, the object to be installed can be prevented from being detached from the holder in the temporarily fixing stage, the operation of installing the object to be installed to the building can easily be carried out.

Further, in the invention, in a state of being formed to be able to pinch two of the objects to be installed respectively on both sides in a vertical direction by the holder and the cover member and holding the two objects to be installed, the holder is formed with a lower side mounting face for mounting an upper side peripheral edge portion of the lower side object to be installed disposed on a lower side, an upper side mounting face mounting a lower side peripheral edge portion of the upper side object to be installed disposed on an upper side and provided to be higher than the lower side mounting face, and a screw forming portion rising above the lower side mounting face continuously from the upper side mounting face and formed with a screw hole for screwing to a screw member, the cover member is formed with a lower side press piece for pressing the upper side peripheral edge portion of the lower side object to be installed from an upper side and an upper side press piece for pressing the lower side peripheral edge portion of the upper side object to be installed from the upper side and provided on an upper side of the lower side press piece, and the cover member can be fixed to the holder by pressing the lower side press piece against the lower side mounting face of the holder by a front end portion of the screw member in a state of capable of mounting the peripheral edge portions of the respective objects to be installed to the respective mounting faces of the holder, when a state of fixing the cover member is released by loosening the screw member, and the peripheral edge portions of the objects to be installed can be brought into a state of being able to be pressed by the cover member and the peripheral edge portions of the objects to be installed can be pressed by the cover member by fastening the screw member in the pressable state.

According to the invention, the objects to be installed and the cover member are integrated by the screw member previously on the ground, on the building, the objects to be installed can be fixed to the holder from the integrated state by a very small amount of operation and therefore, an amount of operation in fixing the objects to be installed to the holder on the building having a gradient, for example, the roof is reduced and operability and safety can be promoted.

Further, in the invention, the cover member is formed with a stopper portion for positioning the object to be installed.

Further, according to the invention, a positional shift of the object to be installed can be prevented by the stopper portion.

Further, in the invention, the screw member is formed with an unscrewed groove forming portion interposed by screwed groove forming portions in a front and rear direction.

According to the invention, the screw member is formed with the unscrewed groove forming portion interposed by the screwed groove forming portions in the front and rear direction and therefore, the unscrewed groove forming portion constitutes a stopper against loosening and loosening of the screw member by being detached from the holder can be prevented.

In the invention, a front end portion of the screw member is formed to be larger than a remaining portion in a state of being screwed to the holder.

According to the invention, the front end portion of the screw member is formed to be large and therefore, the screw member can be prevented from being detached from the holder.

In the invention, the peripheral edge portions on the both sides of the object to be installed are respectively held by two of the holders respectively provided with an interval therebetween.

According to the invention, by holding the peripheral edge portions of the object to be installed by the holders, the object to be installed can further firmly be fixed.

The invention provides a fixing apparatus for fixing an object to be installed which is installed to a building, comprising:

a base connected to the building;

a guide member provided to be able to angularly displace around a predetermined angular displacement axis line relative to the base; and

a holder formed to be movable by being guided by the guide member, for holding the object to be installed.

In the invention, when the holder is guided by the guide member while maintaining a position of the holder, by angularly displacing the base relative to the guide member around the angular displacement axis line, a position of fixing the base relative to the building can arbitrarily be determined.

According to the invention, by enabling to angularly displace the guide member around the angular displacement axis line relative to the base, without removing the base from the holder and maintaining the position of the holder, in accordance with a situation of the building, a position for attaching the fixing apparatus can be adjusted. Further, a number of parts is small to construct a simple constitution and therefore, the apparatus can be fabricated inexpensively, a number of attaching steps can be reduced and since the apparatus is light-weighted, the apparatus is easy to handle even above the roof and safe operation can be carried out.

In the invention, a position of fixing the building and the base is changed between before and after pivoting the base by 180 degrees around the angular displacement axis line relative to the guide member.

According to the invention, two of fixing arrangements can be selected without changing the longitudinal direction of the base. Therefore, another fixing portion can be selected by avoiding an inconvenient fixing position without changing an optimum direction of the base for fixing the holder.

In the invention, the angular displacement axis line is provided at a position other than a middle position in the longitudinal direction of the base.

According to the invention, by angularly displacing the base relative to the holder, the fixing position at which the base is fixed to the building can be changed.

In the invention, the base is provided with a pressing member for restricting displacement of the holder relative to the guide member by pressing the holder and the guide member when an angle made by the longitudinal direction of the base and the longitudinal direction of the holder is shifted by a predetermined angle or more.

According to the invention, the holder is pressed against the guide member to fix the holder by only shifting the angle made by the longitudinal direction of the base and the longitudinal direction of the holder by the predetermined angle or more and therefore, the holder can be fixed very simply and conveniently.

Further, in the invention, the fixing apparatus further comprises a pressing member for restricting displacement of the holder relative to the guide member by pressing the holder and the guide member when an angle made by the longitudinal direction of the base and the longitudinal direction of the holder is shifted by a predetermined angle or more, wherein the pressing member is interposed between the base and the guide member and when the pressing member is moved by the predetermined angle relative to the longitudinal direction of the holder, the holder is fixed to the guide member.

Further, in the invention, the fixing apparatus further comprises a pressing member for restricting displacement of the holder relative to the guide member by pressing the holder and the guide member when an angle made by the longitudinal direction of the base and the longitudinal direction of the holder is shifted by a predetermined angle or more, wherein the pressing member is interposed between the base and the support member and when the pressing member is moved in a predetermined direction relative to the holder, the holder is fixed to a guide member.

According to the invention, the structure of the guide member is simplified by using the pressing member in the plate-like shape having the simple structure. Therefore, the apparatus can be fabricated inexpensively, a number of attaching steps can be reduced and since the apparatus is light-weighed, the apparatus is easy to handle even above the roof and safe operation can be carried out.

Further, in the invention, the fixing apparatus further comprises a pressing member for restricting displacement of the holder relative to the guide member by pressing the holder and the guide member when an angle made by the longitudinal direction of the base and the longitudinal direction of the holder is shifted by a predetermined angle or more, wherein the pressing member is formed with a projected streak portion.

Further, in the invention, the fixing apparatus further comprises a pressing member for restricting displacement of the holder relative to the guide member by pressing the holder and the guide member when an angle made by the longitudinal direction of the base and the longitudinal direction of the holder is shifted by a predetermined angle or more, wherein the pressing member is interposed between the base and the guide member and is formed with a projected streak portion.

According to the invention, the holder rides over the projected streak portion in accordance with mutual predetermined movement between the holder and the base or between the holder and the pressing member. As a result, the holder is pressed by the guide member to fix the holder. According to the constitution, the structure becomes extremely simple and therefore, a number of parts is small, the apparatus can inexpensively be fabricated, a number of attaching steps can be reduced, since the apparatus is light-weighted, the apparatus is easy to handle even above the roof and safe operation can be carried out.

Further, in the invention, the peripheral edge portions on the both sides of the object to be installed are respectively held by two of the holders respectively provided with an interval therebetween.

According to the invention, the object to be installed can solidly be arranged above the roof in accordance with a situation of the building.

Further, in the invention, the fixing apparatus further comprises a side face cover member for covering side faces of the object to be installed and the holder, wherein the side face cover member is brought into contact with the object to be installed to ground the object to be installed.

According to the invention, by providing an electrically conductive side face member made of a metal attached at the end portions of the holders for grounding the object to be installed over to a plurality of the holders in a direction orthogonal to the holders, an appearance of a solar power generation apparatus and the roof installed therewith is promoted and even when a frame of the object to be installed comprises a nonconductive material, the object to be installed can be grounded.

Further, by closing a clearance between the solar power generation apparatus and the roof face by the side face member made of a metal, birds can be prevented from invading under the object to be installed and noise or stain can be prevented from being brought about.

Further, the invention provides an object to be installed which is installed to a building, comprising: a portion brought into contact with a holder, which portion is formed to be electrically conductive and is held by the holder of any one of the above-mentioned fixing apparatuses.

According to the invention, the object to be installed is formed to be brought into contact with the holder and be electrically conductive and therefore, it is not necessary to separately provide a wiring for grounding.

Further, the invention provides a solar cell module installed to a building, comprising:

a solar cell main body; and

a metal frame mounted to a peripheral edge portion of the solar cell main body,

wherein the metal frame makes the solar cell module and a holder conductive to each other by being brought into contact with a portion installed with the holder of any one of the above-mentioned fixing apparatuses and a surface thereof excluding a face thereof on a side of being brought into contact with the holder is covered with an insulating coating.

According to the invention, the face of the metal frame on the side of being brought into contact with the holder is formed in a stepped shape, at least the surface excluding the face of the metal frame on the side of being brought into contact with the holder is covered with the insulating coating and therefore, there can be provided a simple and convenient solar power generation apparatus capable of dispensing with attachment of a new part for grounding and a part on a roof, facilitating arranging operation on the roof and having a small number of operational steps.

The invention provides a fixing apparatus for fixing an object to be installed which is installed to a building, comprising:

a base connected to the building and formed in a shape of an elongated rail;

a support member formed to be movable in a first direction previously determined at the base by being guided by the base;

a holder formed to be movable in a second direction intersecting with the first direction by being guided by the support member, for holding the object to be installed;

a displacement hampering portion for hampering displacement of the support member relative to the base and displacement of the holder relative to the support member;

a cover member for pinching the object to be installed in cooperation with the holder;

a screw member formed to be screwable to the holder for generating a press force for pressing the cover member to the holder by screwing to the holder; and

an interval adjusting member for screwing to retract the screw member from the holder and moving the cover member to separate from the holder.

According to the invention, after fixing the base to the building, the position of the holder can be adjusted in the first direction and the second direction intersecting with the first direction. Thereby, it is not necessary to accurately position the fixing position of the base relative to the building. Thereby, the operation of fixing the base at the building can be simplified. For example, when the building is the roof and the object to be installed is the solar cell module, by simplifying the operation of fixing the base at the roof base, the operation of fixing the solar cell module on the roof can be simplified. Further, the screw member is screwed to the holder and the cover member is pressed by screwing the screw member to the holder. Thereby, the object to be installed is fixed by the cover member by pressing the object to be installed to the holder. Further, when the screw member is screwed to retract from the holder, the screw member is screwed to retract and the cover member is separated from the holder thereby. Thereby, when the object to be installed is removed from the holder, the interval between the holder and the cover member is increased and therefore, the operation of removing the object to be installed can easily be carried out.

The invention provides a fixing apparatus for fixing an object to be installed which is installed to a building, comprising:

a base connected to the building and formed in a shape of an elongated rail;

a support member formed to be movable in a first direction previously determined at the base by being guided by the base;

a holder formed to be movable in a second direction intersecting with the first direction by being guided by the support member, for holding the object to be installed;

a cover member for pinching the object to be installed in cooperation with the holder; and

a screw member formed to be screwable to the holder, for generating a press force for pressing the cover member to the holder by screwing to the holder,

wherein the cover member is mounted to the holder in a temporarily fixing state of capable of temporarily fixing the object to be installed in cooperation with the holder.

According to the invention, after fixing the base to the building, the position of the holder can be adjusted in the first direction and the second direction intersecting with the first direction. Thereby, it is not necessary to accurately position the fixing position of the base relative to the building. Thereby, the operation of fixing the base at the building can be simplified. For example, when the building is a roof and the object to be installed is a solar cell module, by simplifying the operation of fixing the base at the roof face, the operation of fixing the solar cell module above the roof can be simplified. By temporarily fixing the object to be installed by the cover member, in the temtemporarily fixing stage, the object to be installed can be prevented from detaching from the holder and the operation of installing the object to be installed to the building can easily be carried out.

Further, the invention provides a fixing apparatus for fixing an object to be installed which is installed to a building, comprising:

a base connected to the building;

a holder supported by the base and formed to be movable in a horizontal direction, for holding the object to be installed; and

a displacement hampering member capable of hampering the holder from being displaced relative to the base and the holder from being displaced relative to a support member.

According to the invention, by forming the holder to be movable in the horizontal direction, even when accuracy of positioning the base in the horizontal direction relative to a roof is low, the object to be installed can be fixed to the roof face. Further, after fixing the base to the roof face, the holder can easily be moved in the horizontal direction in accordance with a shape of the roof face and operability at the roof face can be promoted.

### BRIEF DESCRIPTION OF THE DRAWINGS

Other and further objects, features, and advantages of the invention will be more explicit from the following detailed description taken with reference to the drawings wherein:

FIG. 1 is a sectional view showing an example of a fixing apparatus for a roof according to a first embodiment of the invention;

FIG. 2A is a perspective view showing a base rail, a holder supporting member, a holder fixing member and a bolt;

FIG. 2B is a perspective view showing a state of connecting the holder supporting member, the holder fixing member and the bolt;

FIG. 2C is a perspective view showing a state of connecting the base rail, the holder supporting member, the holder fixing member and the bolt;

FIG. 3A is a perspective view showing a first stage of a construction state in fixing a solar cell module to a roof face;

FIG. 3B is a perspective view showing a second stage of the construction state in fixing the solar cell module to the roof face;

FIG. 3C is a perspective view showing a third stage of the construction state in fixing the solar cell module to the roof face;

FIG. 3D is a perspective view showing a fourth stage of the construction state in fixing the solar cell module to the roof face;

FIG. 4 is a sectional view showing a standard tool for adjusting positions of holders aligned in a first direction;

FIG. 5 is a perspective view showing a base rail 41 and a base supporting member 42 of other example of the first embodiment of the invention;

FIG. 6 is a perspective view showing a holder supporting member and a holder of still other example of the first embodiment of the invention;

FIG. 7 is a exploded perspective view showing an example of a fixing apparatus for a roof according to a second embodiment of the invention;

FIG. 8 is a perspective view showing a state of fixing a solar cell module;

FIG. 9 is a side view showing portions of constituent elements of the fixing apparatus;

FIG. 10 is a side view showing a state of guiding a holder supporting member by a base rail;

FIG. 11 is a side view showing a state of supporting a holder by the holder supporting member;

FIG. 12 is a side view showing a state of mounting solar cell modules to the fixing apparatus;

FIG. 13 is a plan view schematically showing a state of attaching the base rail above a roof;

FIG. 14 is a plan view schematically showing a state of attaching the holder supporting member to the base rail;

FIG. 15 is a plan view schematically showing a state of attaching the holder to the holder supporting member;

FIG. 16 is a plan view schematically showing a state of inserting a first solar cell module 11a between the holders;

FIG. 17 is a plan view schematically showing a state of inserting a second solar cell module between the holders;

FIG. 18 is a plan view schematically showing a state of mounting a plurality of the solar cell modules to the holders;

FIG. 19A is a plan view schematically showing a first example of arranging a solar cell module on a roof by using the fixing apparatus;

FIG. 19B is a plan view schematically showing a second example of arranging the solar cell module on the roof by using the fixing apparatus;

FIG. 19C is a plan view schematically showing a third example of arranging the solar cell module 11 on the roof by using the fixing apparatus;

FIG. 19D is a plan view schematically showing a fourth example of arranging the solar cell module on the roof by using the fixing apparatus;

FIG. 20 is a sectional view showing a fixing apparatus of variation of the second embodiment;

FIG. 21 is a perspective view showing a state of connecting the fixing apparatus of variation of the second embodiment to the roof;

FIG. 22 is a perspective view showing the holder guided by the fixing apparatus of variation of the second embodiment;

FIG. 23 is a sectional view showing an example of a fixing apparatus for a roof according to a third embodiment of the invention;

FIG. 24A is a plan view showing a first stage of a construction state in fixing a solar cell module to a roof face;

FIG. 24B is a plan view showing a second stage of the construction state in fixing the solar cell module to the roof face;

FIG. 24C is a plan view showing a third stage of the construction state in fixing the solar cell module to the roof face;

FIG. 25A is a plan view showing a fourth stage of the construction state in fixing the solar cell module to the roof face;

FIG. 25B is a plan view showing a fifth stage of the construction state in fixing the solar cell module to the roof face;

FIG. 26 is a plan view showing a solar cell module;

FIG. 27A is a side view showing a fixing cover mounted with an interval adjusting member;

FIG. 27B is a front view showing the fixing cover mounted with the interval adjusting member;

FIG. 28 is a sectional view showing a solar cell module mounted to a fixing apparatus;

FIG. 29 is a sectional view showing a state before pinching the solar cell module by the fixing cover;

FIG. 30 is a sectional view showing a state after pinching the solar cell module by the fixing cover;

FIG. 31 is a sectional view showing an example of a fixing apparatus for a roof according to a fourth embodiment of the invention;

FIG. 32 is an enlarged sectional view showing a vicinity of a fixing cover of FIG. 31;

FIG. 33A is a sectional view showing a first stage in operation of mounting a solar cell module to a holder;

FIG. 33B is a sectional view showing a second stage in the operation of mounting the solar cell module to the holder;

FIG. 33C is a sectional view showing a third stage in the operation of mounting the solar cell module to the holder;

FIG. 34A is a sectional view showing a fourth stage in the operation of mounting the solar cell module to the holder;

FIG. 34B is a sectional view showing a fifth stage in the operation of mounting the solar cell module to the holder;

FIG. 34C is a sectional view showing a sixth stage in the operation of mounting the solar cell module to the holder;

FIG. 35A is a sectional view showing a state of mounting a fixing cover to the holder;

FIG. 35B is a sectional view showing a state of temporarily fixing the solar cell module to the holder;

FIG. 35C is a sectional view showing a state of loosening a screw from the state of temporarily fixing the solar cell module;

FIG. 35D is a sectional view showing a state of fastening the screw from a state of moving the fixing cover to a position of pinching the solar cell module;

FIG. 35E is a sectional view showing a state of pinching the solar cell module by the fixing cover and the holder:

FIG. 36A is a sectional view showing a screw member of other example of the fourth embodiment of the invention;

FIG. 36B is a sectional view showing a state of a fixing cover member fixed by the screw member;

FIG. 37 is a sectional view showing a fixing apparatus for a roof according to a fifth embodiment of the invention;

FIG. 38 is a perspective view showing the fixing apparatus for a roof;

FIG. 39 is a sectional view showing an occasion at which a base is disposed at a first position relative to a holder;

FIG. 40 is a sectional view showing an occasion at which the base is disposed at a second position relative to the holder;

FIG. 41A is a perspective view showing a first stage of a mounting procedure of mounting the holder to a support member;

FIG. 41B is a perspective view showing a second stage of the mounting procedure of mounting the holder to the support member;

FIG. 41C is a view showing a third stage of the mounting procedure for driving the base to displace the base relative to the holder;

FIG. 41D is a view showing a restricted state of guiding the holder to the base;

FIG. 42A is a view showing a state of restricting displacement of the base relative to the holder;

FIG. 42B is a view showing a state of angularly displacing the base relative to the holder by 180 degrees from the state shown in FIG. 42A;

FIG. 43A is a sectional view for explaining a positional relationship between a stepped difference of a roof member and a holder and a direction of a fixing apparatus, and showing a state of fixing the fixing apparatus to a first position;

FIG. 43B is a sectional view for explaining the positional relationship between the stepped difference of the roof member and the holder and the direction of the fixing apparatus, and showing a state of fixing the fixing apparatus to a second position;

FIG. 43C is a sectional view for explaining the positional relationship between the stepped difference of the roof member and the holder and the direction of the fixing apparatus, and showing a state of fixing the fixing apparatus to a third position;

FIG. 43D is a sectional view for explaining the positional relationship between the stepped difference of the roof member and the holder and the direction of the fixing apparatus, and showing a state of fixing the fixing apparatus to a fourth position;

FIG. 44 is a sectional view showing a base rail of other example of the fifth embodiment;

FIG. 45 is a sectional view showing a base rail of still other example of the fifth embodiment;

FIG. 46A is a perspective view showing a base rail of still other example of the fifth embodiment and showing a state of capable of guiding the holder;

FIG. 46B is a perspective view showing a state of angularly displacing a support member by 90 degrees from the state shown in FIG. 46A;

FIG. 46C is a perspective view showing a state of guiding the holder by the support member in the state shown in FIG. 46A;

FIG. 46D is a perspective view showing a state of angularly displacing the support member by 90 degrees from the state shown in FIG. 46C;

FIG. 47A is an exploded perspective view showing a base rail of still other example of the fifth embodiment;

FIG. 47B is a perspective view showing a state of assembling the base rail of the still other example shown in FIG. 47A;

FIG. 47C is a perspective view showing a state of guiding the holder by the support member in the state shown in FIG. 47B;

FIG. 47D is a perspective view showing a state of hampering the holder from being displaced from the state shown in FIG. 47C;

FIG. 48 is a sectional view showing FIG. 47C;

FIG. 49 is a sectional view showing FIG. 47D;

FIG. 50 is a plan view showing a portion of a solar cell module according to the invention;

FIG. 51A is a perspective view showing an upper face of the solar cell module;

FIG. 51B is a perspective view showing a lower face of the solar cell module;

FIG. 52A is a perspective view showing a first precursor to constitute a frame member of a solar cell module by extending perpendicular to a holder;

FIG. 52B is a perspective view showing a second precursor constituted by working the first precursor;

FIG. 52C is a perspective view showing the frame member of the solar cell module constituted by subjecting the second precursor to conduction working;

FIG. 53 is an enlarged sectional view showing a portion of the holder member in a vertical direction of the solar cell module;

FIG. 54 is a sectional view showing a fixing apparatus according to a sixth embodiment of the invention;

FIG. 55 is an exploded plan view showing a main body of the fixing apparatus and a side face cover member;

FIG. 56 is a perspective view schematically showing a state of installing a solar cell module 103 on a roof by using a fixing apparatus 110 of a first related art;

FIG. 57 is an enlarged perspective view showing a section S1 of FIG. 56;

FIG. 58 is a sectional view schematically showing a state of installing the fixing apparatus of the first related art on a tile-roofing;

FIG. 59 is a perspective view showing a fixing metal piece of the first related art;

FIG. 60 is an exploded perspective view showing a fixing apparatus of the second related art;

FIG. 61 is a plan view schematically showing a state of installing a solar cell module on the roof by using a fixing apparatus of the second related art;

FIG. 62 is a partial enlarged perspective view of FIG. 61;

FIG. 63A is a plan view schematically showing a first example of arranging the solar cell module on the roof by using the fixing apparatus of the related art;

FIG. 63B is a plan view schematically showing a second example of arranging the solar cell module on the roof by using the fixing apparatus of the related art;

FIG. 63C is a plan view schematically showing a third example of arranging the solar cell module on the roof by using the fixing apparatus of the related art; and

FIG. 63D is a plan view schematically showing a fourth example of arranging the solar cell module on the roof by using the fixing apparatus of the related art.

### DETAILED DESCRIPTION

Now referring to the drawings, preferred embodiments of the invention are described below.

A detailed explanation will be given of an example of a first embodiment of the invention by taking an example of a case of arranging a solar cell module which is an object to be installed on a roof in a shape of a flat plate in reference to schematically illustrated drawings as follows. For example, the roof face is provided to be inclined relative to a horizontal face 29.

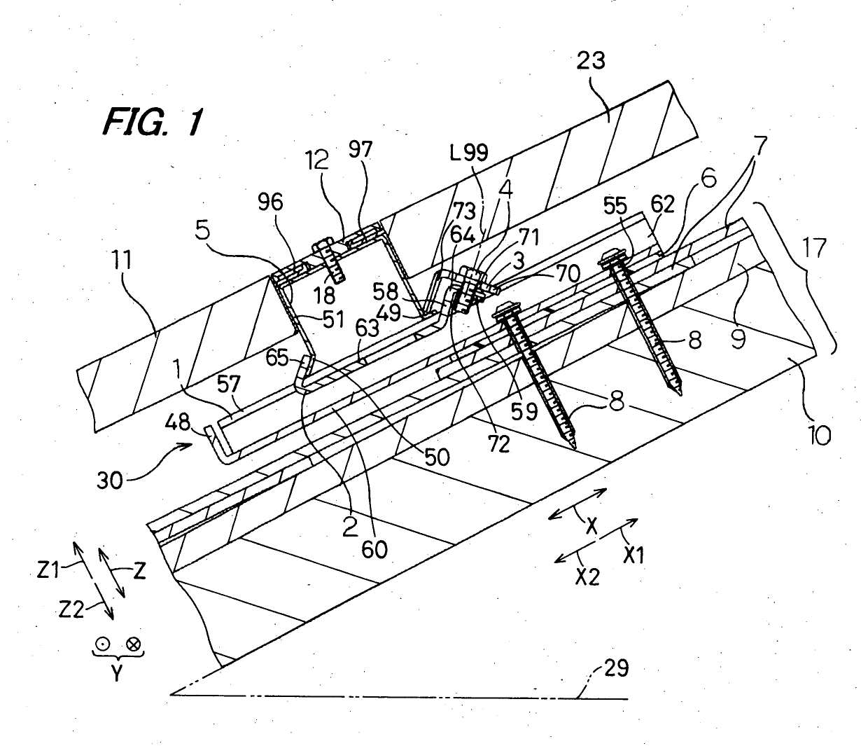

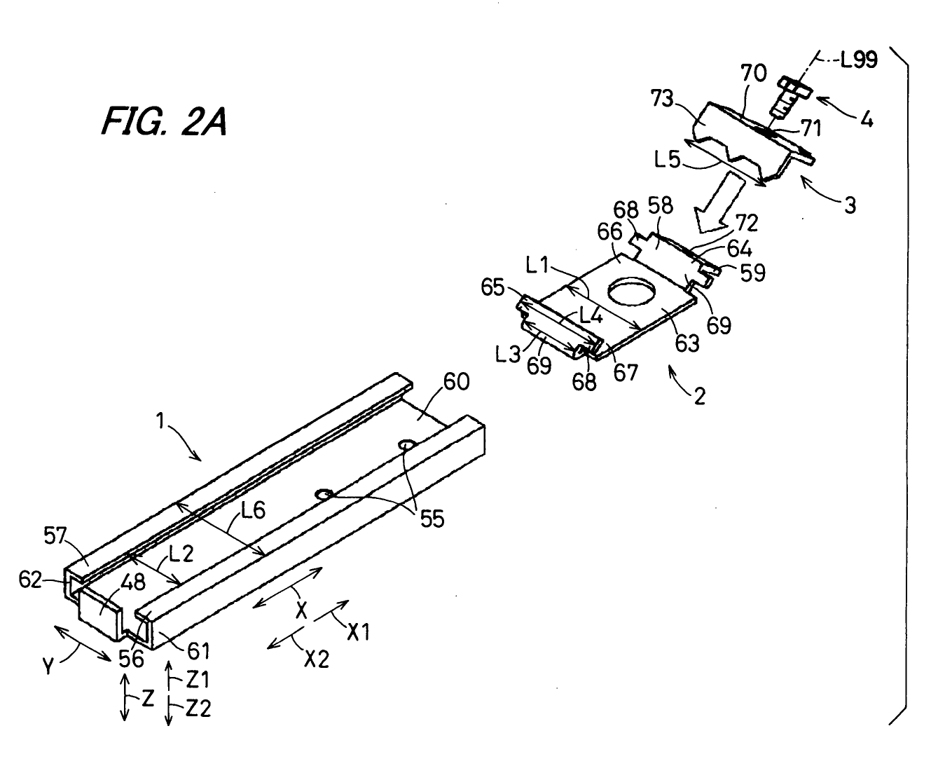

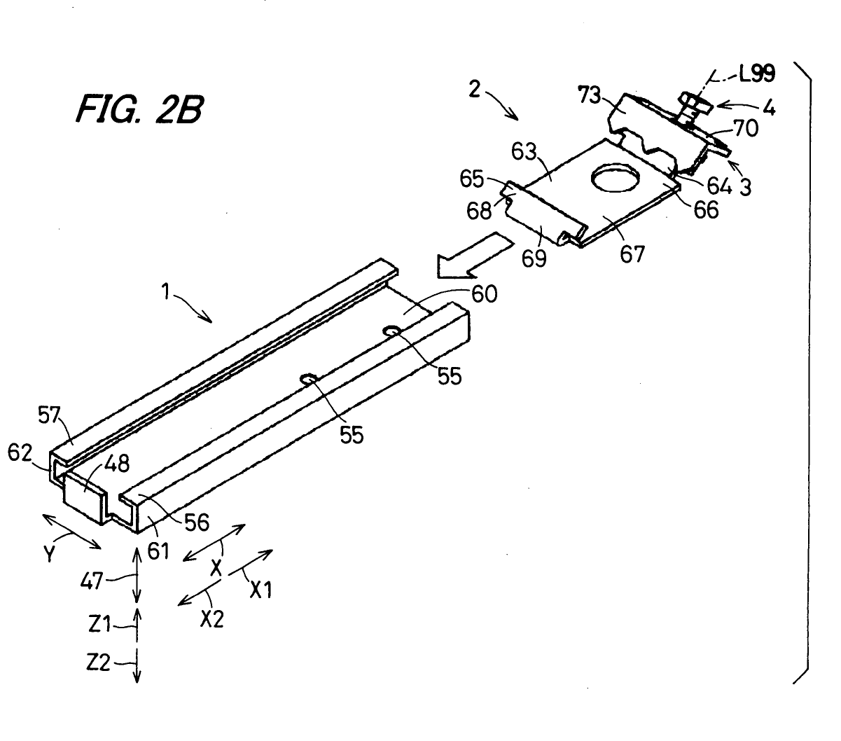

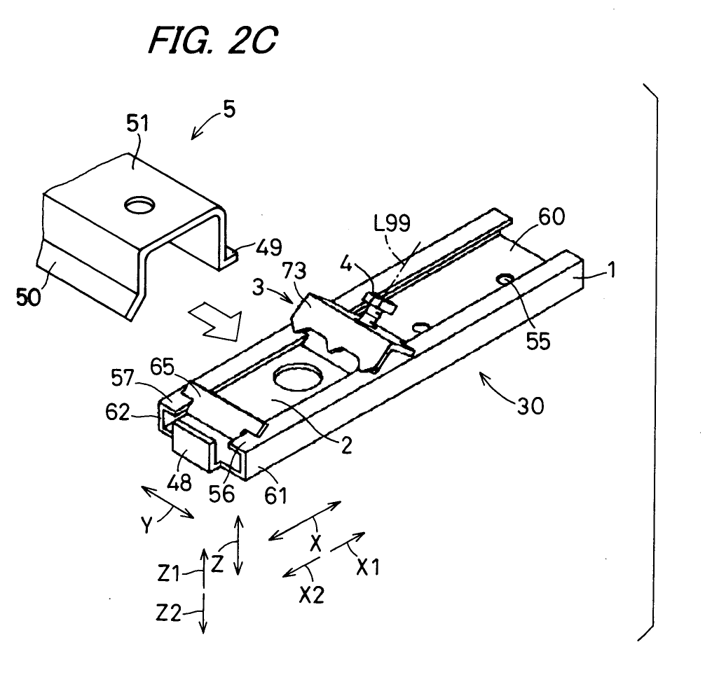

FIG. 1 is a sectional view showing an example of a fixing apparatus 30 for a roof according to the first embodiment of the invention. FIGS. 2A, 2B and 2C are perspective views showing a constitution of parts and an integrated state according to the example of the embodiment of the fixing apparatus 30 for a roof of the invention. As shown in FIG. 1, the fixing apparatus 30 includes a base rail 1, a holder supporting member 2, a holder fixing member 3 and a bolt 4. As shown in FIG. 2A, the holder supporting member 2 is attached with the holder fixing member 3 in a movable state at a screw hole 72 of a fastening receive portion 59 by the bolt 4. Under the state, the holder supporting member 2 and the holder fixing member 3 are inserted into the base rail 1 as shown in FIG. 2B. At this occasion, an engaging portion 63 of the holder supporting member 2 is brought into contact with a rear face of a flange portion 56 and 57 of the base rail 1 and by fastening the bolt 4, the flange portion 56 and 57 is pinched by the holder fixing member 3 and the engaging portion 63 to fix.

An explanation will be given of a structure of attaching an object to be supported to a roof by using the roof fixing apparatus 30 according to the embodiment in reference to the sectional view of FIG. 1. The roof fixing apparatus 30 is constituted by including the base rail 1, the holder supporting member 2, the holder fixing member 3 and the bolt 4. The engaging portion 63 of the holder supporting member 2 engages with the flange portion 56 and 57 of the base rail 1. Further, a locking portion 65 of the holder supporting member 2 and a first engaging portion 50 of a holder 5 are engaged with each other, further, a locking portion 73 of the holder fixing member 3 and a second engaging portion 49 of the holder 5 are engaged with each other. The first engaging portion 50 and the second engaging portion 49 of the holder 5 are pinched by the engaging portion 63 of the holder supporting member 2 and the locking portion 73 of the holder fixing member 3 by fastening the bolt 4. Further, by fastening the bolt 4, the holder 5 is pulled to a lower side, the holder supporting member 2 is pulled to an upper side and therefore, the first engaging portion 50 and the second engaging portion 49 of the holder 5 and the engaging portion 63 of the holder supporting member 2 are pressed to the flange portion 56 and 57 of the base rail 1. Thereby, the holder 5 is brought into an unmovable state relative to the base rail 1 in an inclined direction of a roof 17 and a direction orthogonal thereto. However, before fastening the bolt 4, the holder supporting member 2 is movable in the inclined direction x of the roof relative to the base rail 1 and the holder 5 is movable in the direction Y orthogonal to the inclined direction X of the roof relative to the holder supporting member 2.

The baser rail 1 is attached to a roof board 9 and a rafter 10 by an attaching screw 8 by penetrating the roof member 7 via a seal member 6. The holder 5 is mounted with a mounting piece 96 and 97 of a solar cell module 11 and 23 from a vertical direction and a fixing cover 12 is fixed to the holder 5 by a fixing screw 18 from an upper face thereof.

Explaining in further details, the base rail 1 is formed in an elongated shape and is fixed to the roof face. In the following, with regard to respective constituent members in correspondence with the fixing apparatus, in a case of being constituted as the fixing apparatus, a direction in parallel with the roof face and orthogonal to a horizontal line is defined as an inclined direction X, a direction in parallel with the roof face and extended along the horizontal line is defined as a horizontal direction Y, and a direction perpendicular to the roof face is defined as a normal direction Z. Further, an upper inclined direction X1 becomes a direction directed to an upper direction along the roof face and an upper normal direction Z1 becomes a direction perpendicular to the roof face and directed to the upper direction.

As shown in FIG. 2, when the base rail 1 is cut by a cross sectional surface perpendicular to the inclined direction X, the cross sectional surface thereof is formed in a substantially U-like shape. A longitudinal direction of the base rail 1 is along the inclined direction X and a width direction of the base rail 1 is along the horizontal direction Y. The base rail 1 includes a bottom face portion 60, raised portions 61, 62 and a stopper piece 48. The bottom face portion 60 is formed in an elongated shape and a longitudinal direction thereof is extended along the inclined direction X. The bottom face portion 60 is formed with an attaching screw inserting hole 55 of fixing to the roof face. The attaching screw 8 fixes the bottom face portion 60 to the roof 17 by being loosely inserted into the attaching screw inserting hole 55 of the bottom face portion 60.

The respective raised portions 61, 62 are respectively raised from both side portions in the horizontal direction Y of the bottom face portion 60 in the upper normal direction Z1 and respectively extended along the inclined direction X. Side end portions of the upper normal directions Z1 of the respective raised portions 61, 62 are bent in directions approaching each other in the horizontal direction Y. That is, when cut by an imaginary face perpendicular to the inclined direction X, cut faces of the respective raised portions 61, 62, are respectively formed in an L-like shape. The stopper piece 48 is continuous to a side end portion in a lower inclined direction X2 and is projected from the bottom face portion 60 in the upper normal direction Z1. By providing the stopper piece 48, the holder supporting member 2 can be prevented from being detached from the base rail 1.

The holder supporting member 2 is mounted to the base rail 1 for connecting the holder 5 and the base rail 1. The holder supporting member 2 is formed with a flat portion 63 formed in a plate-like shape, a first projected portion 64 raised from a side end portion 66 in the upper inclined direction X1 of the flat portion 63 in the upper normal direction Z1, and a second projected portion 65 raised from a second side end portion 67 in the lower inclined direction X2 of the flat portion 63 in the upper normal direction Z1.

Each of the projected portions 64, 65 includes a barrel portion 69 continuous to the flat portion 63, and an arm portion 68 projected from the barrel portion 69 to both sides in the horizontal direction Y at a position continuous to the barrel portion 69 and separated from the flat portion 63 in the upper normal direction Z1.

A dimension L1 in the horizontal direction of the flat portion 63 is formed to be larger than a distance L2 in the horizontal direction between bent portions 56, 57 of the two raised portions 61, 62 of the base rail 1. Further, a dimension L3 in the horizontal direction of the barrel portion 69 is formed to be smaller than the distance L2 in the horizontal direction between the bent portions 56, 57 of the two raised portions 61, 62. Further, a dimension L4 in the horizontal direction of the arm portion 68 is formed to be larger than the distance L2 in the horizontal direction between the bent portions 56, 57 of the two raised portions 61, 62. Thereby, the barrel portion 69 of the holder supporting member 2 is arranged between the two bent portions 56, 57, the flat portion 63 is arranged at an inner portion of the base rail 1 and the arm portion 68 can be arranged at an outer portion of the base rail 1. By arranging in this way, the holder supporting member 2 is mounted to the base rail 1 to be movable along the inclined direction X and to be restricted in moving in other directions Y, Z.

In the two projected portions 64, 65, the first projected portion 64 is formed in an L-like shape. Specifically, the first projected portion 64 is formed with a first inclined portion 58 continuous to the flat portion 63, separated from the flat portion 63 in the upper inclined direction X1 and extended in the upper normal direction Z1, and a second inclined direction 59 continuous to the first inclined direction 58, separated from the first inclined portion 58 in the upper inclined direction X1 and extended in a lower normal direction Z2. The second projected portion 65 proceeds from the flat portion 63 from the flat portion 63 in the upper normal direction Z1 and is extended in the upper inclined direction X1.

According to the embodiment, the first inclined portion 58 and the second projected portion 65 are extended substantially in the same direction. Further, the second inclined portion 59 is bent by 90 degrees relative to the first inclined portion 58. The second inclined portion 59 is formed with a screw hole 72 for screwing the bolt 4. An axis line L99 of the screw hole 72 is formed to be perpendicular to the second inclined portion 59. That is, the axis line L99 of the screw hole 72 is extended in the upper inclined direction X1 as proceeding in the upper normal direction Z1.

The holder fixing member 3 is formed in a substantially L-like shape and is formed in a shape along the first projected portion 64. The holder fixing member 3 is formed with a first inclined portion 73 and a second inclined portion 70 continuous to the first inclined portion 73 and bent by 90 degrees relative to the first inclined portion 73. The second inclined portion 70 of the holder fixing member 3 is formed with a screw hole 71 screwed with the bolt 4. Further, a dimension L5 in the horizontal direction of the first inclined portion 73 of the holder fixing member 3 is formed to be substantially equal to a dimension L6 in the horizontal direction of the base rail 1.

In a state in which the second inclined portion 70 of the holder fixing member 3 is arranged to be opposed to the second inclined portion 59 of the first projected portion 64, the bolt 4 is inserted through the screw hole 71 formed at the second inclined portion 70 of the holder fixing member 3 and is screwed to the screw hole 72 of the second inclined portion 59 of the first projected portion 64. Thereby, the holder fixing member 3 is mounted to the holder supporting member 2. The first inclined portion 73 of the holder fixing member 3 is arranged substantially in parallel with the first inclined portion 58 of the first projected portion 64. By screwing the bolt 4 to the screw hole 72 of the holder supporting member 2, the holder fixing member 3 is moved to the flat portion 63 of the holder supporting member 2 along the axis line L99 of the screw hole 72. Further, in a state in which the holder fixing member 3 is mounted to the holder supporting member 2, the fist inclined portion 73 of the holder fixing member 3 and the first inclined portion 58 of the first projected portion 64 are arranged with an interval therebetween in the inclined direction X and the normal direction Z.

The holder 5 holds the solar cell modules 11, 23. The holder 5 is mounted to the base rail 1 via the holder supporting member 2. The holder 5 is extended along the horizontal direction Y in a state of being mounted to the base rail 1. In a case of being cut by an imaginary plane perpendicular to the horizontal direction Y, the holder 5 is formed with a main body portion 51, a first flange portion 49 and a second flange portion 50. The main body portion 51 is formed in a substantially U-like shape. The first flange portion 49 is continuous to a side end portion in the upper inclined direction X1 of the main body portion 51b and is bent relative to the main body portion 51. The first flange portion 49 is formed with a contact face bent from the main body portion 51 in the upper inclined direction X1 and in parallel with the inclined direction X. The second flange portion 50 is continuous to a side end portion in the lower inclined direction X2 of the main body portion 51 and is bent relative to the main body portion 51. The second flange portion 50 is extended in the lower normal direction Z2 as proceeding from the main body portion 51 in the lower inclined direction X2.

In a state in which the holder 5 is mounted to the base rail 1, the first flange portion 49 is arranged between the respective bent portions 56, 57 of the base rail 1 and the first inclined portion 73 of the holder fixing member 3. At this occasion, the first flange portion 49 is extended to be opposed to the respective bent portions 56, 57 of the base rail 1 in parallel therewith. The second flange portion 50 is arranged between the respective bent portions 56, 57 of the base rail 1 and the second projected portion 65 of the holder supporting member 2. At this occasion, the second flange portion 50 is extended to be opposed to the second projected portion 65 of the holder supporting member 2 in parallel therewith.

In a state in which the holder 5 is mounted to the base rail 1, the holder 5 is movable in the horizontal direction Y by guiding the second flange portion 50 by the second projected portion 65 of the holder supporting member 2 and is hampered from moving in the inclined direction X. At this occasion, the second projected portion 65 and the second flange portion 50 are inclined relative to the bent portions 56, 57 and therefore, even when the base rail 1 is fixed to be inclined relative to a horizontal face, the holder 5 can stably be guided.

Further, by screwing the bolt 4 to the holder supporting member 2, the holder fixing member 3 is moved to the base rail 1 along the axis line direction of the screw hole 72. Thereby, the first inclined portion 73 of the holder fixing member 3 presses the first flange portion 49 of the holder 5 to the holder supporting member 2. Specifically, the first inclined portion 73 presses the holder 5 in the lower inclined direction X2 and in the lower normal direction Z2.

The respective bent portions 56, 57 of the base rail 1 are arranged between the first flange portion 49 of the holder 5 and the holder supporting member 2. Therefore, when the holder 5 is pressed by the holder fixing member 3, the first flange portion 49 of the holder 5 is pressed to the bent portions 56, 57 of the base rail 1. Further, the second flange portion 50 of the holder 5 is pressed to the second projected portion 65 of the holder supporting member 2. Thereby, a friction force is generated between the holder 5 and the base rail 1 to hamper the holder 5 from being displaced from the base rail 1 and the holder supporting member 2.

Further, by bringing the first flange portion 49 into face contact with the bent portions 56, 57, a large friction force can be provided and the holder 5 can firmly be fixed to the base rail 1. Further, by only turning the bolt 4, both of displacements of the holder 5 in the inclined direction X and the horizontal direction Y can be simultaneously hampered and operation of fixing the holder 5 can simply be carried out. Further, by arranging the second projected portion 65 in the upper normal direction Z1 of the second flange portion 50, the holder 5 can be hampered from being displaced in the upper normal direction Z1. Further, in order to increase the friction force, a material having a high friction coefficient of rubber of the like may partially be provided at the contact portion of the holder 5 and the holder supporting member 3, the contact portion of the holder 5 and the base rail 1 and between the base rail 1 and the holder supporting member 3. Further, in a state in which the holder 5 and the base rail 1 are brought into contact with each other, shapes of recesses and projections may respectively be formed at either one of the holder 5 and the base rail 1 and the main supporting member 3 and other thereof to be brought in mesh with each other such that the holder 5 is prevented from moving downward. Thereby, even when the bolt is slightly loosened, the holder 5 can be prevented from being dropped.

Further, the holder supporting member 2 can be prevented from being detached by the stopper piece 48 and therefore, the holder supporting member 2 can previously be mounted to the base rail 1 before being attached to the roof. By fixing the base rail 1 under the state to the roof face, it is not necessary to mount the holder supporting member 2 to the base rail 1 on the roof face and operability at the roof face can be promoted.

Therefore, the flange portion 56 and 57 is constituted by the bent portions 56, 57 which are bent in the respective raised portions 61, 62 of the base rail 1. Further, the engaging portion 63 is constituted by the flat portion 63 of the holder supporting member 2, a fastening receive portion 59 is constituted by the second inclined portion 59 of the first projected portion 64 and a locking portion 65 is constituted by the second projected portion 65. Further, the locking portion 73 is constituted by the first inclined portion 73 of the holder fixing member 3. Further, the second engaging portion 49 is constituted by the first flange portion 49 of the holder 5 and the first engaging portion 50 is constituted by the second flange portion 50. Further, a movement hampering member for hampering movement of the holder is constituted by including the bolt 4 and the holder fixing member 3. The fixing apparatus 30 according to the embodiment may not include the holder 5.

According to the constitution of the roof fixing apparatus of the embodiment, the holder supporting member 2 supports the holder 5 which is directly mounted on the base rail 1, the holder 5 can be fixed to the base rail 1 by the holder fixing member 3 provided at the holder supporting member 2 and therefore, by fastening a single one of the holder fixing member 3, both of the holder 5 and the holder supporting member 2 can be fixed to the base rail 1 in one motion. Thereby, a number of steps in attaching the holder 5 to the roof fixing apparatus can be reduced.

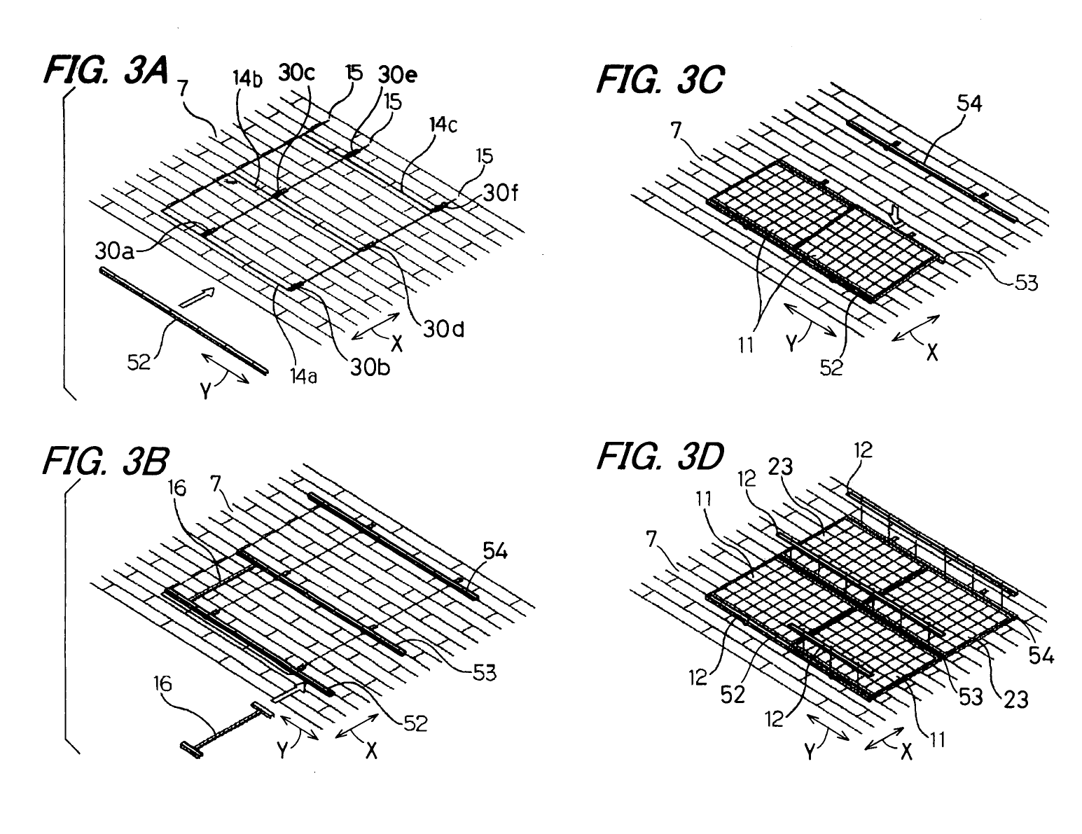

FIGS. 3A through 3D are views showing a construction state of the example of the embodiment according to the invention. An explanation will be given to an attaching procedure using the roof fixing apparatus of the invention.

First, as shown in FIG. 3A, a lateral mark 14a indicating a position of the roof fixing apparatus in a roof inclination direction on the endmost side of the eaves is written on the roof member 7, and a lateral mark 14b and a lateral mark 14c are written in the house direction of the roof by constituting a base point by the lateral mark 14a. Next, a longitudinal mark 15 indicating an end portion of the holder 5 orthogonal to the lateral mark and a longitudinal direction of flow of the roof fixing apparatus is written. The roof fixing apparatus 30a and 30b on the endmost side of the eaves are aligned at positions of the longitudinal marks 15 and front ends thereof on the eaves side are aligned to the lateral mark 14 and fixed to the roof face by attaching screw 8 or the like. Other roof fixing apparatus is similarly fixed to vicinities of intersections of the lateral marks 14 and the longitudinal marks 15. Here, according to the roof fixing apparatus 30 of the invention, as described above, before fastening the bolt 4, a position of the holder 5 can be adjusted in wide ranges in the inclined direction X and the direction X orthogonal to the inclined direction X of the roof and therefore, it is not necessary to fix the roof fixing apparatus 30 to finely align the intersections of the lateral marks 14 and the longitudinal marks 15.

When the base rail 1 has been finished to attach, the holder 52 on the endmost side of the eaves is attached to the roof fixing apparatus 30a and 30b to fix.

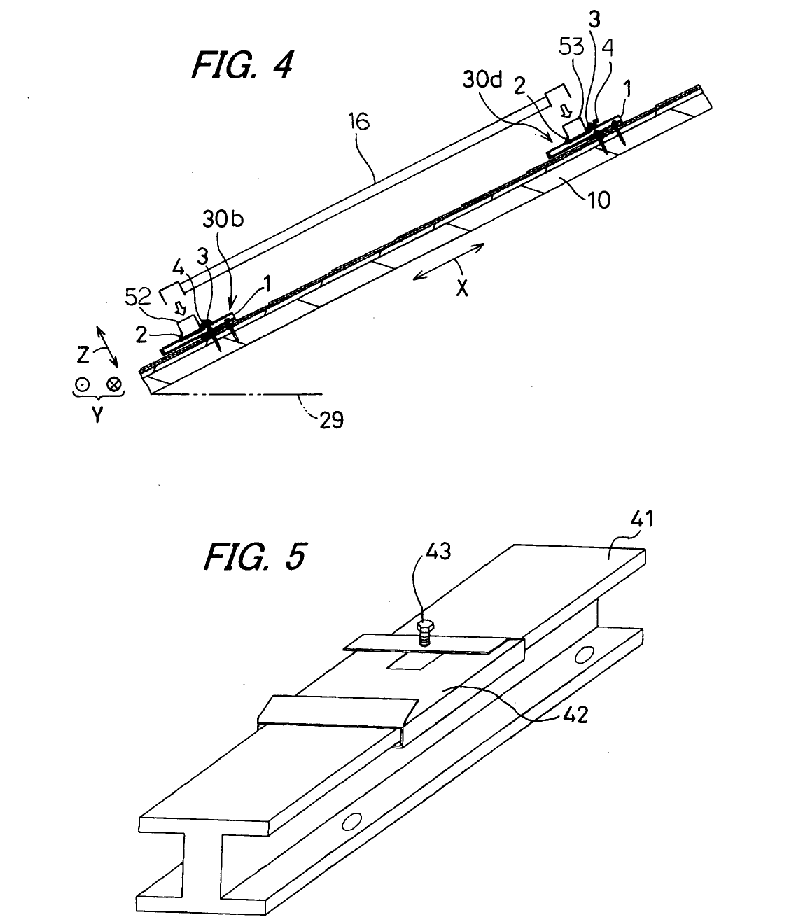

Next, as shown in FIG. 3B, a adjacent one of the holder 53 and 54 are attached successively to the house side. At this occasion, the holder 53 at a second stage may be attached while adjusting an attaching interval by using a standard tool 16 by constituting a reference by the holder 52 at the first stage. FIG. 4 is a sectional view showing the standard tool 16. A position of the roof fixing apparatus 30 can be adjusted in wide ranges in the inclined direction X and the direction Y orthogonal to the inclined direction X of the roof before fastening the bolt 4 and therefore, when in a state of fixing the holder 52 to the roof fixing apparatus 30b, the attaching interval between the roof apparatus 30d and the holders 52 and 53 is adjusted by fitting the standard tool 16 to the transverse rack while moving the holder supporting member 2 of the roof fixing apparatus 30d and the bolt 4 of the roof fixing apparatus 30d is fastened, adjacent two pieces of the holders 52 and 53 are fixed to tho roof face while maintaining the predetermined interval therebetween. The standard tool 16 is removed when the holder 53 has been finished to fix and similarly, the standard tool 16 is used in fixing operation of the successive holder 54 constituting a base point by the holder 53.

When all of the holders have been finished to attach, as shown in FIG. 3C, the solar cell module 11 is temporarily installed by riding over adjacent holders 52 and 53. Similarly, the solar cell module 23 is temporarily installed also between the holders 53 and 54. When temporary installation of all of the solar cell modules have been finished, as shown in FIG. 3D, the solar cell modules 11 and 23 are fixed by fastening the fixing covers 12 by fixing screw 18 or the like. Thereby, the solar cell modules 11 and 23 are finished to install.

Further, FIG. 5 is a perspective view showing a holder supporting member 42 and a base rail 41 according to other example of the first embodiment. According to the invention, the base rail 41 may be constituted by an I-like shape. In this case, the holder supporting member 42 envelops the base rail 41. At this occasion, the holder fixing member 3 as shown in FIGS. 1 and 2 may be used or a bolt 43 may directly press the holder as the holder fixing member.

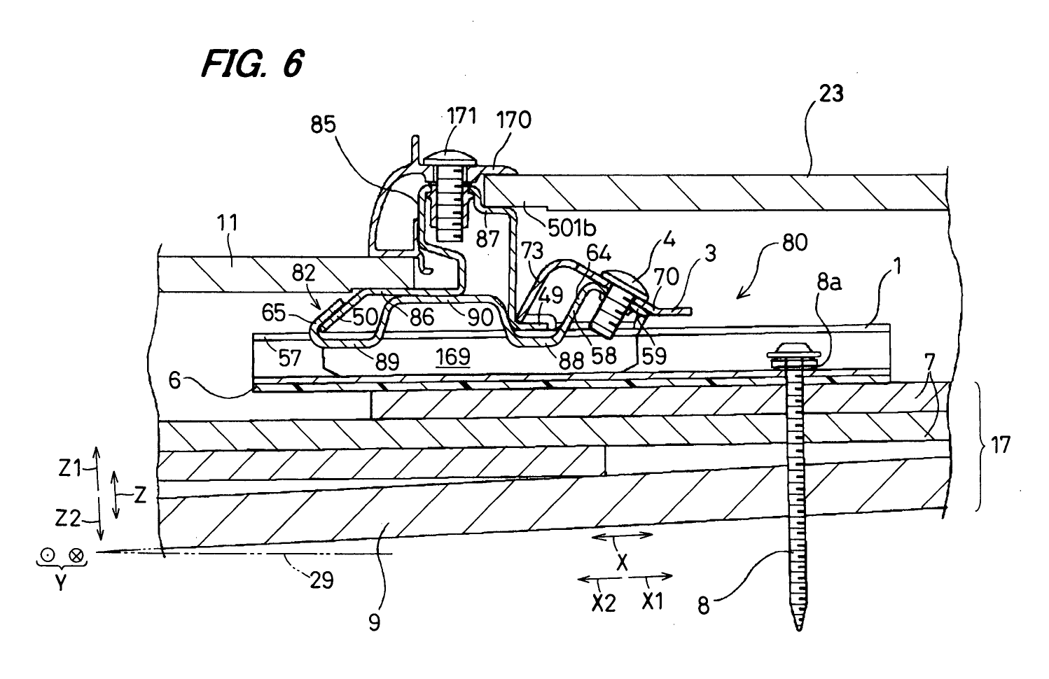

FIG. 6 is a sectional view showing a fixing apparatus 80 of still other example of the first embodiment. The embodiment shows a constitution similar to that of the embodiment exemplified to show in FIG. 1. Therefore, the same components as those of the embodiment shown in FIG. 1 will be denoted by the same reference numerals, and an explanation thereof will be omitted. The fixing apparatus 80 generally differs from the fixing apparatus 80 shown in FIG. 1 in a holder supporting portion 82 and a holder 85. The holder 85 is mounted with the two solar cell modules 11, 23. In a state of being held by the holder 85, positions of holding the one solar cell module 11 and the other solar cell module 23 in the normal direction Z differ from each other. The holder 85 is formed with a lower mounting portion 86 for mounting the solar cell module 11 on the lower side and an upper mounting portion 87 for holding the solar cell module 23 on the upper side as the main body portion 50. The upper mounting portion 87 is formed on the upper normal direction Z1 in comparison with the lower mounting portion 86. Even when the shape of the main body portion 51 differs from that in the case shown in FIG. 1 in this way, the holder 85 is formed with flange portions 49, 50 the same as the first flange portion 49 and the second flange portion 50 shown in FIG. 1.

The holder supporting member 82 is provided with constitutions in correspondence with the respective projected portions 64, 65 shown in FIG. 1. Further, the holder supporting member 82 is formed with a first flat portion 88 brought to be opposed to the first flange portion 49, a second flat portion 89 brought to be opposed to the second flange portion 50 and a connecting portion 90 for connecting the first flat portion 88 and the second flat portion 89, in a state of being installed the holder 85, in place of the flat portion 63. The respective flat portions 89, 90 are provided with a function similar to that of the flat portion 63 shown in FIG. 1. The first flange portion 49 of the holder 85 and the bent portion 56, 57 of the base rail 1 are pinched by the first flat portion 88 and the first inclined portion 73 of the holder fixing member 3. Further, the holder 85 is locked to the base rail 1 by the second projected portion 65 of the holder supporting member 2.

The connecting portion 90 is raised from the each flat portion 88, 89 in the upper normal direction Z1 and is brought into contact with the lower mounting portion 86 of the holder 85 to support the holder 85. Thereby, when the solar cell module 11 is held by the holder 85, the holder 85 can be prevented from being deformed. The constitution is applicable also to the holder supporting member 2 shown in FIG. 1.

Even when the shape of the main body portion 51 of the holder 85 differs in this way, by providing the first flange portion 49 and the second flange portion 50 to the holder 85, the holder 85 can firmly be locked by the holder supporting member 2 and the holder fixing member 3. Even when the holder 85 and the holder supporting member 82 are used in the fixing apparatus 85 as shown in FIG. 6, the fixing apparatus can be fixed to the roof 17 by the method shown in FIG. 3.

In this way, the invention is a fixing apparatus comprising a base rail 1 in an elongated shape to be fixed to a roof face, a holder supporting members 2 and 82 movable in a longitudinal direction of the base rail 1 by being guided by the base rail 1 and a holder fixing member 3 provided at the holder supporting member 2 and 82, wherein the holder supporting member 2 and 82 supports the holder 5 and 85 for an object to be installed on a roof in a shape of a flat plate directly mounted on the base rail 1 and a predetermined portion of the holder 5 and 85 is pressed to the base rail 1 by the holder fixing member 3 to thereby enable to fix the holder 5 and 85 to the base rail 1.

Further, the invention is a fixing apparatus for fixing a plurality of pieces of holders for an object to be installed, which object is a solar cell module, on the roof to one or more of the objects to be installed on the roof constituting a planar angular shape at least two sides of which are in parallel with each other by the above-mentioned roof fixing apparatus, wherein a group of the fixing apparatus provided in at least two rows at a predetermined interval therebetween are arranged on the roof, the holders are fixed to each of one fixing apparatus group and other fixing apparatus group and the two side portions in parallel with each other of the object to be installed on the roof are arranged to fix between the holders.

Further, when the base rail 1 is constituted by a cylindrical body formed in a substantially U-like shape as shown in FIG. 1 and FIGS. 2A, 2B and 2C, there is achieved an advantage of capable of thinning the roof fixing apparatus since the holder can be fixed in a state of containing portions of the holder supporting member 2 and the holder fixing member 3 in a groove of the base rail 1. In contrast thereto, when the base rail 41 is constituted by the I-like shape as shown in FIG. 5, there is achieved an advantage of capable of ensuring a height by the roof fixing member when the holder 5 is intended to separate from the roof face to improve ventilation or the like.

Further, when the press piece such as the first inclined portion 73 is used as the holder fixing member 3 as shown in FIG. 1 and FIGS. 2A, 2B and 2C, there is achieved an advantage of facilitating attachment and detachment thereof and capable of simultaneously fixing the holder 5 and the holder supporting member 2. In contrast thereto, when the bolt 43 is used as the holder fixing member as shown in FIG. 5, there is achieved an advantage of capable of reducing a number of parts since the bolt 43 can serve also as a locking portion.

Further, although an explanation has been given of the embodiment by taking an example of the solar cell module as the object to be installed on the roof, the invention is not limited thereto but is applicable preferably to a solar energy utilizing apparatus or the like in a shape of a flat plate such as a solar heat collector or the like and can pertinently be modified to embody within a range thereof not deviated from the gist of the invention. That is, the fixing apparatus can be widely used with regard to the fixing of the object to be installed which is fixed to a building.

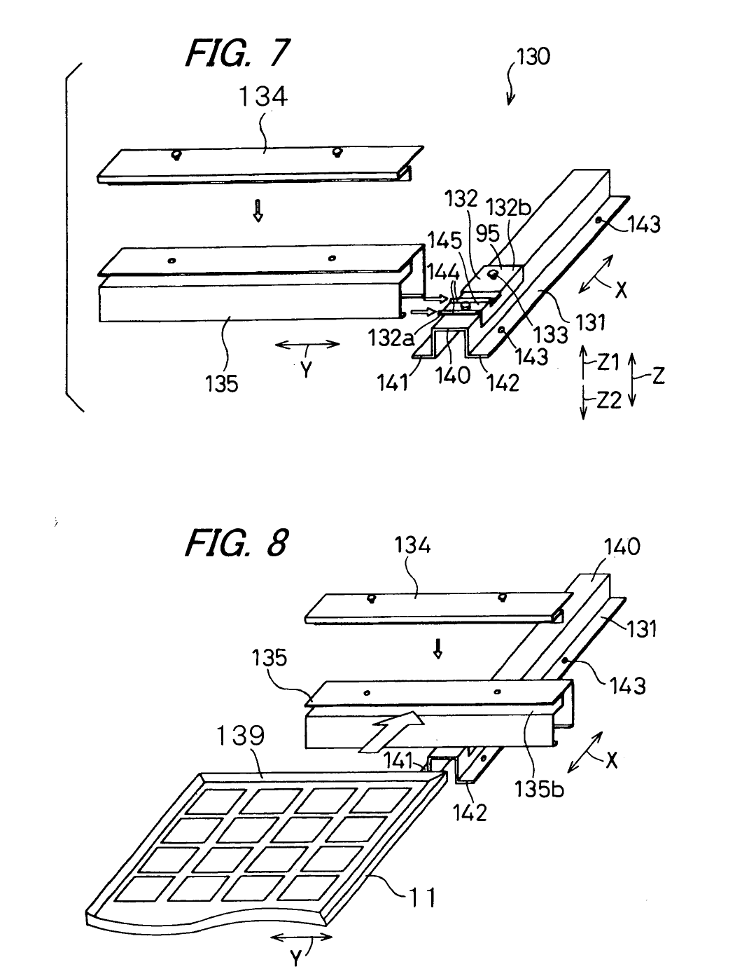

FIG. 7 is a perspective view showing a state of a constitution of parts and an integrated state according to an example of an embodiment of a fixing apparatus 130 of a second embodiment of the invention. Further, the same components as those of the fixing apparatus 130 shown in FIG. 1 will be denoted by the same reference numerals, and an explanation thereof will be omitted.

As shown in FIG. 7, the fixing apparatus 130 includes the base rail 131, the holder supporting member 132 and the holder fixing member 133. The holder supporting member 132 is attached in a state of being able to move on the base rail 131 in the longitudinal direction and the holder supporting member 132 is attached with the holder 135 (transverse rack) for supporting the solar cell module or the like.

The holder 135 includes fixing means for fixing an object to be installed in a shape of a flat plate of the solar cell module 11 or the like by itself. On the other hand, when the holder 135 does not include the fixing means for fixing the object to be installed in the shape of the flat plate of the solar cell module or the like, the object to be installed in the shape of the flat plate such as a solar cell module or the like can be pinched by screws or bolts to fix by using not only the holder 135 but also an outer side pinching member 134 or the like in addition to the holder 135 as shown in FIG. 8.

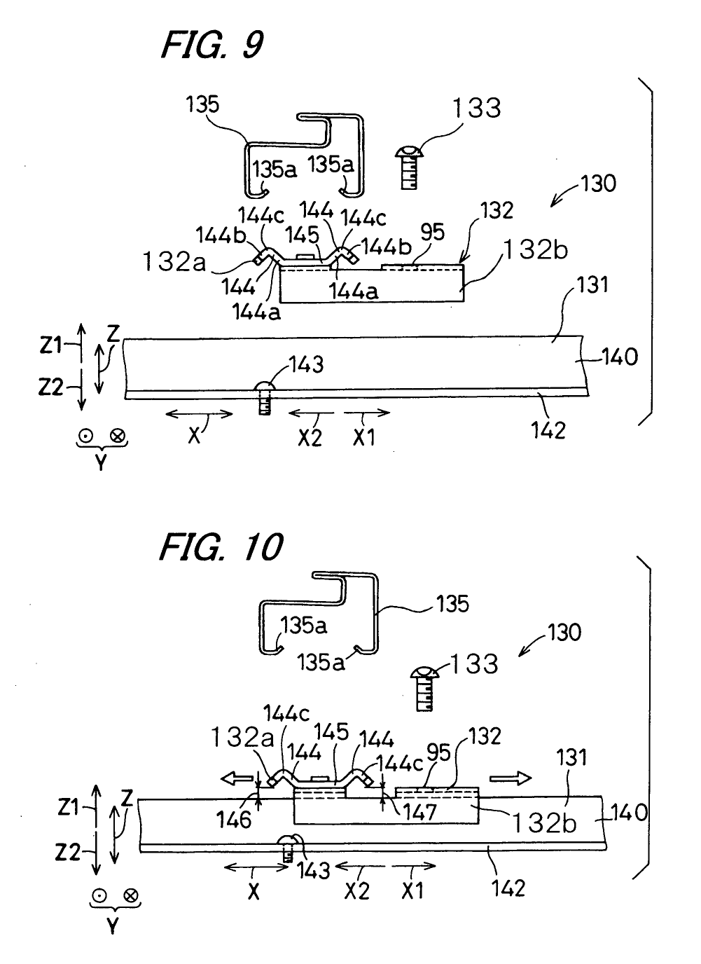

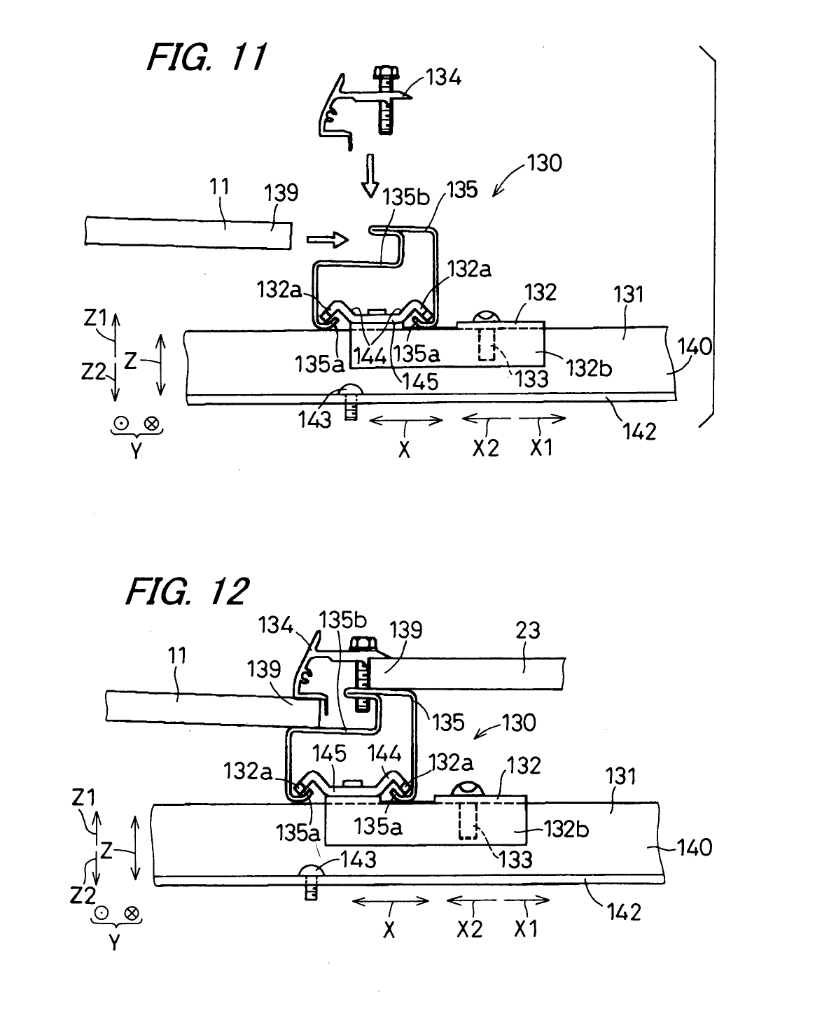

FIG. 9 is a sectional view showing a structure of a fixing apparatus 130 according to the invention, FIG. 10 is a sectional view showing a state of moving the fixing apparatus 130 according to the invention on the base rail 131, FIG. 11 is a sectional view showing a behavior of pinching the solar cell module to fix to the fixing apparatus 130 according to the invention and FIG. 12 is a sectional view showing a state of fixing the fixing apparatus 130 according to the invention to the base rail 131.

As shown in FIG. 9, the holder supporting member 132 includes a locking portion 132a in a rail-like shape for fixing the holder 135 and a base seat portion 132b movable on the base rail 131 and is fixed to the base rail 131 by the holder fixing member 133.

As shown in FIG. 10, initially, the holder supporting member 132 is brought into a state of being only placed on the base rail 131, freely movable along the longitudinal direction, that is the inclined direction X of the roof, of the base rail 131 and after adjusting a position thereof in accordance with a position of installing the holder 135, the holder supporting member 132 is fixed by opening a hole for screwing on the base rail 131 and inserting the holder fixing member 133 to fix.

Further, although according to the example, a method of opening the hole after adjusting the position is exemplified, the baser rail 1 may previously be provided with a screw hole or the like for fastening the holder fixing member to simplify operation on the site.

Next, as shown in FIG. 11, when a lower end 135a constituting a locking portion in a rail-like shape on the lower side of the holder 135 is passed through the lower side of the locking portion 132a in the rail-like shape of the holder supporting member 132, the holder fixing member 133 is fastened, the base seat portion 132b of the holder supporting member 2 is pressed to the side of the base rail 1 and the lower end 135a constituting the locking portion in the rail-like shape at the lower portion of the holder 135 is pinched between the locking portion 132a in the rail-like shape and the upper face of the base rail 131 to thereby fix the holder 135.

An explanation will be given of an example of using fixing means for fixing the solar cell module 11 by the holder 135 and the outer side pinching member 134 when the solar cell module 11 is fixed onto the holder 135.

After the holder 135 has been fixed, by inserting an end portion of the solar cell module 11 into an opening portion 135b of the holder 135 and fixing the outer side pinching member 134 to the upper portion of the holder 135, as shown in FIG. 12, the solar cell module 11 can solidly be pinched between the outer side pinching member 134 and the holder 135 to fix.

Specifically, the base rail 131 is formed in an elongated shape and is fixed such that a longitudinal direction thereof is along the inclined direction X of the roof, that is, in a direction in which rain water dropped on the roof face flows. As shown in FIG. 7, the base rail 131 is formed with a main body portion 140 whose cross sectional shape in a cross sectional surface perpendicular to the inclined direction X is formed in a substantially U-like shape and which extends in the inclined direction X, and fixing portions 141, 142 respectively projected from side portions in the lower normal direction Z2 of the main body portion to both sides in the horizontal direction Y. The fixing portions 141, 142 are fixed to the roof 17 by bolts 143. Therefore, the main body portion 140 is projected from the roof face in the upper normal direction Z1.

The holder supporting member 132 is formed with the base seat portion 132b and the locking portion 132a. the base seat portion 132b is provided so that a cross sectional shape thereof in the cross sectional surface perpendicular to the inclined direction X is formed in a substantially U-like shape, and the base seat portion 132b is fitted to the main body portion 140 of the base rail 131 from the upper normal direction Z1. Thereby, the holder supporting member 132 is formed to be movable in the inclined direction X in a state in which the base seat portion 132b is fitted to the base rail 131. Further, the base seat portion 132b is formed with a screw hole 95 for fixing the base rail 131.

The locking portion 132a includes two streaks of rail portions 144 extended in the horizontal direction Y and aligned in the inclined direction X, and support portions 145 for connecting the respective rail portions 144 and the base seat portions 132b. The support portion 145 is provided at a middle portion in the inclined direction X of each rail portion 144 for supporting two rail portion 144 from both sides thereof.

Each rail portion 144 is formed in an L-like shape. Each rail portion 144 is projected mostly in the upper normal direction Z1 at a bent portion 144C thereof. Specifically, each rail portion 144 is formed with a raised portion 144a continuous to the support portion 145 and extended in the upper normal direction Z1 as separating from the support portion 145 in the inclined direction X, and a lowered portion 144b continuous to the raised portion 144a and extended in the normal direction Z2 as separating from the support portion 145 in the inclined direction X. The raised portion 144a is inclined by about 45 degrees relative to the support portion 145 and the lowered portion 144b is bent by 90 degrees relative to the raised portion 144a. Further, as shown in FIG. 10, clearances 146, 147 are formed between the respective rail portions 144 and the base rail 131 in the normal direction Z in a state in which the holder supporting member 132 is fitted to the base rail 131 and the screw 133 is screwed to the screw hole 95.

According to the embodiment, one of the two rail portions 144 is projected from the base seat portion 132b in the other inclined direction X2 and is formed with the clearance 146 in the normal direction Z between the one and the base rail 131. Further, other of the two rail portions 144 is arranged to be opposed to the base seat portion 132b. However, a portion of the base seat portion 132b opposed to the other rail portion 144 is cut to remove and the clearance 147 is formed in the normal direction Z between the other rail portion 144 and the base rail 131. The two clearances 146, 147 are formed such that distances of normal direction distances Z of the base rail 131 are equal to each other.

The holder 135 is formed in an elongated shape and a sectional shape thereof is formed in a substantially U-like shape in a cross sectional surface perpendicular to the horizontal direction Y. Both end portions in the sectional shape of the holder 135 are respectively formed with locking portions 135a. The respective locking portions 135a are bent to inner sides of the holder 135 and bent in directions approaching each other. Further, as shown in FIG. 11, the front ends of the respective locking portions 135a are formed to warp in the upper normal direction Z1 in a state in which the holder 135 is mounted to the holder supporting member 132.

In the state in which the holder supporting member 132 is mounted to the base rail 131, when the holder 135 is mounted, the respective locking portions 135a of the holder 135 are inserted through intervals between the base rail 131 and the respective locking portions 132a of the holder supporting member 132. At this occasion, by forming to warp the front ends of the respective locking portions 135a in the upper normal direction Z1 of the base rail 131, the holder 135 is prevented from being displaced in the inclined direction X and the normal direction Z relative to the holder supporting member 132. Further, the clearances 146, 147 formed between the respective rail portions 144 and the base rail 131 are reduced by moving the holder supporting member 132 to the base rail 131 in the normal direction Z by the bolt 133. Thereby, the clearances 146, 147 between the respective rail portions 144 and the base rail 131 are reduced. Therefore, the locking portion 135a of the holder 135 is pinched by the locking portion 132a of the holder supporting member 132 and the base rail 131 and displacement of the holder 135 in the horizontal direction Y relative to the base rail 131 is hampered.

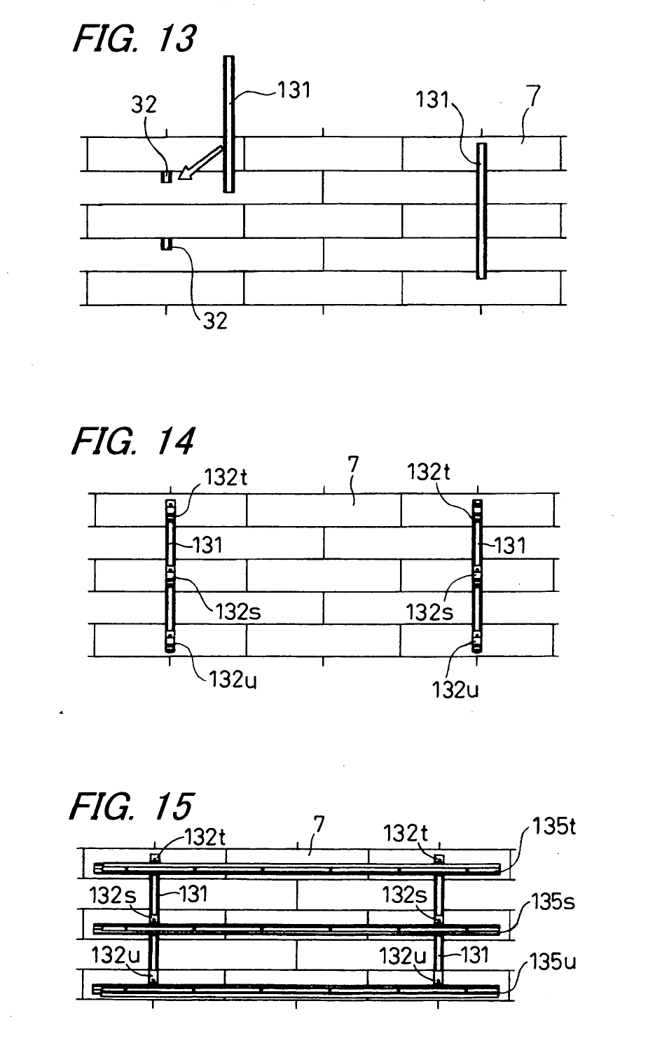

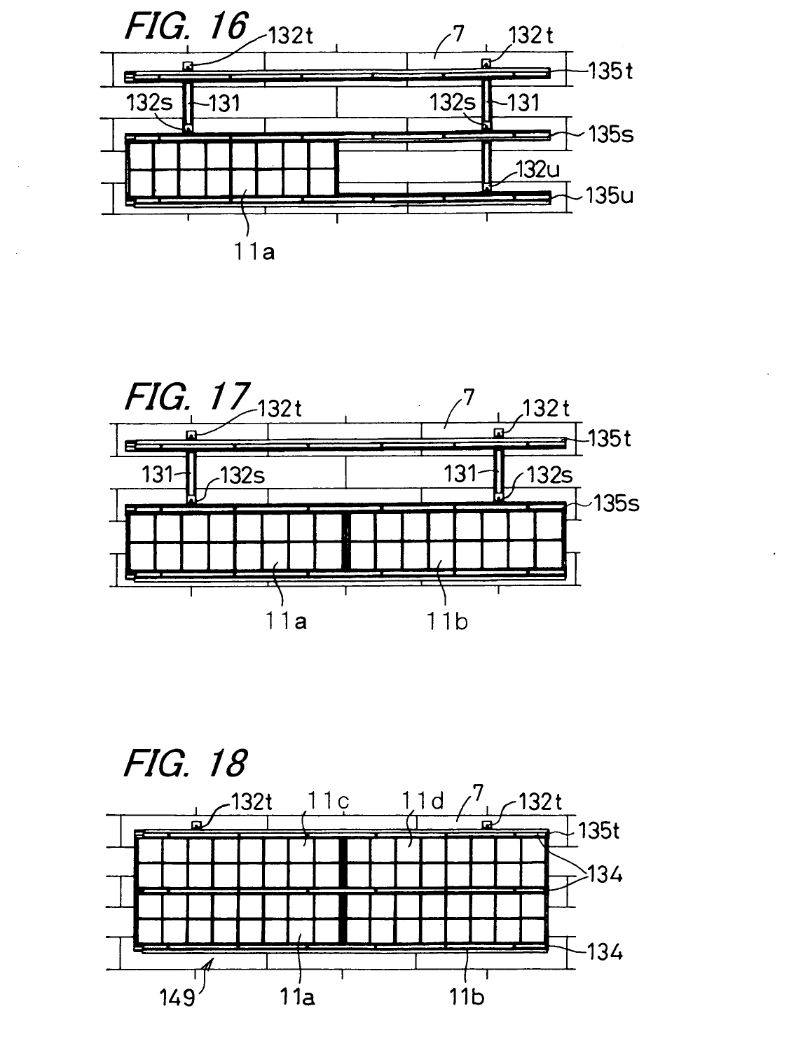

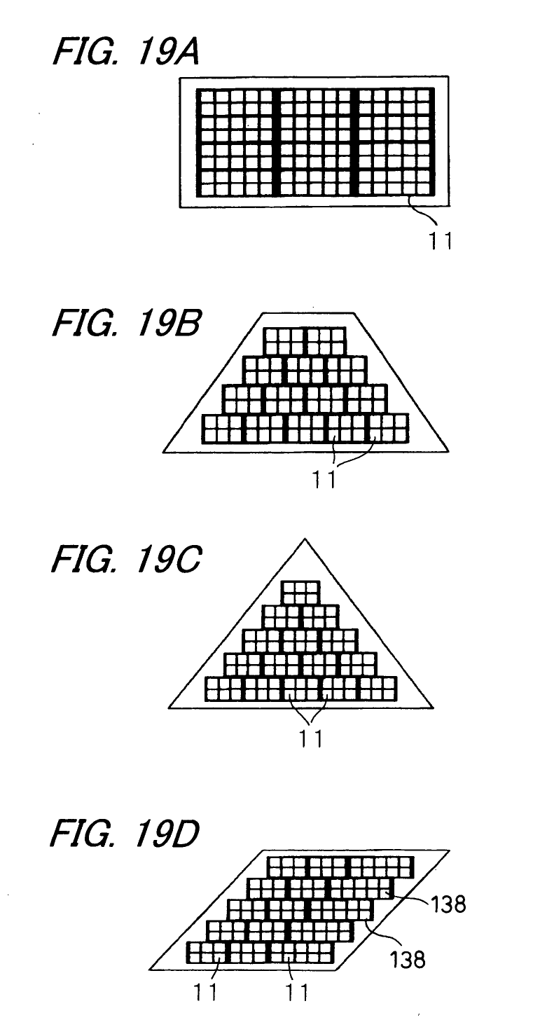

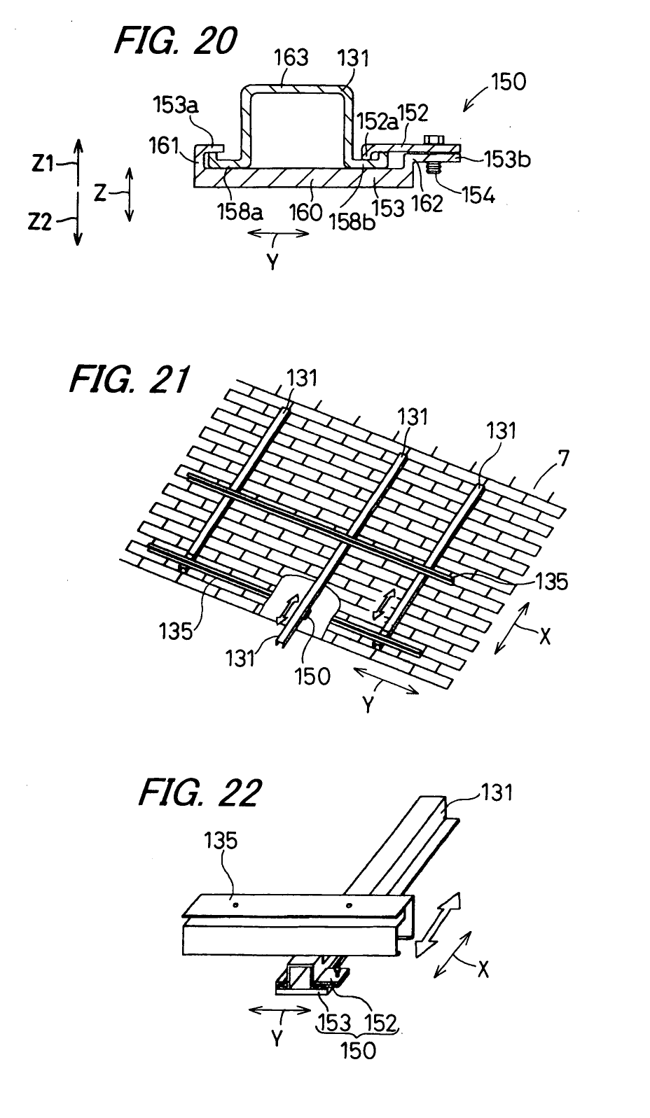

FIG. 13 is a schematic view when the base rail 131 of the fixing apparatus 130 according to the invention is attached onto the roof, FIG. 14 is a schematic view when the holder supporting member 132 of the fixing apparatus 130 according to the invention is attached onto the base rail 131, FIG. 15 is a schematic view when the holder 135 of the fixing apparatus 130 according to the invention is attached onto the holder supporting member 132, FIG. 16 is a schematic view when the solar cell module 11 is fixed to the fixing apparatus 130 according to the invention, FIG. 17 is a schematic view when the solar cell module 11 is fixed to the fixing apparatus 130 according to the invention, FIG. 18 is a plan view schematically showing a behavior of constructing a solar cell array by the holder 135 using the fixing apparatus 130 according to the invention, FIGS. 19A through 19D are plan views showing a behavior of improving mounting of the solar cell module 11 on the roof by using the fixing apparatus 130 according to the invention, FIG. 20 is sectional views showing a structure of enabling to move the base rail 131 of the fixing apparatus 130 according to the invention on an installed face fixing metal piece and FIG. 21 is a perspective view viewed from an upper face of installing to the roof in the case where the base rail 131 is movable. FIG. 22 is a partial enlarged perspective view in the case where the base rail 131 is movable.

An explanation will be given of a procedure of construction of the solar cell module 11 as the object to be supported onto the roof by using the fixing apparatus 130 of the embodiment in reference to FIG. 13 through FIG. 18.

First, as shown in FIG. 13, a plurality of roof attaching members 32 for attaching the base rails 131 on the roof member 7 are fixed to the roof face by attaching screws or the like. As the roof attaching member 32, there may be selected a member used by what is the roof member of the roof of the house to be constructed and a restriction by the fixing apparatus 130 of the invention is not brought about. Although there is a wavy tile, a slate tile, a sheet metal or the like as the roof member 7 of the house, an explanation will be given of a roof of a slate tile using a tile in a plate-like shape according to the example.

After fixing the base rail 131 to the roof member via the roof attaching member 32, as shown in FIG. 14, a necessary number of holder supporting members 132 (132u, 132s, 132t) are arranged on the base rail 131. According to the example, two rows of solar cell arrays are constituted and therefore, three pieces of the holder 135 is needed and six pieces of the holder supporting members 132 are arranged. Thereafter, after correctly positioning the holder supporting member 132u disposed on the endmost side of the eaves of the roof, the holder supporting member 132u is fixed to the base rail 131 by the holder fixing member 133.

Further, at this occasion, although the holder supporting members 132s and 132t may be positioned to fix onto the base rail 1 by the holder fixing member 133, according to the example, the holder supporting members 132s and 132t are left in a movable state.

Next, as shown in FIG. 15, the holders 135 (135u, 135s, 135t) are respectively attached to the holder supporting members 132u, 132s and 132t. At this occasion, the holders 135s and 135t are freely movable on the base rail 131 along with the holder supporting members 132s and 132t and therefore, when the solar cell module 11a is inserted as shown in FIG. 16, the solar cell module 11a is inserted by constituting a base point by the holder 135u which has already been fixed, by moving down the holder 135s in accordance with the solar cell module 11, positioning of the holder 135s is automatically finished and therefore, operation in construction required in positioning the fixing apparatus 130 can be simplified and a number of construction steps can be reduced.

Further, with regard to a behavior of inserting the solar cell module 11 into the fixing apparatus 130, as shown in FIG. 8, an end portion 139 (frame portion) of the solar cell module 11 is inserted into the opening portion 135b of the holder 135 orthogonally attached onto the base rail 131 and the outer side pinching member 134 presses the solar cell module 11 to the side of the holder 135 to thereby pinch to fix the solar cell module 11.

Further, after mounting of the solar cell modules 11a and 11b has been finished, as shown in FIG. 17, the solar cell modules 11a and 11b are fixed by fixing the holder 135s to the base rail 131 by the holder supporting members 132s.

Similarly, after mounting the solar cell modules 11c and 11d as shown in FIG. 18, by fixing the holder 135t to the base rail 131 by the holder supporting members 132t, the solar cell array 149 is finished.

As described above, according to the fixing apparatus 130 of the invention, by arranging the holder supporting member 132 in a state of being able to move over an entire region on the base rail 131 (vertical rack), also the holder 135 (transverse rack) supported by the base rail 131 and the holder supporting member 132 can be moved on the base rail 131 along the longitudinal direction and therefore, when the base point is determined in attaching the solar cell module 11, attachment thereafter can be carried out all by gauging and accuracy of marking can be alleviated and a number of operational steps can considerably be reduced.

Further, owing to the structure of attaching the holder 135 on the base rail 131 by the holder supporting member 132, the solar cell module 11 can be mounted on the base rail 131 without closing the opening portion 135b of the holder 135 for inserting the solar cell module 11 an as shown in FIG. 19A, an exposed clearance of the base rail 131 (vertical rack) is not brought about between the solar cell modules 11 and an appearance of the roof is not deteriorated. Further, the roof area of an amount of the clearance by the base rail 131 is not reduced from the area capable of being utilized in solar power generation.

Further, the solar cell modules can also be mounted to shift in respective rows in accordance with the shape of the roof of the trapezoidal shape, the triangular shape, or the shape of a parallelogram as shown in FIGS. 19B through 19D and therefore, various arrangements of the solar cell modules can be selected and a rate of area capable of carrying out the solar power generation in the same roof can be promoted.

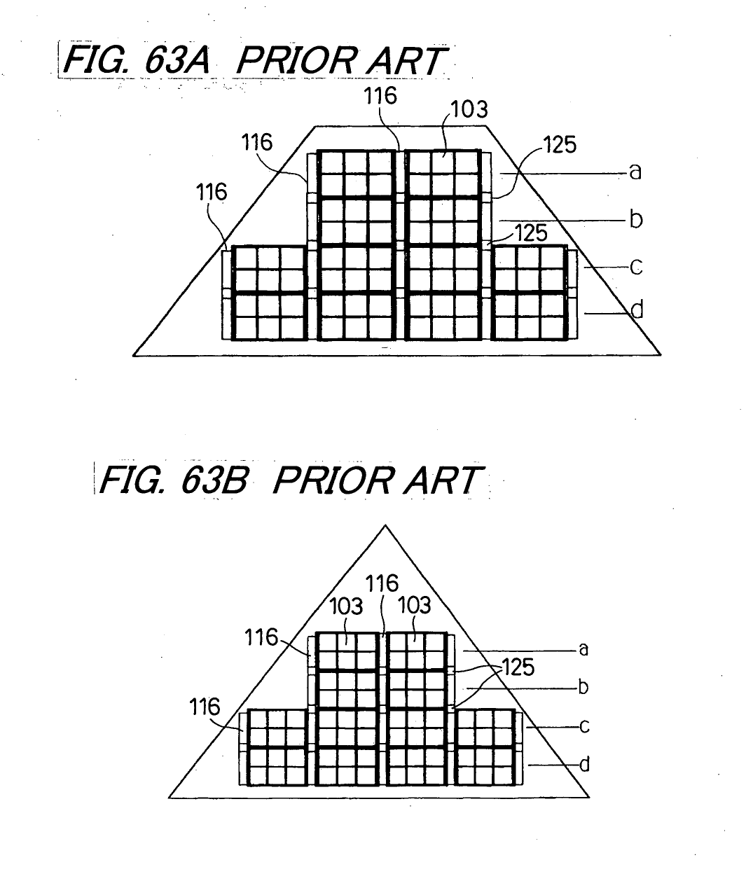

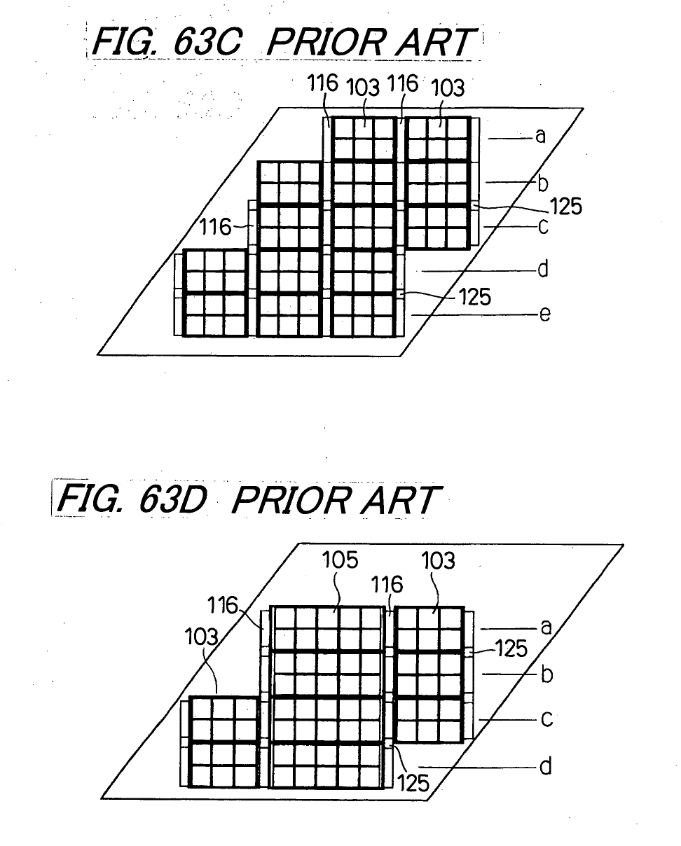

Specifically, in the case of the roof in the trapezoidal shape of FIG. 19B, in comparison with FIG. 63A of the related art, two sheets of the solar cell module 11 is increased to install and in the case of the roof in the triangular shape of FIG. 19C, in comparison with FIG. 63B of the related art, three sheets of the solar cell module 11 are increased to install. Further, in the case of arranging the solar cell modules 11 and 138 having different sizes as shown in FIG. 19D, the case can easily be dealt with.

Further, although not particularly illustrated, it is necessary to arrange a number of the holders 135 on the base rail 131 in the case of constituting the solar cell array by using a number of small-sized solar cell modules, since the holder supporting member 132 can be moved, an arrangement of the holder by any interval (irregular arrangement having different intervals can be dealt with) or any number of pieces thereof can be dealt with, further, since a number of steps of fixing the holder 135, the holder fixing member 132 and the solar cell module 11 is small, an effect of reducing the number of steps of construction is considerable in comparison with that of the construction method of the related art.

Further, as shown in FIG. 20, the base rail 131 may be pinched between a metal piece base 153 and a press metal piece 152 to fix. In this case, a base rail bottom portion 158a constituting one of locking portions in a rail-like shape provided at a lower portion of the base rail 131 is pinched between an upper pressing portion 153a of the metal piece base 153 and a bottom portion 160 of the metal piece base 153. Further, a base rail bottom portion 158b constituting the other of the locking portions in the rail-like shape provided at the lower portion of the base rail 131 is pinched between a claw portion 152a of the press metal piece 152 and the bottom portion 160 of the metal piece base 153, until fastening a fastening bolt 154, as shown in FIG. 21, the base rail 131 can be moved above the metal piece base 153 in a direction of the eaves of the roof and the house, that is, in the longitudinal direction of the base rail 131 and therefore, in construction, the base rail 131 is temporarily fixed (the fastening bolt 154 is fastened to a degree of not detaching the base rail 131), after attaching the holder 135 onto the base rail 131, the fastening bolt 154 of an installing face fixing metal piece 150 to pinch to fix the holder 135, thereby, the holder 135 can be moved along with the base rail 131 to thereby enable to position on the roof.

Specifically, the base includes the base rail 131 and the installing face fixing metal piece 150. The installing face fixing metal 150 is constituted by the metal piece base 153 and the press metal piece 152. The base includes a base fixing portion, a base moving portion and a base coupling portion. The base fixing portion is fixed to a building and is realized by the metal piece base 153 according to the embodiment. The base moving portion is provided to be movable in the inclined direction X relative to the metal piece base 153 by being guided by the metal piece base 153 to connect the holder supporting member 135. According to the embodiment, the base moving portion is realized by the base rail 131. The coupling portion hampers movement of the base rail 131 relative to the metal piece base 153. The base coupling portion is realized by the press metal piece 152.

The metal piece base 153 is fixed to the roof face and is extended in the inclined direction X. The metal piece base 153 is formed in a rail-like shape and is formed in a substantially U-like shape. The metal piece base 153 includes a bottom portion 160 and two guide portions 161, 162 respectively projected from both sides in the horizontal direction Y of the bottom portion 160 in the upper normal direction Z1.

The first guide portion 161 constituting one of the two guide portions is extended to other guide portion 162 thereof at a first front end portion 153a constituting a front end portion thereof. That is, the bottom portion 160 and the first front end portion 153a are opposed to each other by opening a clearance in a thickness direction Z. The first front end portion 153a constitutes the upper holding portion 153a mentioned above. The second guide portion 162 constituting other of the two guide portions is extended in a direction of being separated from the one guide portion 161 at the second front end portion 153b constituting a front end portion thereof. The second front end portion 153b is formed by inserting a screw hole screwed with the fastening bolt 154 in the normal direction Z.

The press metal piece 152 is formed with a screw hole inserted with the above-described fastening bolt 154. The fastening bolt 154 is inserted through the screw hole of the second front end portion 153b by being inserted through the screw hole of the fastening bolt 154. By screwing the fastening bolt 154 to the second front end portion 153b, the press metal piece 152 is moved to the second front end portion 153b. The press metal piece 152 is extended from the second front end portion 153b to the first front end portion 153a. The press metal piece 152 is formed with the claw portion 152a at a front end thereof. In a state of being screwed to the second front end portion 153 by the fastening bolt 154, the press metal piece 152 is opposed to the bottom portion 160 of the metal piece base 153 at the claw portion 152a and is bent to the lower normal direction Z2 in comparison with a remaining portion of the press metal piece 152.

The base rail 131 is formed in an elongated shape and a longitudinal direction thereof is fixed along the inclined direction X of the roof. The base rail 131 is formed with a main body portion 163 whose cross sectional shape in a cross sectional surface perpendicular to the inclined direction X is formed in a substantially U-like shape and which extends in the inclined direction X and bottom portions 158a, 158b respectively projected from both sides of the main body portion 163 in the horizontal direction Y toward the outside in the horizontal direction Y.

The base rail 131 is mounted to the bottom portion 160 in a state of being guided by the respective guide portions 161, 162 of the metal piece base 153. At this occasion, the one bottom portion 158a of the two bottom portions 158a, 158b of the base rail 131 is contained between the bottom portion 160 of the metal piece base 153 and the first front end portion 153a. Further, the other bottom portion 158b of the two bottom portions 158a, 158b of the base rail 131 is contained between the bottom portion 160 of the metal piece base 153 and the claw portion 152a of the press metal piece 152.

By screwing the fastening bolt 154 to the second front end portion 153b, the press metal piece 152 approaches the metal piece base 153. Thereby, the claw portion 152a of the press metal piece 152 presses the other bottom portion 158b of the base rail 131 to the bottom portion 160 of the metal piece base 153. Thereby, the base rail 131 is fixed to the metal piece base 153. Further, the press metal piece 152 is separated from the metal piece base 153 by screwing to retract the fastening bolt 154 from the second front end portion 153b. Thereby, the claw portion 152a of the press metal piece 152 is separated from the base rail 131 and the base rail 131 becomes displaceable in the inclined direction X relative to the metal piece base 153.

Thereby, when the holder 135 disposed on the endmost side of the eaves is positioned horizontally relative to the eaves of the roof, even when there are various lengths of respective ones of the base rails 131 extruded to the eaves side, no problem is posed and therefore, accuracy of marking the base rail 131 is not needed and construction operation is further simplified. Further, according to the invention, also fixing the metal piece base 153 needs not to mark and therefore, construction is naturally further facilitated.

In this way, the invention is a fixing apparatus 130 which is a fixing apparatus for fixing an object to be installed in a flat plate shape, for example a solar cell module, to an installing face, the fixing apparatus 130 comprising a base rail 131 in an elongated shape fixed onto the installing face, a holder supporting member 132 movable in a longitudinal direction X of the base rail 131 by being guided by the base rail 131, a holder 135 in an elongated shape attached onto the base rail 131 by the holder supporting member 132 and movable in a direction Y orthogonal to the base rail 131, further comprising fixing means for fixing the object to be installed by the holder 135 or the holder 135 and an outer fitting member 134 and further including a holder fixing member 132 for fixing the holder supporting member 132 and the holder 135 onto the base rail 131.

Further, the invention is characterized in further comprising a locking portion 132a in a rail-like shape for locking the holder 135 on the base rail 131 in a direction Y orthogonal to the base rail 131, further comprising a locking portion 135a in a rail-like shape for locking the holder 135 on the base rail 131 by a locking portion 132a of the holder supporting member 132 at a lower portion of the holder 135, wherein the locking portion 132a provided at the holder supporting member 132 and the locking portion 135a provided at the lower portion of the holder 135 are engaged with each other.

Further, the invention is characterized in further comprising a locking portion 158a in a rail-like shape at a lower portion of the base rail 131 and installing face fixing metal piece 150 for engaging with a locking portion 158a of the base rail 131 at the installing face to be able to move in a longitudinal direction of the base rail 131 on the installing face installed with the base rail 131.

Further, although according to the embodiment, the holder supporting member 132 is pinched to fix on an inner side of the holder 135, the holder supporting member 132 may be pinched to fix on the outer side thereof, further, the base rail 131 may be constituted by a rail in a U-like shape arranged with a groove at an upper face thereof to thereby enable to move the holder supporting member 132 on the inner side. Further, the base rail 131 may be pinched to fix by the installing face fixing metal piece 150 on the inner side of the base rail 131. Further, although an explanation has been given by taking an example of the solar cell module 11 as the object to be installed, the invention is not limited thereto but is applicable preferably to apparatus of utilizing solar energy in a shape of a flat plate such as a solar heat collector or the like and the invention can be embodied by pertinently changing the invention within a range not deviated from the gist of the invention.

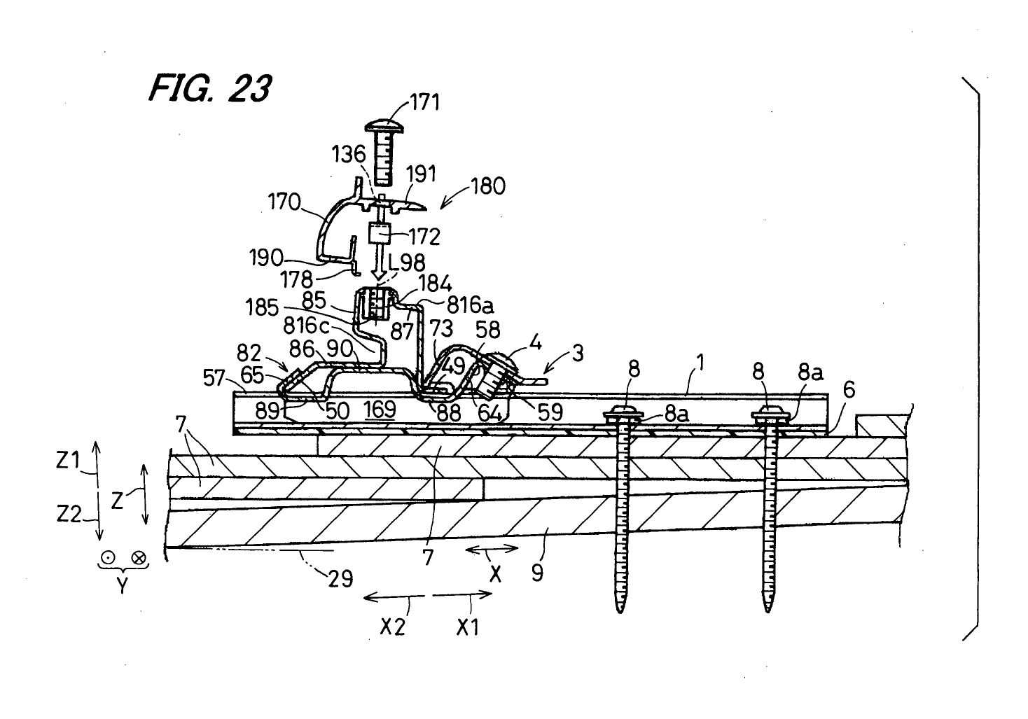

FIG. 23 is a sectional view showing an example of a fixing apparatus 180 according to a third embodiment of the invention. Further, the same components as those of the fixing apparatus shown in FIG. 6 will be denoted by the same reference numerals, and an explanation thereof will be omitted. As described later, the fixing apparatus of the invention is a fixing apparatus 180 for arranging a plurality of the holders 85, substantially in parallel with each other in a house-eaves direction of the inclined roof, mounting a side of the house side and a side of the eaves side of the solar cell module 11 and 23 in the shape of the flat plate on each of the holders 85 disposed on the house side and on the eaves side and containing the side on the house side and the side on the eaves side of the solar cell module 11 and 23 at each of two recess portions formed by the holders 85 and the fixing covers 170 covering the holder 85, particularly comprising fastening means 171 for pressing the solar cell module 11 and 23 mounted above the holder 85 by the fixing cover 170 and the holder 85, and interval maintaining means 172 for maintaining intervals in the two recess portions before pressing further widely after pressing.

First, an explanation will be given of fixing apparatus 180 for fixing the solar cell module 11 in the shape of the flat plate on the inclined roof. As shown in FIG. 23, the fixing apparatus 180 is fixed the base rail 1 to the roof board 9 or the rafter by penetrating the roof member 7 via the seal member 6 by the fixing screw 8. The seal member 6 is preferably achieve an effect of preventing rain water or the like from invading from a penetrated portion of the roof member 7 and an effect of damping a load applied from the holder 85 to the roof member, mentioned later, and the seal member 6 made of butyl rubber or made of foamed rubber is used. Further, a packing 8a is mounted to a neck portion of the fixing screw 8 to prevent rain water from invading.

Further, the base rail 1 is provided with a slit at an upper face portion thereof, the holder supporting member 82 is inserted into the slit and therefore, the holder supporting member 82 can freely be moved in the inclined direction X at inside of the base rail 1. Further, the holder supporting member 82 is provided with a height such that the bottom portion 169 does not sink into the base rail 1 and an upper portion thereof is exposed above the base rail 1. One end of the holder supporting member 82 is attached with the holder fixing member 3 by the screw 4. Further, by fastening the screw 4, the holder supporting member 82 can be fixed at an arbitrary position on the base rail 1. Further, such a constitution is explained with regard to FIGS. 1 and 6 and an explanation will be omitted.

Further, the holder supporting member 82 is inserted with the holder 85, and by fastening the screw 4, the holder 85 can be fixed at an arbitrary position on the base rail 1 along with the holder supporting member 82. Further, the fixing cover 170 is attached onto the holder 85 along with the interval maintaining member 172 constituting the interval holding means by the fastening screw 171.

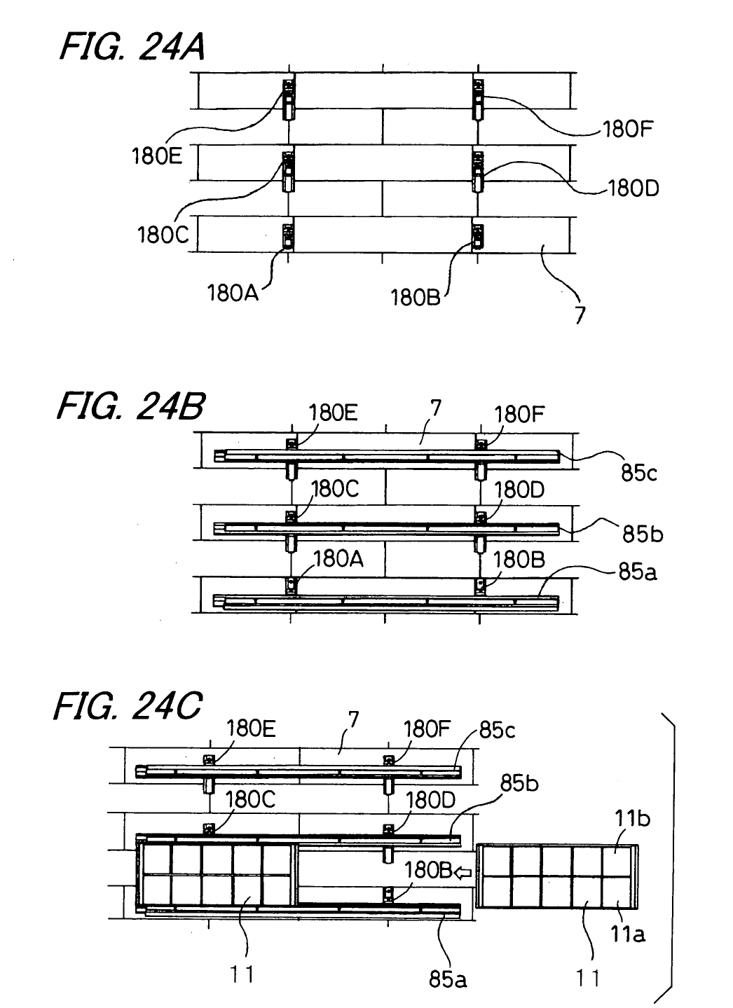

An explanation will be given of a method of installing the solar cell module 11 and 23 on the roof by using the fixing means 180 of an object to be installed according to the invention in accordance with a construction procedure as follows. As shown in FIG. 24A, the fixing apparatus 180A through 180F are fixed to the roof member 7 of slate tile or the like arranged on the roof of a house or the like. Further, as shown in FIG. 24B, the holders 85 (85a, 85b, 85c) are inserted at constant intervals horizontally on the roof by pairing 180A and 180B, 180C and 180D, and 180E and 18OF of the fixing apparatus 180. At this occasion, the fixing cover 170 may previously be attached onto the holder 85 by the fastening screw 171 constituting the fastening means.

Here, the object to be installed, the fixing apparatus 180, the holder 85 and the fixing cover 170 are constituted by a metal of aluminum alloy, steel or the like subjected to surface treatment, resin or the like having waterproof performance. Further, as shown in FIG. 24C, the solar cell module 11 is supported by the house side of the holder 85a and the eaves side of the holder 85b.

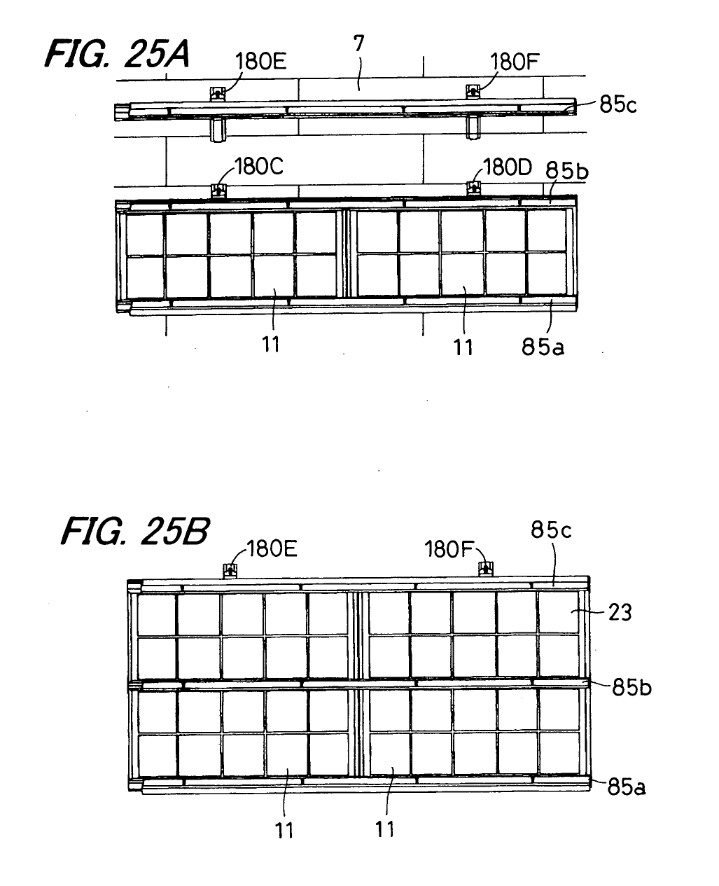

Further, after finishing arrangement and wiring check of all of the solar cell modules 11 and 23 as shown in FIGS. 25A and 25B, the solar cell modules 11 and 23 are fixed by fastening the screws 171 of the fixing covers 170 of the holders 85a, 85b and 85c to thereby finish the solar cell array. At this occasion, the eaves side of the solar cell module 11 and 23 is constituted by a mode of being caught by the holder 85 and therefore, the solar cell module 11 and 23 is not slipped to drop even in a temporary installation state.

Further, although according to the embodiment, the object to be installed and the fixing apparatus 180 are independently provided for each of the holder 85, the fixing apparatus 180 may be a fixing member referred to as longitudinal piece for attaching a plurality of the holders 85 in the inclined direction of the roof face. Further, a length of the holder 85 may be more prolonged to be supported by a number of the fixing apparatus 180 of the object to be installed. Further, the solar cell module 11 and 23 may be started to install from the house side of the roof and the screw may successively be fixed from a location finished with arrangement of the solar cell module 11 and 23 to the holder 85.

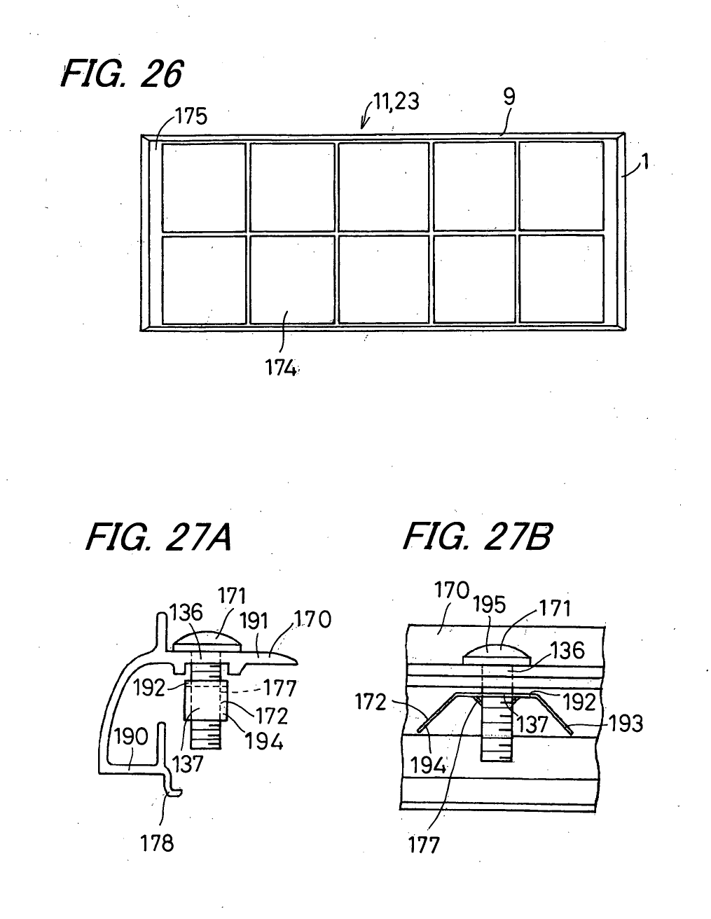

Next, an explanation will be given of a behavior of arranging the solar cell module 11 and 23 between the holder 85. As shown in FIG. 26, the solar cell module 11 and 23 are formed by mounting a frame 175 at four sides of a solar cell main body 174. However, the frame 175 is not necessarily be needed but the solar cell module 11 and 23 can also be constituted only by the solar cell main body 174. The frame 175 is constituted by a metal material excellent in workability of aluminum or the like or a molded product of resin. Further, generally, the solar cell main body 174 is provided with a transparent board of glass, resin or the like at a light receiving face thereof, the transparent board is pasted with a rear face member by a seal member comprising resin or the like containing a number of solar cell elements, as the solar cell element, a single crystal, polycrystal or amorphous material of, for example, silicon species semiconductor, or a compound semiconductor comprising gallium arsenic or the like is used and the solar cell elements are electrically connected in series and/or in parallel with each other and an output is outputted to outside.

As shown in FIGS. 27A and 27B, the fixing cover 170 is attached with the fastening screw 171 and the interval maintaining member 172 and can be screwed by a screw fixing member 184 constituting fastening means provided at the holder 85. Although the interval maintaining member 172 may be constituted by a metal, resin or the like having elasticity, further, by constituting a shape thereof to pinch a neck portion 177 of the fastening screw 171, useless slack of the fastening screw 171 can preferably be prevented. Further, by using a metal material for the interval maintaining member 172, electric conduction between the holder 85 and the fixing cover 170 can be ensured to be able to escape static electricity, which is further preferable. Further, it is preferable to provide a folded piece 178 at a lower portion of the fixing cover 170 to prevent the solar cell module 11 from moving in a flow direction, that is the inclined direction X of the roof when the fixing cover 170 is attached to the holder 85.

Specifically, the solar cell module 11, 23 are fixed to the holder 85 by being pinched by the holder 85 and the fixing cover 170. The holder 85 is formed with a through hole 185 screwed with the fastening screw 171. An axis line L98 of the through hole 185 is extended along the normal direction Z. The fixing cover 170 is formed with a through hole 136 for screwing the fastening screw 171. The fixing cover 170 is mounted to the holder 85 by inserting the fastening screw 171 to the through hole 136 of the fixing cover 170 and further inserting the fastening screw 171 through the through hole 185 of the holder 85. At this occasion, the fixing cover 170 is formed with a first opposed portion 190 opposed to the lower mounting portion 86 of the holder 85 and a second opposed portion 191 opposed to the upper mounting portion 87 of the holder 85. The fixing cover 170 and the fastening screw 171 constitute install object fixing members for fixing the solar cell module 11, 23 to the holder 85.

In a state in which the solar cell modules, 11, 23 are mounted to the respective mounting portions 86, 87 of the holder 85, by screwing the fastening screw 171 to the holder 85, the fixing cover 170 can be pressed to the solar cell modules 11, 23. Thereby, the solar cell modules 11, 23 are pinched by the fixing cover 170 and the holder 85. That is, the solar cell modules 11, 23 are fixed to the roof face.

The interval holding member 172 is provided at a vicinity of the neck portion 177 of the screw groove forming portion of the fastening screw 171 in a state of inserting the fastening screw 171 through the fixing cover 170. The interval holding member 172 includes a connecting portion 192 connected to the fastening screw 171 and spring portions 193, 194 respectively extended from the connecting portion 192 to both sides thereof. The spring portions 193, 194 are extended in directions separating from each other and extended in directions separating from the head portion 195 of the fastening screw 171 in an axis line direction of the fastening screw 171. The spring portions 193, 194 are provided with spring performance. The connecting portion 192 is provided with a through hole 137 which is penetrated in a state where the fastening screw 171 screws together the connecting portion 192.

By screwing the fastening screw 171 to the holder 85 under the state, the spring portions 193, 194 of the interval holding member 172 are brought into contact with an upper face of the holder 85. By screwing the fastening screw 171 further to the holder 85, the fixing cover 170 is moved to the holder 85 to pinch the solar cell modules 11, 23 by the fixing cover 170 and the holder 85. At this occasion, the interval holding member 172 is elastically deformed to exert a force in a direction of separating from the holder 85 to the fixing cover 170. When the fastening screw 171 is loosened, the fixing cover 170 is held in a state of a large interval between the fixing cover 170 and the holder 85 by the spring force exerted from the interval holding member 172. Further, the interval between the interval holding member 172 and the fixing cover 170 can accurately be held without deviating the spring force by forming the two spring portions 193, 194. Further, the interval holding member 172 can be a nut penetrated by the fastening screw 171.

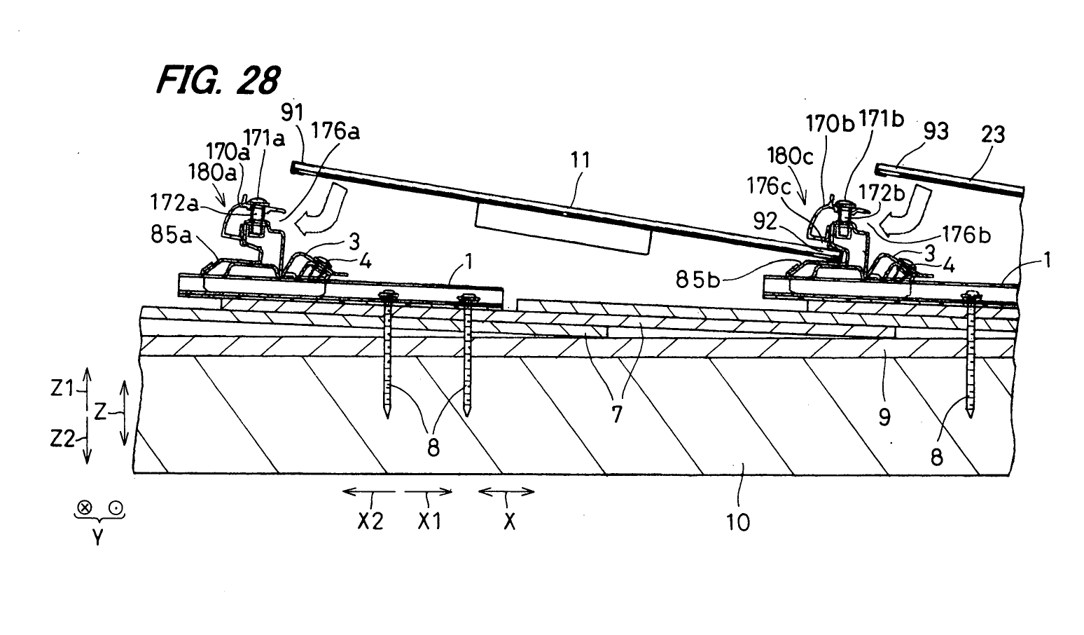

Next, an explanation will be given of a behavior of fixing the solar cell module 11 and 23 by the holder 85 and the fixing apparatus 180. When the solar cell module 11 and 23 is fixed between the holders 85a and 85b attached with the fixing apparatus 180a and 180c fixed onto the roof as shown in FIG. 28, first, the hour side peripheral edge portion 92 of the solar cell module 11 is inserted into the opening portion 176c constituting the recess portion of the holder 85b. At this occasion, the fixing cover 170b is pulled up to an upper side by the interval maintaining member 172b attached to the fastening screw 171b, mentioned above, and therefore, a state wider than a state of fastening the fastening screw 171b is maintained in the house direction and the opening portion 176c can be ensured with a depth sufficient for inserting the solar cell module 11. Thereby, the eaves side peripheral edge portion 91 of the solar cell module 11 can be brought into the house side more than the fixing cover 170a attached at the upper portion of the holder 85a and therefore, the eaves side 91 is inserted into the opening portion 176a constituting the recess portion constituted by the fixing cover 170a and the holder 85a. When the solar cell module is not arranged on the eaves side of the holder 85a at the time point, the fastening screw 171a is fastened. Thereby, the eaves side 91 of the solar cell module 11 is pinched by the fixing cover 170a and the holder 85a to fix.

Next, by a similar procedure, the eaves side 93 of the solar cell module 23 arranged on the house side of the holder 85 is inserted into the opening portion 176b constituting the recess portion constituted by the fixing cover 170b and the holder 85b and the house side of the solar cell module 11 and the eaves side 93 of the solar cell module 23 are pinched by the fixing cover 170b and the holder 85b to fix by fastening the fastening screw 171b.

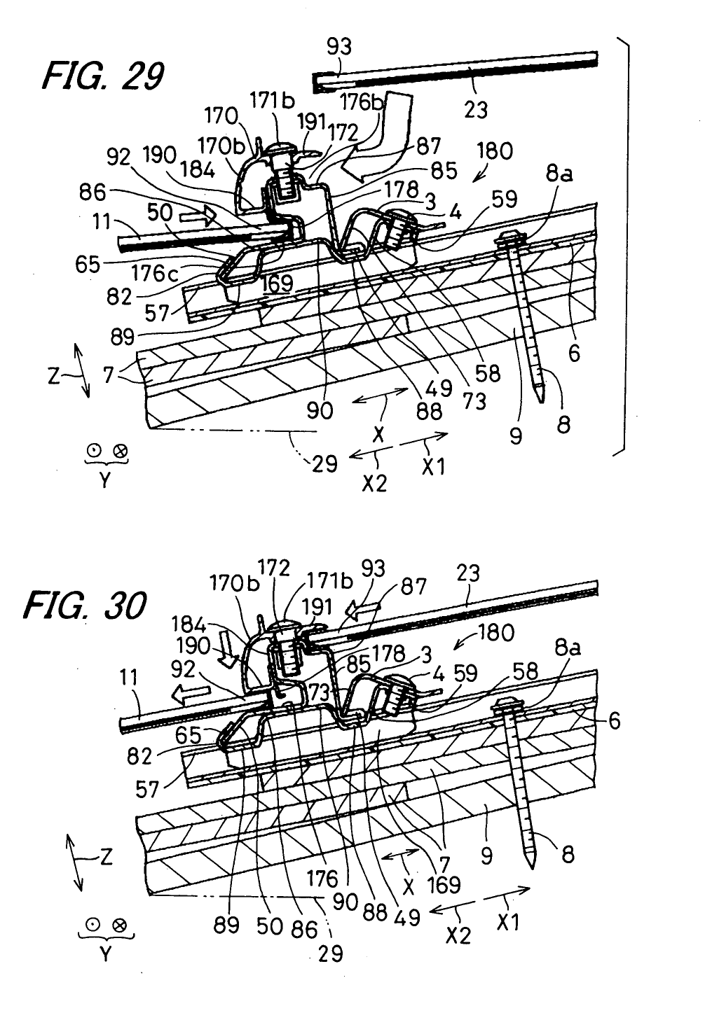

FIG. 29 shows a state in inserting the solar cell modules 11 and 23 and FIG. 30 shows a state of fixing the solar cell module 11 by fastening the fastening screw 171. Further, as shown in FIG. 29, the house side peripheral edge portion 92 of the solar cell module 11 is prevented from moving to the house side by the folded piece 178 provided at the lower portion of the fixing cover 170b, thereby, a detachment thereof is prevented. Further, when the solar cell modules 11 and 23 are arranged to the holders 85a and 85b, the opening portions (recess portion) for inserting and fixing the solar cell modules 11 and 23 can be ensured with spaces wider than a thickness of the solar cell module 11 and 23 and construction performance is promoted.

Further, the fixing cover 170b is pulled up to the upper side by the interval maintaining member 172 attached to the fastening screw 171 as described above and therefore, by loosening again the fastening screw 171b, a space wider than the fastened state is ensured in the house direction, that is, the inclined direction X and by inserting the solar cell module 11 to a further depth side of the opening portion 176c, the solar cell module 11 can easily be removed.

As described in details as mentioned above, according to the fixing apparatus 180, even in the case of an object to be installed, for example, a solar cell module 11 and 23 using a light and thin member for a frame member thereof, rigidity thereof can be maintained in a state of being attached to the holder 85. Further, construction operation of a solar cell module 11 and 23 is simple and the object can easily be attached and detached. Further, even the solar cell module 11 and 23 using the light and thin member for the holder member is not slipped to drop in temporarily installing and construction operation can safely be carried out.

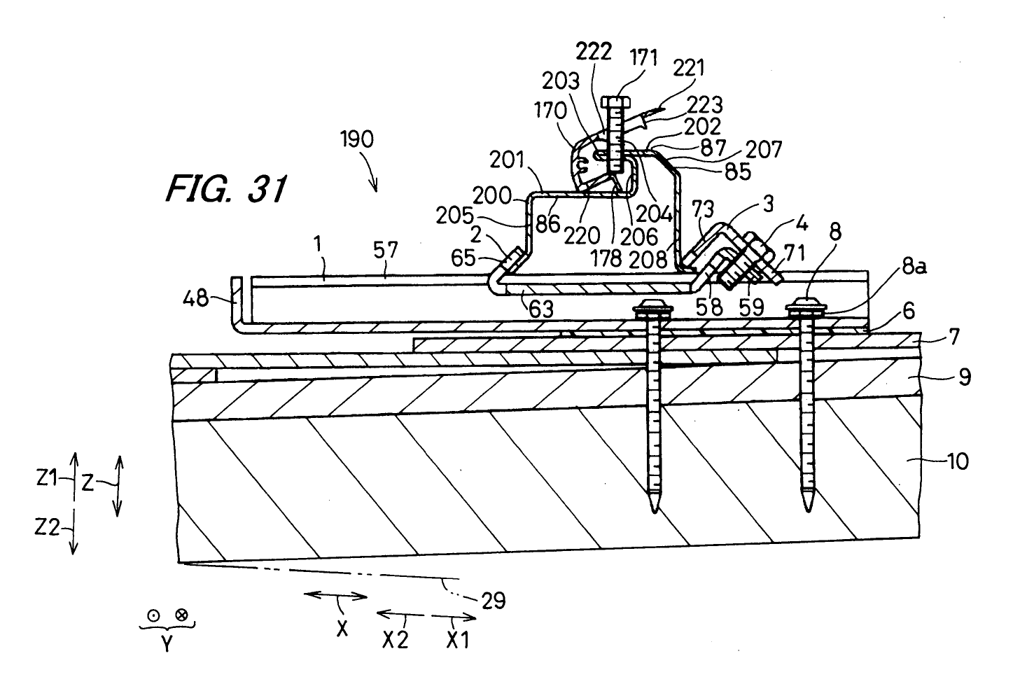

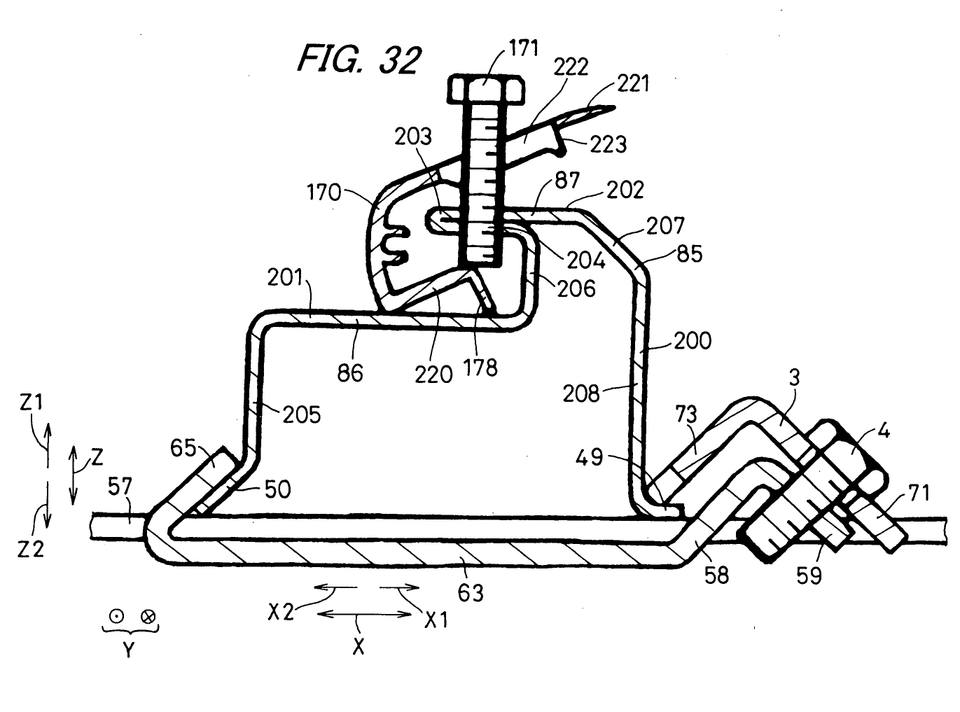

FIG. 31 is a sectional view showing an example of a fixing apparatus 190 according to a fourth embodiment of the invention. FIG. 32 is a view enlarging a portion of FIG. 31. Further, the same components as those of the fixing apparatus shown in FIG. 6 will be denoted by the same reference numerals, and an explanation thereof will be omitted. As shown in FIG. 31, the holder 85 is constituted by a structure of mounting the elongated fixing cover 170 for pressing to fix the solar cell module 11 and 23 on the upper side of an elongated main body portion 200 by the fastening screw 171. The main body portion 200 includes an eaves side mounting face 201 for mounting an eaves side peripheral edge portion 91 of the solar cell module 11 disposed on the lower side in a pair of the solar cell modules 11 and 23 adjacent to each other in the inclined direction X of the roof, a house side mounting face 202 provided to be higher than the eaves side mounting face 201 for mounting an eaves side peripheral edge portion 93 of other solar cell module 23, an eaves piece 203 which continuously extends in the inclined direction X from the house side mounting face 202 and is projected out above the eaves side mounting face 201 and a screw hole 204 provided at the eaves piece 203 for fitting the fastening screw 171.

As described above, when cut by an imaginary face perpendicular to the horizontal direction Y, the holder 85 is formed with the main body portion 200 formed in a substantially U-like shape, the first flange portion 49 and the second flange portion 50 as mentioned above. The main body portion 200 is formed by further including a first raised portion 205, a eaves side mounting portion 86, a second raised portion 206, an eaves piece 203, a house side mounding portion 87, a guide portion 207 and a third raised portion 208.

The second flange portion 50 is continuous to the first raised portion 205 of the main body portion 200. The first raised portion 205 is raised from a portion continuous to the second flange portion 50 in the one normal direction Z1 and is continuous to the eaves side mounting portion 86. The lower mounting portion 86 is formed with an eaves side mounting face 201 mounting the eaves peripheral edge portion 91 of the solar cell module 11 disposed on the lower side and in parallel with the base rail 1. The lower mounting portion 86 connects the first raised portion 205 and the second raised portion 206. The second raised portion 206 is raised from a portion continuous to the lower mounting portion 86 in the upper normal direction Z1 and is continuous to the eaves piece 203. The eaves piece 203 is extended opposedly to the lower mounting portion 86. The eaves piece 203 is formed with a screw hole 204 for screwing the fastening screw 171. Further, an extended line of the axis line of the screw hole 204 passes the lower mounting portion 86.

The eaves piece 203 is continuous to the upper mounting portion 87. The upper mounting portion 87 is formed with a house side mounting face 202 mounting the eaves side peripheral edge portion 93 of the solar cell module 23 disposed on the upper side and in parallel with the base rail 1. The upper mounting portion 87 connects the eaves piece 203 and the guide portion 207. The guide portion 207 is lowered from a portion continuous to the upper mounting portion 87 in the other normal direction Z2. The guide portion 207 is inclined in the one normal direction Z2 as proceeding in the upper inclined direction X1. The guide portion 207 is inclined in the one normal direction Z2 as proceeding in the other inclined direction X1. The guide portion 207 connects the upper side mounting portion 87 and the third raised portion 208. The third raised portion 208 is lowered from a portion continuous to the guide portion 207 in the other normal direction Z2 and is continuous to the first flange portion 49.

The fixing cover 170 includes an eaves side press piece 221 for pressing the solar cell module 11 from the upper side, a house side press piece 221 provided to be higher than the eaves side press piece 220 and a through hole 220 for inserting the fastening screw 171.

Further, the fixing cover 170 includes the folded piece 178. The folded piece 178 is bent from an end portion in the upper inclined direction X1 of the eaves side press piece 220 in a direction of separating from the house side press piece 221. Further, the projection 223 of the fixing cover 170 is projected from the house side press piece 221 in the same direction as the folded piece 178.

According to the embodiment, a section of the fixing cover 170 is constituted by a substantially U-like shape and an upper piece thereof is constituted by the house side press piece 221 and a lower piece thereof is constituted by the eaves side press piece 220. Further, the through hole 222 provided at the eaves side press piece 221 is constituted by an elongated hole and the fixing cover 170 can be arranged differently between a state before use and a state of use, mentioned later. Further, a vicinity of a front end portion of the house side press piece 221 is provided with a projection 223 directed downwardly and the projection projected downwardly temporarily fixes the solar cell module 23 in the state before use and positions the solar cell module 23 in the state of use.

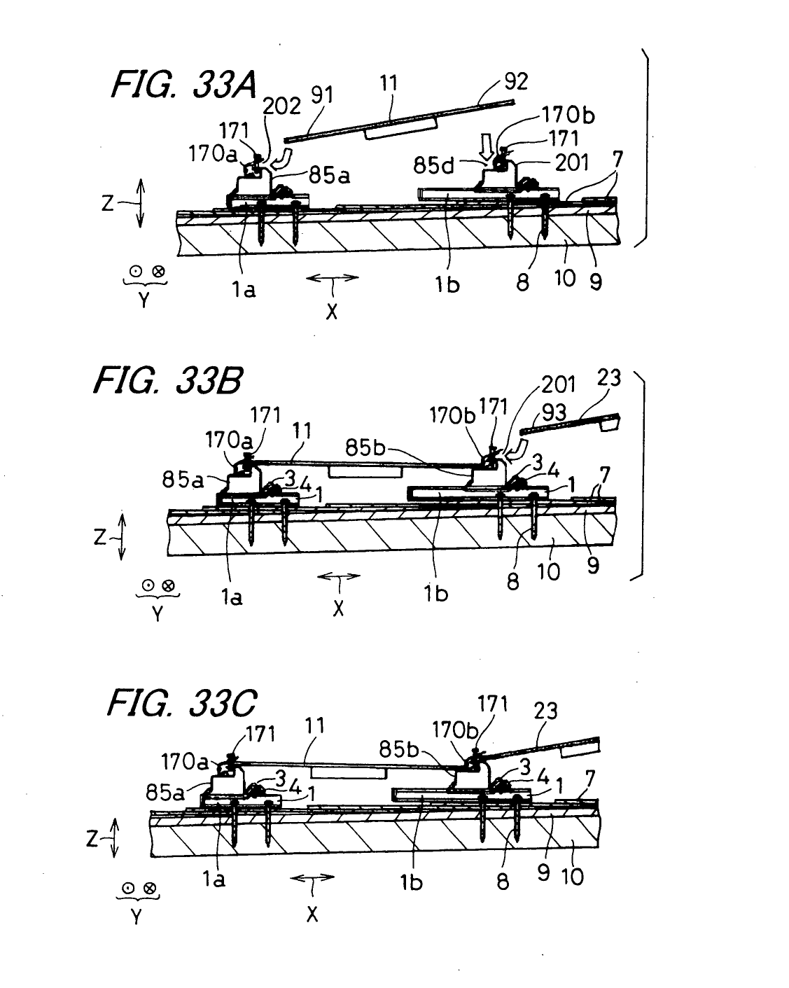

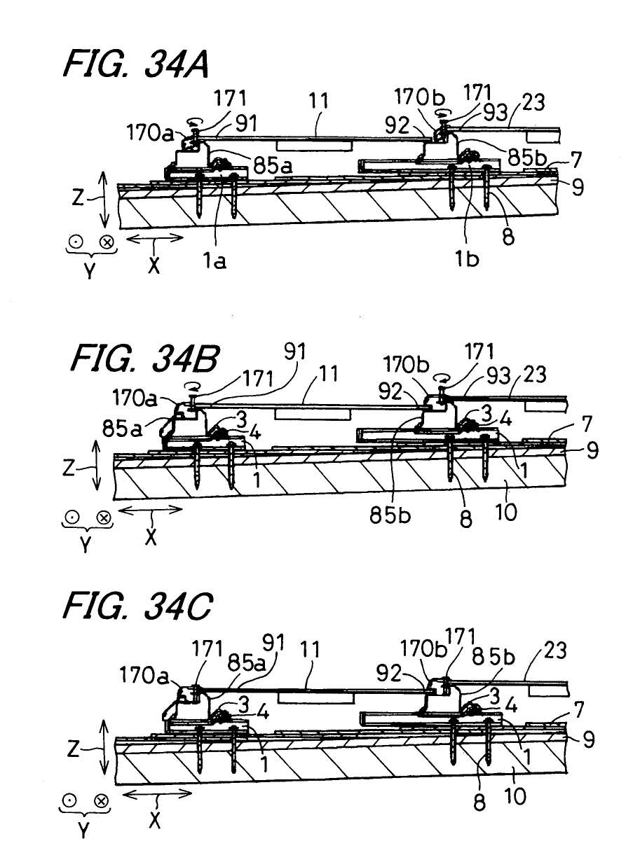

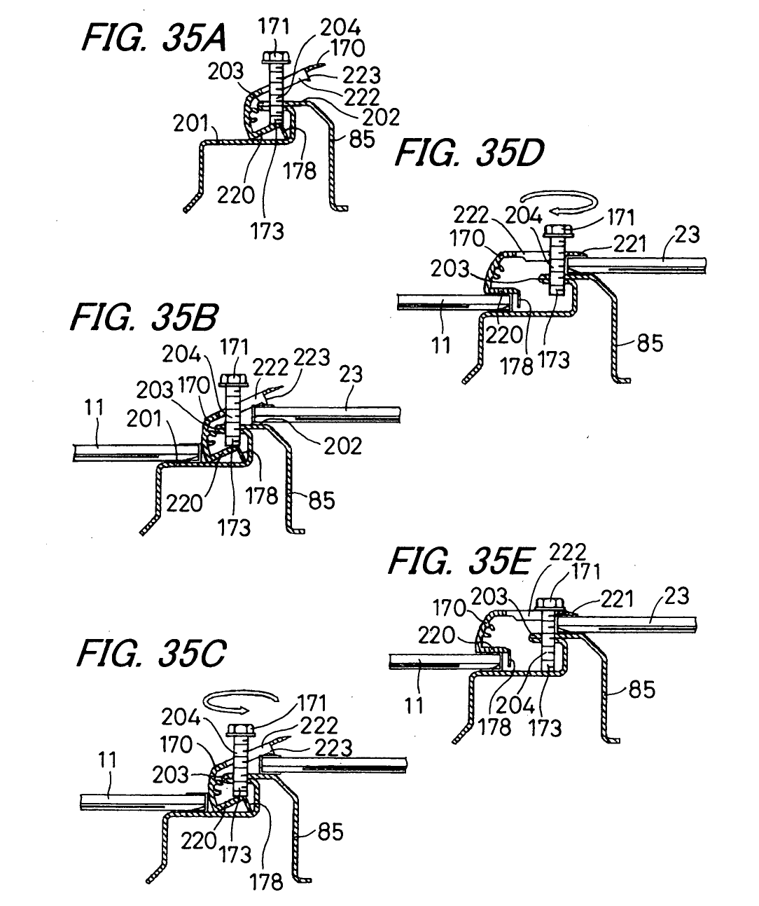

Next, FIGS. 33A, 33B and 33C and FIGS. 34A, 34B and 34C show a detailed procedure of attaching the solar cell module by using the holder 85 for the roof fixed on the roof by the base rail 1. FIGS. 35A, 35B, 35C, 35D and 35E are views showing the procedure particularly centering on the holder 5.

As shown in FIG. 33A, when the solar cell module 11 is fixed between the holders 85a and 85b attached to the bases rail 1a and 1b fixed on the roof, first, an eaves side peripheral edge portion 91 of the solar cell module 11 is mounted to a house side mounting portion 202 of the holder 85a. Successively, while falling down the solar cell module 11 in the house side direction, that is, toward the roof surface, a house side peripheral edge portion 92 of the solar cell module 11 is mounted to an eaves side mounting portion 202 of the holder 85b. Next, as shown in FIGS. 33B and 33C, an eaves side peripheral edge portion 93 of the solar cell module 23 is arranged on the house side of the holder 85b is mounted to a house side mounting portion 202 of the holder 85b by a similar procedure.

At this occasion, as shown in FIGS. 35A and 35B, in a state in which the peripheral portions of the solar cell modules 11 and 23 can be mounted to the mounting faces 201 and 202 of the main body portion 200, by pressing the eaves side press piece 220 of the fixing cover 170 to the eaves side mounting face 201 of the main body portion 200 by a front end portion 173 of the fastening screw 171, there is brought about a state of fixing the fixing cover 170 to the main body portion 200 and a state of mounting the peripheral edge portions 91 and 92 of the solar cell modules 11 and 23 to the mounting faces 201 and 202 of the main body portion 200 and temporarily fixing the solar cell module 23 by the projection 223 directed downwardly in addition thereto (state before use).

Meanwhile, in installing the solar cell modules 11 and 23, considering operation of confirming wirings after arrangement, it is preferable that the solar cell module can safely be temporarily fixed and can be fixed after confirming wirings. Hence, as shown in FIG. 35A, the fixing cover 170 and the holder 85 are temporarily fixed in a state of inclining the fixing cover 170 by the fastening screw 171 to constitute an eaves side receiving portion of the solar cell module 11. At this occasion, in such a state, the solar cell module 11 is temporarily fixed not on the roof to be installed but by operation on the ground, or the solar cell module 11 is temporarily fixed to deliver in delivery at a factory, thereby, operation of engaging a number of the fastening screws 171 to taps of the screw hole 204 the holder 85 to fasten finely on the roof can be dispensed with. Further, by constituting the folded piece 178 of the fixing cover 170 by a structure of being fastened by the fastening screw 171 to temporarily fix, slack of the fastening screw 171 is prevented by spring performance of the folded piece 178. Therefore, even when the solar cell module is temporarily fixed in delivery at a factory, the solar cell module is not loosened or detached in transportation. Further, the folded piece 178 operates also as a stopper for positioning the solar cell module 11.

When the solar cell module is finished to arrange, wirings are confirmed and as shown in FIG. 34A, the fastening screw 171 is temporarily loosened to bring the fixing covers 170a and 170b in a moving state, as shown in FIG. 34B, the fixing covers 170a and 170b are moved to positions of fixing the solar cell module 11 and 23 to fasten the fastening screw 171a and 171b again, thereby, as shown in FIG. 34C, the house side peripheral edge portion 92 of the solar cell module 11 and the eaves side peripheral edge portion 93 of the solar cell module 23 are pinched by the fixing covers 170a and 170b and the holders 85a and 85b to fix. Further, details in loosening and fastening again the fastening screw 171 are shown in FIGS. 35C through 35E.

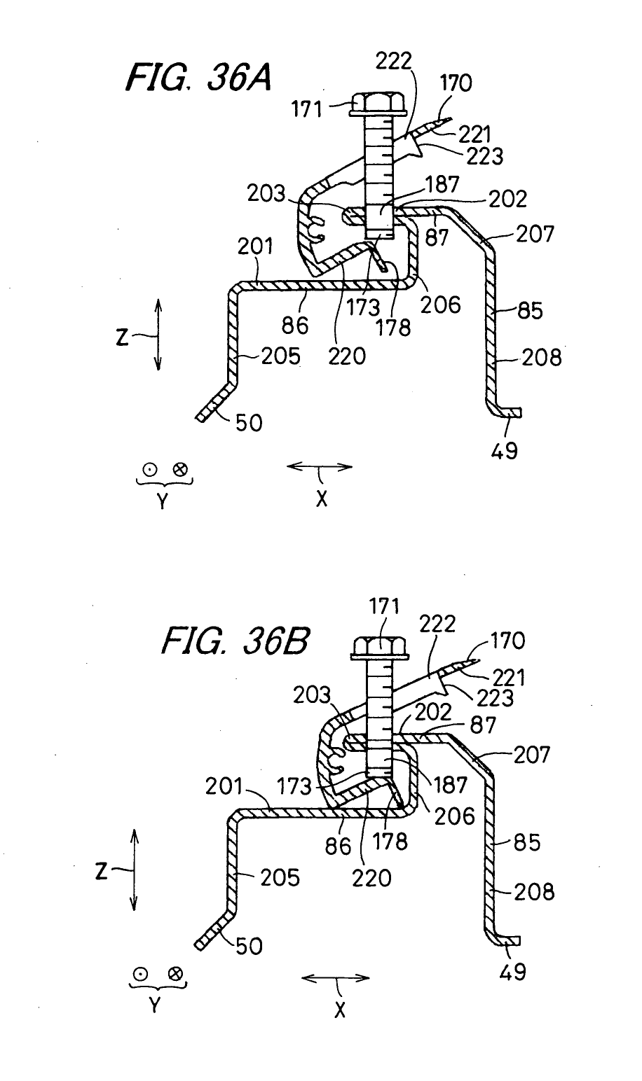

Next, FIGS. 36A and 36B show a holder 85 according to other embodiment. As shown in FIG. 36A, there is not a screw at a portion of a middle portion of the fastening screw 171 and by providing an unscrewed portion 187 a diameter of which is smaller than a valley diameter of the screw, similarly, the fastening screw 171 can be prevented from being slacked and can be prevented from being detached. That is, when the fastening screw 171 is fastened more deeply than the unscrewed portion 187, even when the screw is slacked up to the unscrewed portion 187 by vibration or the like, the screw is not engaged with a screw at a front end of the unscrewed portion 187 and is not slacked frontward from the unscrewed portion 187. Further, by also using the above-described two slack preventing methods as shown in FIG. 36B, even when fixing by the folded piece 178 is accidentally loosened, loosening is stopped by the unscrewed portion 187 and therefore, a double detachment preventing effect is achieved.

That is, the fastening screw 171 is temporarily loosened, the fixing cover 170 is moved to a position of fixing the solar cell module 11 and thereafter, the fastening screw 171 is fastened again. Here, when the fastening screw 171 is provided with the unscrewed portion 187 as mentioned above, in temporarily loosening the screw, there is not a concern of detaching the fastening screw 171 with an impulse and even when a tool of an electric driver or the like is used, the operation can be progressed smoothly. On the other hand, the fastening screw 171 can be loosened to detach while being pulled up and therefore, maintenance performance is not deteriorated. In addition, in order to prevent detachment of the fastening screw 171, the outside diameter of the front end portion 173 of the fastening screw 171 may be larger than the inside diameter of the screw hole in a state where the fastening screw 171 is attached to the holder 85.

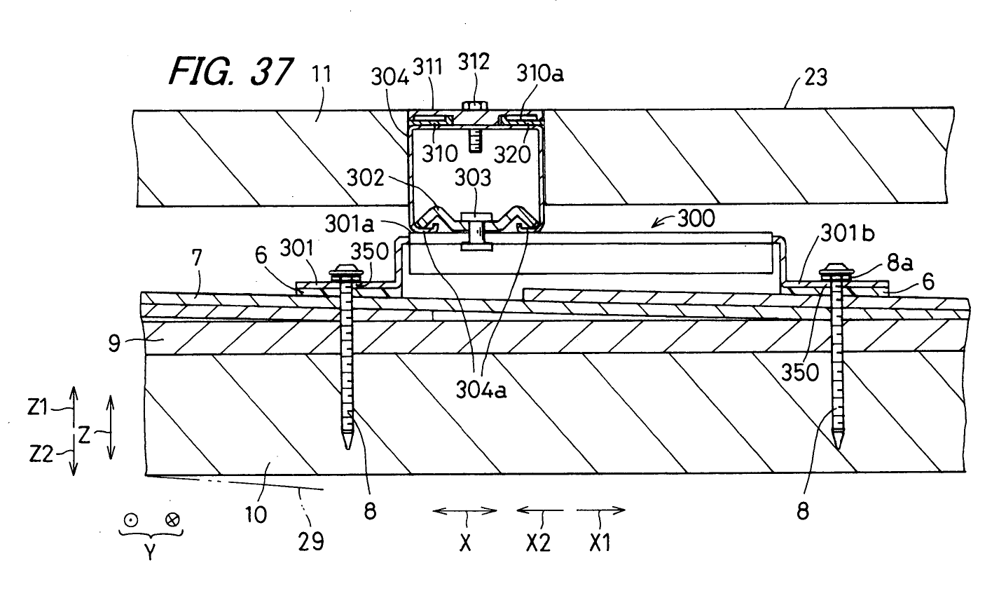

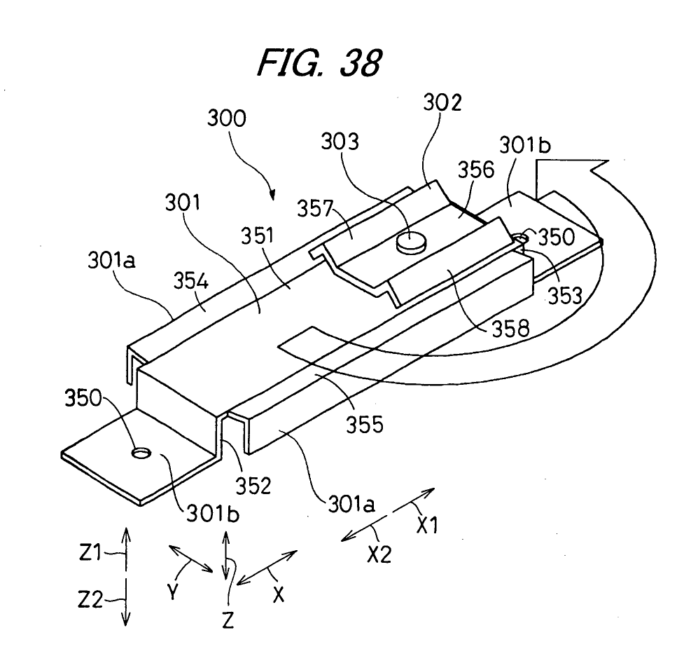

FIG. 37 is a sectional view showing a fixing apparatus 300 for a roof according to a fifth embodiment of the invention and FIG. 38 shows a portion thereof. The fixing apparatus 300 includes a base 301 and a restricting member 302 provided above the base 301 for restricting the holder 304 from being moved and the base 301 and the restricting member 302 are integrated to be pivotable as illustrated centering on a pivoting shaft 303 by the pivoting shaft 303 penetrating the two members in a vertical direction. Here, the pivoting shaft 303 is preferably a fastening member having a cylindrical shaft of rivet, bolt, nut or the like. Further, the base 301 includes a pressing portion 301a constituting a projected streak in a longitudinal direction as fixing means for fixing a holder 304, mentioned later.

According to the fixing apparatus 300 shown in FIG. 37, by making the restricting member 302 pivotable around the pivoting shaft 303 relative to the base 301, while maintaining the position of the holder 304 without removing the fixing apparatus 300 from the holder 304, mentioned later, in accordance with the situation of the roof member 7, the position of attaching the fixing apparatus 300 can be adjusted. Further, since a number of parts is small and owing to a simple and convenient constitution, the fixing apparatus can be fabricated inexpensively, a number of attaching steps can be reduced and since the fixing apparatus is light-weighted, the fixing apparatus is easy to handle even above the roof and safe operation can be carried out.

As shown in FIG. 37, the base 301 includes fixing portions 301b for fixing with the roof member at both end portions in the longitudinal direction. Further, the pivoting shaft 303 and the restricting member 302 are provided at a position deviated to one end side in the longitudinal direction of the base 301. Therefore, positions of the fixing portions 301b relative to the roof member are changed before and after pivoting the base 301 by 180 degrees relative to the restricting member 302. Thereby, two fixed arrangements can be selected without changing the longitudinal direction of the base 301 and therefore, an optimum direction of the base 301 is not changed for fixing the holder 304 and other fixing position can be selected by avoiding an inconvenient fixing position.

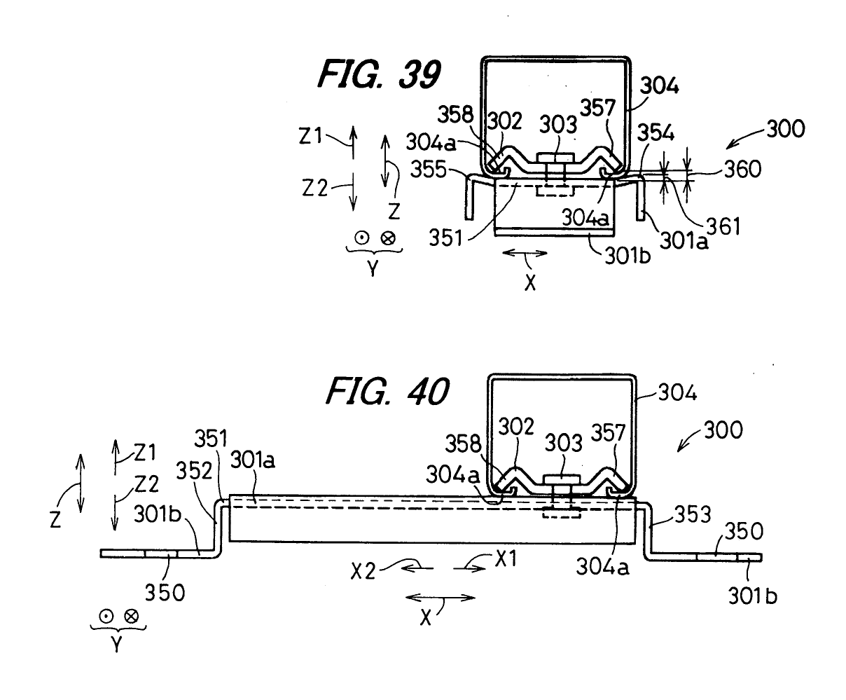

FIGS. 39 and 40 are views showing a state of guiding an elongated holder 304 at the roof holder fixing apparatus 300. FIG. 39 shows a state where longitudinal directions X of the base 301 and the holder 304 are in parallel with each other. Under the state, the holder 304 is not brought into contact with the pressing portion 301a of the base 301 and therefore, the base 301 is brought into a state of being movable in the longitudinal direction X of the holder 304. FIG. 40 shows a state of rotating the base 301 by 90 degrees relative to the restricting member 302 as well as the holder 304 from the movable state centering on the pivoting shaft 303. In the state shown by the drawing, the locking portion 304a of the holder 304 is pressed to the upper side by the pressing portion 301a of the base 301 and therefore, the base 301 is brought into an unmovable state also in the longitudinal direction of the holder 304 by being pinched between the pressing portion 301a and the restricting member 302. That is, there is brought about a state of fixing the holder 304 to the base 301.

Specifically, the base 301 includes a supporting portion 351, a pair of leg portions 352, 353, a fixing portion 301b and a pressing portion 301a. The supporting portion 351 is formed in a plate-like shape and extended in the inclined direction X. The respective leg portions 352, 353 are continuous to both end portions in the inclined direction X of the supporting portion 351 and bent in the other normal direction Z2 from the supporting portion 351. The fixing portion 301b is extended to end portions in the other normal direction Z2 of the respective leg portions 352, 353 and extended in parallel with the supporting portion 351. That is, the supporting portion 351 connects the pair of leg portions 352, 353 and spans the pair of leg portions 352, 353. Further, the fixing portion 301b is formed with a screw hole 350 for fixing to the roof member 7. The pressing portions 301a are provided on both sides in the horizontal direction Y. The pressing portion 301a is formed with pressing portion projected streaks 354, 355 projected from the supporting portion 351 in the upper normal direction Z1 and extended in the inclined direction X. According to the embodiment, the pressing portion projected streaks, 354, 355 are respectively formed on both sides in the horizontal direction Y.

The restricting member 302 is provided rotatably relative to the supporting portion 351 of the base 301. A rotational axis line of the restricting member 302 is provided at a position different from a center position in the inclined direction of the base 301. The restricting member 302 is formed with a restricting main body portion 356 extended in parallel with the supporting portion 351 and restricting portion projected streaks 357, 358 formed on both sides of the restricting main body portion 356. The restricting portion projected streaks 357, 358 are projected from the restricting main body portion 356 in the upper normal direction Z1. According to the embodiment, two of the restricting portion projected streaks 357, 358 are provided and extended respectively previously determined directions. The restricting portion projected streaks 357, 358 are formed to be longer than at least a dimension in the horizontal direction of the pressing portion projected streaks 354, 355.

FIG. 39 and FIG. 40 are views showing the restricting member 302 arranged in a first arranging state relative to the base 301. In the first arranging state, the restricting member 302 is arranged between the pressing portion projected streaks 354, 355 of the pressing portion 301a. At this occasion, the restricting portion projected streaks 357, 358 of the restricting member 302 are extended in parallel with the pressing portion projected streaks 354, 355. The pressing portion projected streaks 354, 355 are formed in a substantially L-like shape, and bent portions thereof are arranged mostly in the upper normal direction Z1 in comparison with remaining portions of the pressing portion projected streaks 354, 355. Similarly, the restricting portion projected streaks 357, 358 are formed in a substantially L-like shape, and bent portions thereof are arranged mostly in the upper normal direction Z1 in comparison with remaining portions of the restricting portion projected streaks 357, 358. Further, at least either of the pressing portion projected streaks 354, 355 and the restricting portion projected streaks 357, 358 are realized by a material having spring performance and flexibility.

As shown in FIG. 39, in the first arranging state, a clearance 360 is formed between the restricting portion projected streaks 357, 358 and the base 301. Further, the pressing portion projected streaks 354, 355 are projected from the supporting portion 351 at a position separated from the supporting portion 351 in the horizontal direction Y by a previously determined amount 361 in the upper normal direction Z1. The holder 304 is formed in an elongated shape and a sectional shape thereof is formed in a substantially U-like shape. Locking portions 304a are respectively formed at both end portions in the sectional shape of the holder 304. The respective locking portions 304a are bent to inner sides of the holder 304 and bent in directions approaching each other. Further, as shown in FIG. 39, in a state in which the restricting member 302 is arranged in the first aligning state, the locking portion 304a of the holder 304 is formed to be capable of being inserted between the restricting member 302 and the supporting portion 351 of the base 301. That is, in the first arranging state, the clearance 360 formed between the restricting portion projecting streaks 357, 358 and the base 301 is formed to be larger than a dimension in the normal direction of the locking portion 304a. Thereby, the holder 304 is locked displaceably in the inclined direction X.

Further, when the base 304 is relatively angularly displaced from the first arranging state relative to the restricting member 302, as shown in FIG. 40, the restricting member 302 is brought into a second arranging state. In the second arranging state, the interval between the pressing portion projected portions 354, 355 and the restricting member 302 becomes smaller than the dimension in the normal direction Z of the locking portion 304a. Therefore, as shown in FIG. 40, in the first arranging state, in a state in which the holder 304 is locked by the restricting member 302, in shifting to the second aligning state, the locking portion 304a of the holder 304 is pinched by the restricting member 302 and the locking portion projected portion 354, 355. Thereby, displacement of the holder 304 is hampered.

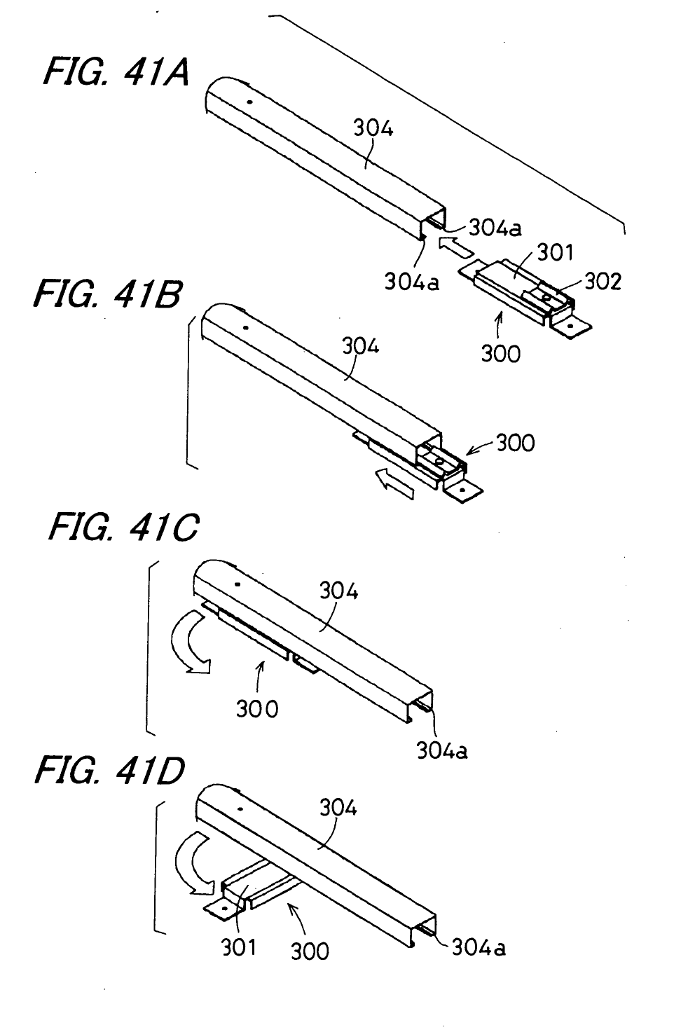

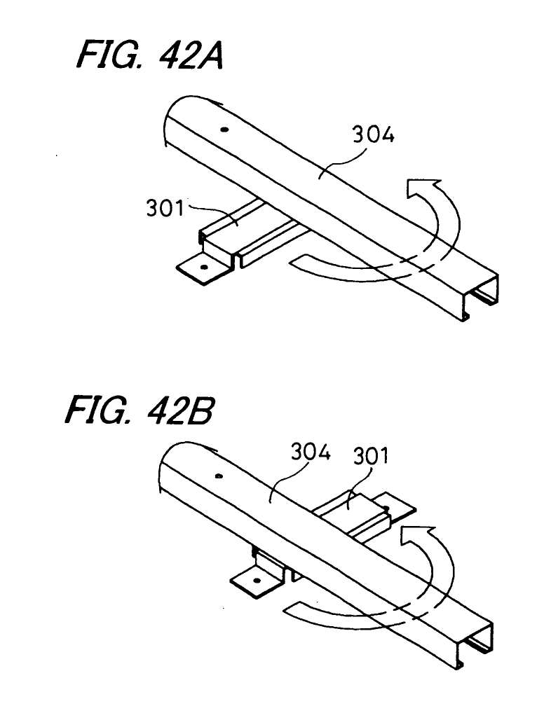

FIGS. 41A, 41B, 41C and 41D show a procedure of adjusting the position of the holder fixing apparatus 300 to fix to the holder 304. As shown in FIG. 41A, longitudinal directions of the base 301 and the restricting member 302 of the fixing apparatus 300 are set to be in parallel with each other in the first state and as shown in FIG. 41B, the base 301 is inserted such that the locking portion 304a of the holder 304 passes a clearance between the base 301 and the restricting member 302 of the holder fixing apparatus 300 for the roof. Next, as shown in FIG. 41C, after inserting the holder fixing apparatus 300 for roof to a position of fixing the holder 304, as shown in FIG. 41D, the base 301 is rotated to a position orthogonal to the holder 304. At this occasion, when the fixing apparatus cannot be attached to the roof face by interference with a stepped difference of the roof member in the direction of FIG. 41D, as shown in FIGS. 42A and 42B, the position of attaching the roof face may be changed by rotating the base 301 by 180 degrees.

An explanation will be given in reference to FIG. 37 in order to explain in further details the structure of attaching the holder fixing apparatus 300 for the roof according to the embodiment. The holder fixing apparatus 300 for the roof is constituted by the base 301, the restricting member 302 and the pivoting shaft 303 and the locking portion 304a of the holder 304 is pinched at a clearance between the pressing portion 301a and the restricting member 302 of the base 301. The base 301 is attached to the roof board 9 and the rafter 10 by the attaching screw 8 by penetrating the roof member 7 via the seal member 6. The holder 304 is mounted with a mounting piece 310 and 320 of the solar cell module 11 and 23 in a vertical direction and fixed to the holder 304 by the fixing screw 312 via the fixing cover 311 from an upper face thereof.

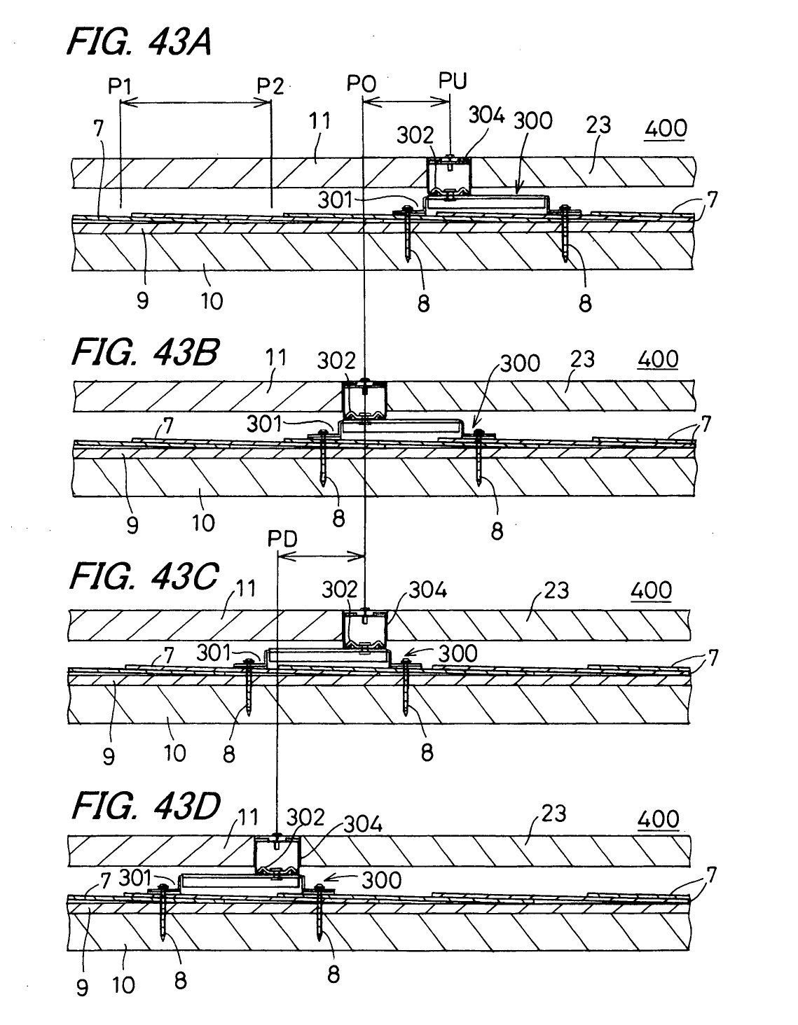

FIGS. 43A, 43B, 43C and 43D are views for explaining a positional relationship between a stepped difference of the roof member 7 and the holder and a direction of the holder fixing apparatus 300 of the roof. As shown in FIG. 43A, according to the roof member 7 arranged above the roof board 9, adjacent ones of the roof members are brought into a state of overlapping tiles and when the holder fixing apparatus 300 for the roof is fixed, it is not preferable to arrange the fixing portion of the holder fixing apparatus 300 for the roof at the stepped difference since the holder fixing apparatus 300 for the roof is not stabilized. Further, similarly, even when a hole for the attaching screw 8 is provided at a vicinity of an end portion of the roof member 7, there poses a problem that the roof member 7 is easy to destruct. Further, it cannot be predicted at which position on the roof the holder 304 is arranged. Hence, when the holder 304 is disposed within a range shown in FIGS. 43A and 43B, the base 301 of the holder fixing apparatus 300 for the roof can be attached to avoid the stepped difference of the roof member by directing the base 301 in a direction of being extended to the house side 400 relative to the holder 304, and a range from PO to PU on the house side can be covered. Further, when the holder 304 is disposed in a range shown in FIGS. 43C and 43D, the base 301 of the holder fixing apparatus 300 for the roof can be attached to avoid the stepped difference of the roof member by directing the base 301 in a direction extended to the eaves the relative to the holder 304 and a range from PO to PD can be covered. Thereby, a range of the roof member 7 from a tile overlapping portion P1 to a next tile overlapping portion P2 can be covered. Further, when the holder 304 is disposed on the house side 400 of that in FIG. 43A, the holder 304 can be attached to avoid the stepped difference of the roof member 7 in a state similar to that in FIG. 43D and therefore, even when the holder is disposed at any position, by selecting the direction of the base 301 by repeating the above-described state, the holder fixing apparatus 300 for the roof can be attached to the roof face by avoiding the stepped difference of the roof member. Further, any of cases of FIG. 43B and FIG. 43C may be selected.

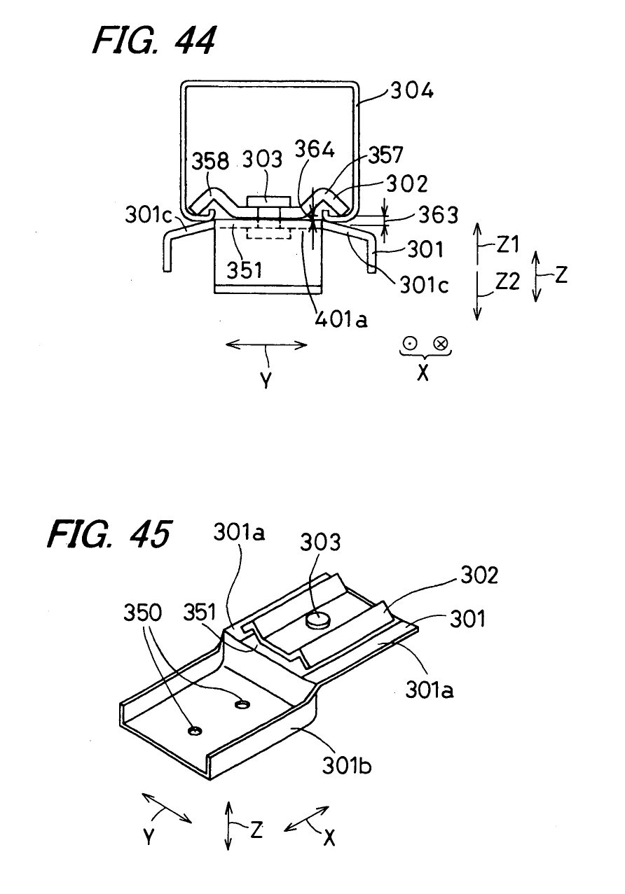

Meanwhile, the above-described holder fixing apparatus 300 for the roof may be constituted by a structure including a pressing portion 401a of a projected streak at a center of the base 301 as shown in FIG. 44 other than the structure shown in FIG. 37. Further, as fixing means for fixing the holder 304, not only the pressing portion 301a of the projected streak but also a projection or other means can pertinently be used.

In this way, according to the embodiment, in the second arranging state, there may be constructed a constitution of pinching the locking portion 304a of the holder 304 from both sides by the base 301 and the restricting member 302. Describing specifically the constitution of FIG. 44, the base 301 is formed with an inclined side portion 301c in place of the restricting portion 301a. The inclined side portions 301c are provided on both sides in the horizontal direction Y of the supporting portion 351 and extended in the inclined direction X. The inclined side portion 301c is extended to be inclined to the lower normal direction Z2 as proceeding from the supporting portion 351 to an outer side in the horizontal direction.

As shown in FIG. 44, in the first arranging state, the restricting portion projected streaks 357, 358 of the restricting member 302 are opposed to the inclined side portions 301c. A clearance 363 is formed between the restricting portion projected streaks 357, 358 and the inclined side portions 301c and the clearance is formed to be larger than the dimension in the normal direction of the locking portion 304a of the holder 304. Thereby, the holder 304 is mounted to the base displaceably in the inclined direction X.

In shifting to the second arranging state, the restricting portion projected streaks 357, 358 are opposed to the supporting portion 351. A clearance between the restricting portion projected streaks 357 and 358 and the supporting portion 351 is formed to be smaller than the dimension 364 in the normal direction of the locking portion 304a of the holder 304. Therefore, in shifting to the second arranging state in the state of mounting the holder 304, the holder 304 is pinched by the restricting portion projected streaks 357, 358 and the supporting portion 351. Thereby, the displacement of the holder 304 is restricted. By making the interval between the two members for guiding the holder smaller in the second arranging state than in the first arranging state, by only angularly displacing the holder 304 mounted to the restricting member 302 and the base 301, the state of the holder 304 can be switched to a movable state or a movement hampering state. That is, a member of a bolt or the like is not needed and convenience can be promoted.

Further, in the first arranging state, in a state in which the holder 304 is moved to an arbitrary position relative to the base 301, by shifting to the second arranging state, the holder 304 can be fixed at the arbitrary portion relative to the base 301. At this occasion, by only angularly displacing the holder 304 and the base 301 relative to each other, the holder 304 and the base 301 can be fixed. That is, the holder 304 and the base 301 can be fixed to each other without using a bolt and operability can be promoted.

Further, the apparatus may be constituted by a shape providing a fixing portion 301b for fastening an attaching screw to the roof of the base 301 on one side as shown in FIG. 45. That is, the supporting portion 351 may be cantilevered by a single leg portion.

Next, an explanation will be given of other embodiment of the invention in reference to FIGS. 46A, 46B, 46C and 46D. As shown in FIG. 46A, according to the holder fixing apparatus 300 for the roof, the base 301, the pressing member 316 and the restricting member 302 are overlapped in this order and they are engaged by the pivoting shaft 303 to be brought into a movable state as shown in FIG. 46B at the center of the pivoting shaft 303. The pressing member 316 is provided with two rows of pressing portion projected streaks 316a in a direction orthogonal to the longitudinal direction by interposing the pivoting shaft 303.

Explaining in details, the supporting portion 351 and the pressing member 316 including the pressing portion projected streaks 354, 355 shown in FIG. 37 through FIG. 40 are provided separately from the base 301. The pressing member 316 is interposed between the base 301 and the restricting member 302 and is provided to be angularly displaced around the angular displacement axis line of the restricting member 302 relative to the restricting member 302 and the base 301. Further, the pressing member 316 includes a knob portion 367 other than the supporting portion 351 and the pressing portion projected streaks 354, 355. The knob portion 367 is integrally provided with the supporting portion 351 and the projected portion projected streaks 354, 355 and is projected from the base in a radius direction of the angular displacement axis line.

After inserting the engaging portion 304a of the holder 304 into a clearance between the restricting member 302 and the pressing member 316 of the holder fixing apparatus 300 for the roof up to a position of fixing the holder 304 as shown in FIG. 46C, by pivoting the pressing member 316 by a predetermined angle as shown in FIG. 46D, a pressing portion projected streaks 316a of the pressing member 316 are changed from a direction in parallel with the longitudinal direction of the holder 304 to a direction orthogonal thereto and therefore, at a portion of intersecting the pressing portion projected streaks 316a of the pressing member 316 and the engaging portion 304a of the holder 304, the engaging portion 304a of the holder 304 is pinched between the pressing portion projected streaks 316a of the pressing member 316 and the restricting member 302 and becomes unmovable in the longitudinal direction of the holder 304.

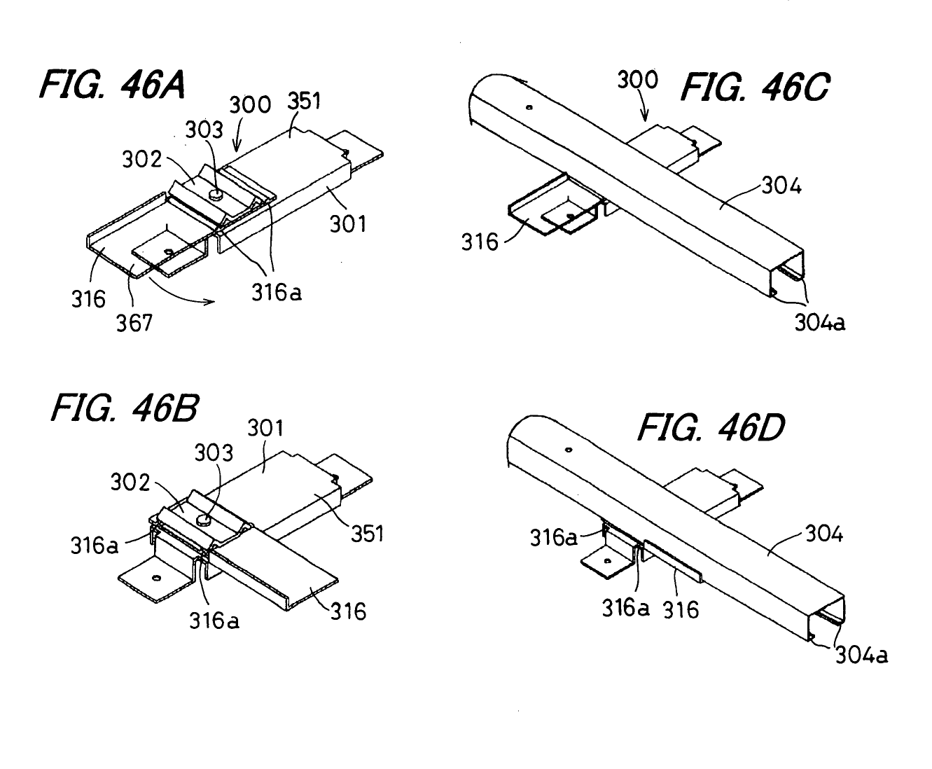

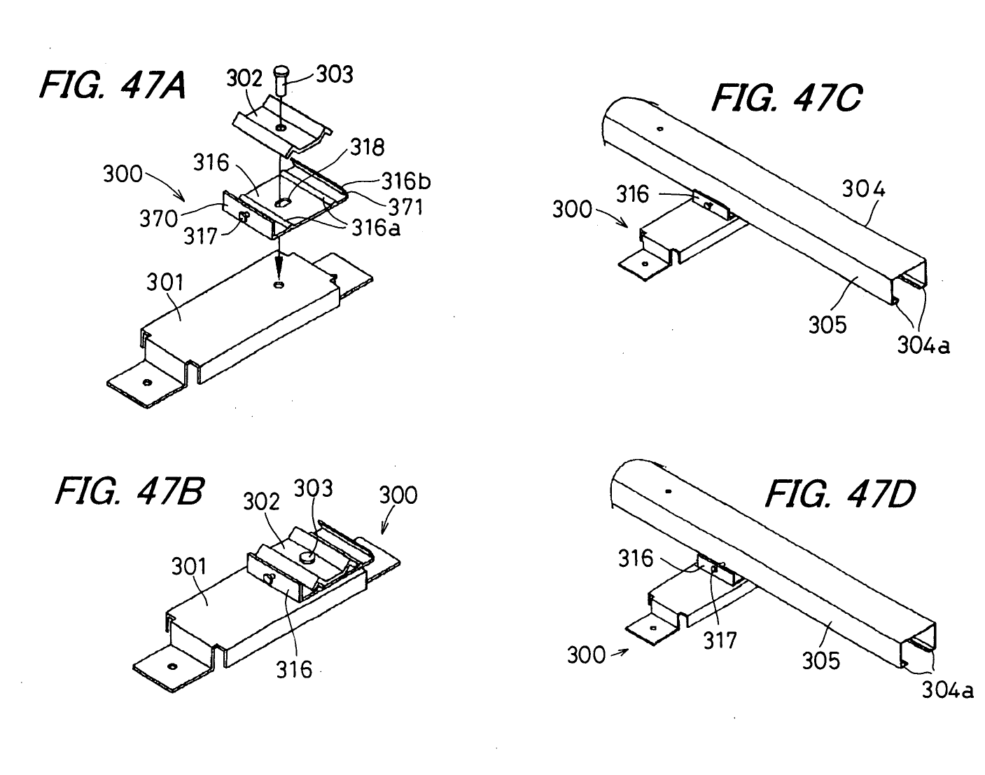

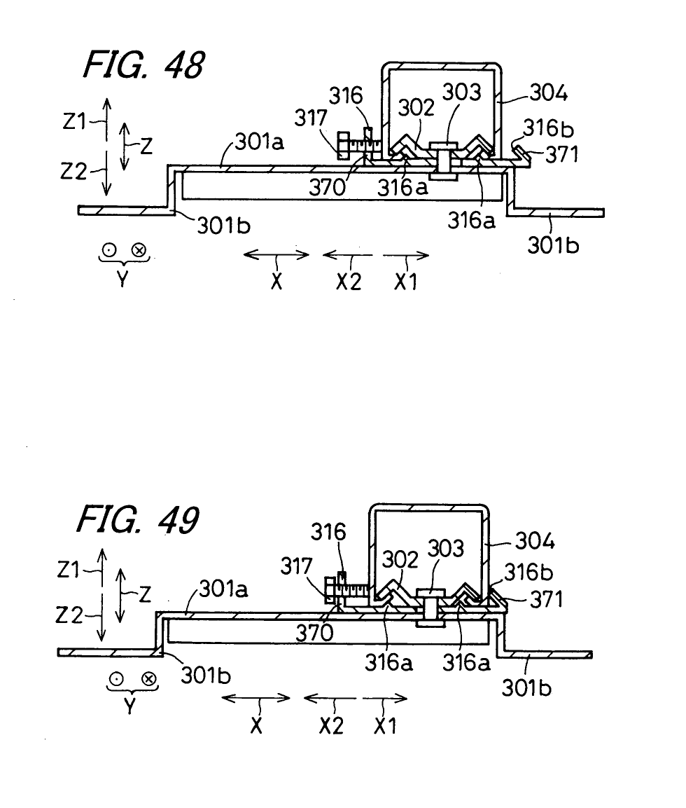

Further, an explanation will be given of other embodiment of the invention in reference to FIGS. 47A, 47B, 47C and 47D. As shown in FIG. 47A, according to the holder fixing apparatus 300 for the roof, the base 301, the pressing member 316 and the base 301 are overlapped in this order and they are engaged by the pivoting shaft 303 to be brought into a movable state at the center of the pivoting shaft 303. As shown in FIG. 47A, the pressing member 316 is provided with two rows of the pressing portion projected streaks 316a in a direction orthogonal to the longitudinal direction by interposing the pivoting shaft 303. Further, the through hole 318 for inserting the pivoting shaft 303 of the pressing member 316 is constituted by an elongated hole and is made to be slidable in the longitudinal direction of the base 301. One of end portions in the longitudinal direction of the pressing member 316 is provided with a contact portion 316b of the first raised piece 371 and other end portion is provided with the second raised piece 370 to be attached with a pressing screw 317. According to the holder fixing apparatus 300 of the roof, by inserting the engaging portion 304a of the holder 304 into the clearance between the restricting member 302 and the pressing member 16 of the holder fixing apparatus 300 for the roof as shown in FIG. 47C to insert into the fixing position and thereafter fastening the pressing screw 317 of the pressing member 316 as shown in FIG. 47D to bring the pressing screw 317 into contact with the holder 304, the pressing portion projected streaks 316a of the pressing member 316 are moved right below the engaging portion 304a of the holder 304, the engaging portion 304a of the holder 304 is pinched between the pressing portion projected streaks 316a of the pressing member 316 and the restricting member 302 and becomes unmovable in the longitudinal direction of the holder 304. Further, it can be prevented in the procedure of fastening the pressing screw 317, that the pressing portion projected streaks 316a of the pressing member 316 is shifted from the engaging portion 304a of the holder 304 by excessively fastening the pressing screw 317 by bringing the contact portion 316b of the pressing member 316 into contact with a side face of the holder 304.

Further, although an explanation has been given of the plurality of embodiments as described above, in the respective embodiments, with regard to constitutions which can be partially used with each other for constituting the fixing apparatus, the fixing apparatus may be realized by combining the respective constitutions of the embodiments. Further, in the specification, the inclined direction X, the horizontal direction Y and the normal direction Z are directions used for facilitating to understand. Therefore, the respective constitutions of the fixing apparatus may be formed in accordance with the first direction in correspondence with the inclined direction X, the second direction in correspondence with the horizontal direction Y and the third direction in correspondence with normal direction Z. Further, the first direction through the third direction may correspond to the inclined direction X, the horizontal direction Y and the normal direction Z in the relationship of directions. That is, the first direction may not be the inclined direction, the second direction may not be the horizontal direction and the third direction may not be the normal direction.

Further, although according to the embodiments, there is a case of explaining the claim as movable in the horizontal direction, the horizontal direction may not be the direction orthogonal to the longitudinal direction of the base but may be a direction intersecting with the longitudinal direction of the base and along the roof face. Further, there is a case in which the holder according to the invention is referred to as a transverse rack and a transverse piece and a transverse holder. Further, although a description has been given of the case of fixing the fixing apparatus to the roof face, the fixing apparatus may be fixed to a building other than the roof.

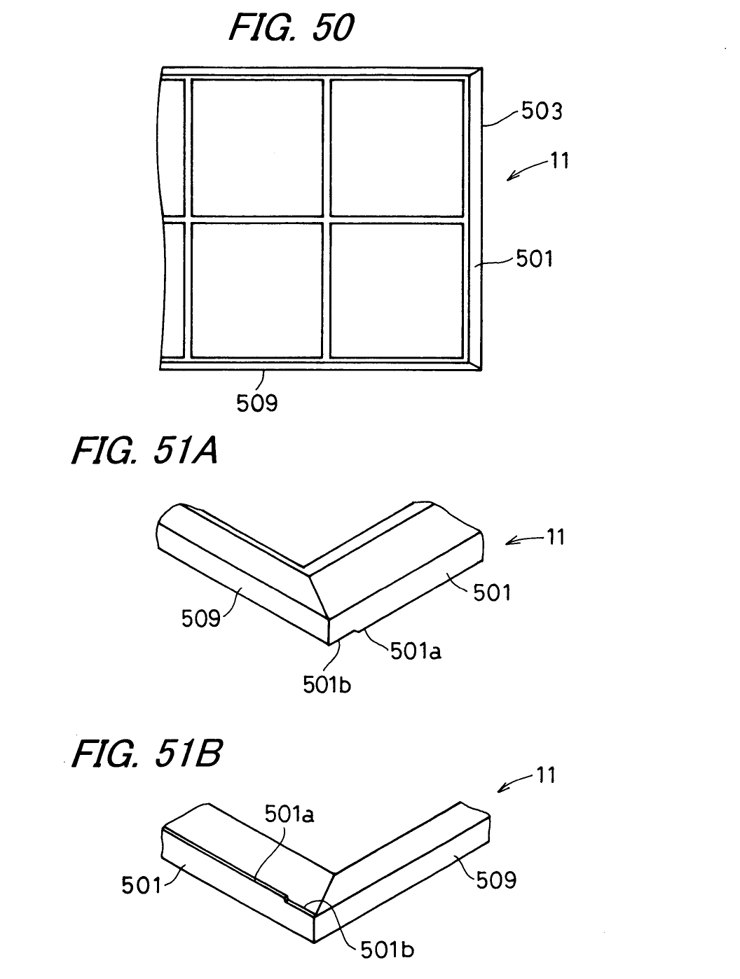

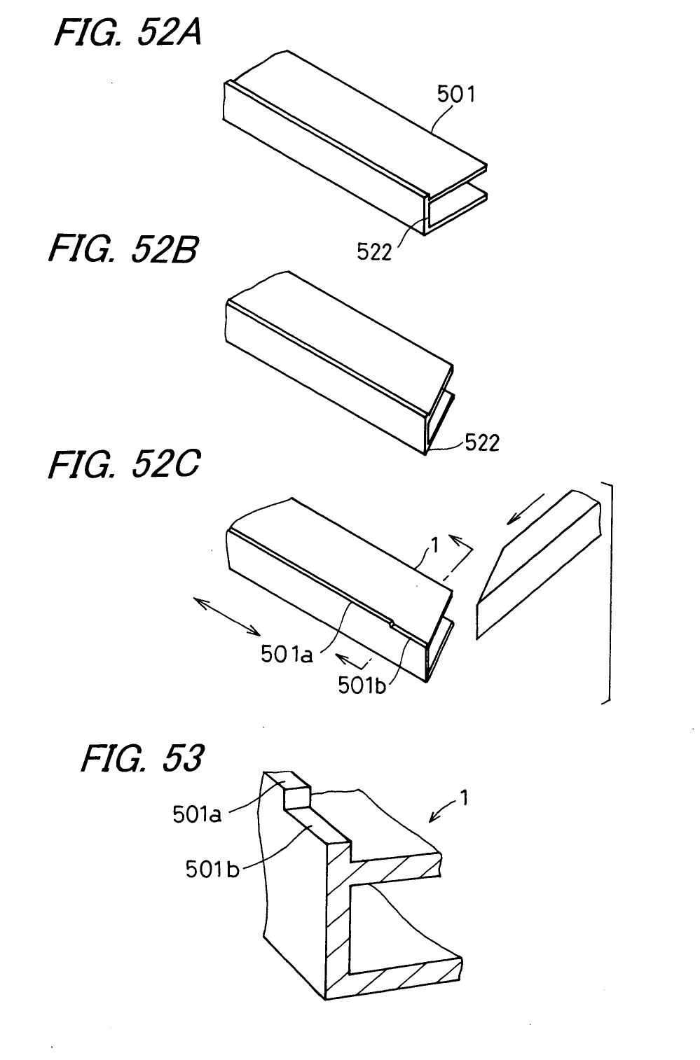

FIG. 50 is a plan view showing the solar cell module 11 of the invention and FIGS. 51A and 51B are enlarged perspective views showing a portion thereof. The solar cell module 11 is constituted by combining a short side frame 501 and a long side frame 509 comprising metal frames 501 and 509 surfaces of which are covered with an insulating coating except portions thereof at a peripheral edge portion of the solar cell main body constituting a rectangular shape in plan view, a projected portion 501a is provided at a lower face of the short side frame 501 and a contact portion 501b exfoliating a portion of the surface treatment by the insulating coating is constituted by polishing a portion thereof mounted on the holder which is a grounded holding member. That is, the metal frame 501 and 509 is mounted above a conductor of the holder in a state of being brought into contact therewith, faces on the side for mounting the metal frames 501 and 509 are formed in shapes of stepped differences and at the metal frame, a surface thereof excluding at least a face on a side of being brought into contact with the holder is covered with the insulating coating.

FIG. 51A shows a behavior of viewing the projected portion 501a and the contact portion 501b from the rear face of the solar cell module. Further, a thickness of the long side frame 509 is smaller than that of the short side frame 501 by an amount of eliminating the projected portion 501a and when the contact portion 501b is constituted by polishing the projected portion 501a of the short side frame 501, the contact portion 501b is projected to be higher than at least the long side frame 509.

As shown in FIG. 6, the solar cell module is fixed on the roof face by each fixing apparatus mentioned above. With reference to FIG. 6, the fixing cover 170 is attached with the fixing screw 171 which can be screwed by a screw hole provided at the holder 85 and the solar cell module 23 is screwed to fix in a state of being inserted between the fixing cover 170 and the holder 85. At this occasion, the contact portions 501b of the short side frames 501 disposed on both ends of the solar cell module 23 are brought into electrically contact with the holder 85 to thereby ground the holder 85. Further, the holder 85 is electrically connected to the roof face directly or indirectly.

Next, an explanation will be given of a behavior of fixing the solar cell module 11 and 23 by the holder 85a and 85b and the fixing apparatus 180a and 180b using FIG. 28. When the solar cell module 11 and 23 is fixed between the holders 85a and 85b attached to the base rail 1 fixed onto the roof, first, the house side peripheral edge portion 92 of the solar cell module 11 is inserted into the opening portion constituting a recess portion constituted by the fixing cover 170b and the holder 85b. Thereafter, the eaves side peripheral edge portion 91 of the solar cell module 11 is inserted into the opening portion constituting the recess portion constituted by the fixing cover 170a and the holder 85a. When the solar cell module is not arranged on the eaves side of the holder 85a at the time point, the pressing screw 171a is fastened.

Thereby, the eaves side peripheral edge portion 91 of the solar cell module 11 is pinched by the fixing cover 170a and the holder 85a to fix. At the same time, the contact portions of the solar cell module 11 and the holders 85a and 85b are pressed to each other and therefore, the short side frame 501 of the solar cell module 11 and the holder 85 are brought into an electrically conducted state and the holder 85a on the eaves side and the holder 85b on the house side are brought into an electrically conducted state.

Meanwhile, when there is the solar cell module 23 to be arranged on the house side of the holder 85b as shown in FIG. 28, by a similar procedure, the house side peripheral edge portion 92 of the solar cell module 11 and the eaves side peripheral edge portion 93 of the solar cell module 23 are pinched by the fixing cover 170b and the holder 85b to fix by inserting the eaves side peripheral edge portion 93 of the solar cell module 23 into the opening portion of the holder 85b and fastening the fastening screw 171b. Thereby, the contact portion of the solar cell module 23 and the holder 85b are pressed to each other and therefore, the short side frame 501 of the solar cell module 23 and the holder 85b are brought into an electrically conducted state.

After finishing arrangement and wiring check of all of the solar cell modules, screws of the fixing covers 170 of the each holders are fastened to fix to thereby finish the solar cell array and simultaneously therewith, the contact portion disposed at the short side frame 501 of the solar cell module and the holder 85 are pressed to each other and therefore, the short side frame 501 of the solar cell module 11 and the holder 85 are brought into an electrically conducted state. The short side frame 501 is mounted over adjacent holders, for example, 85a and 85b and therefore, adjacent ones of the holders 85a and 85b are also brought into the electrically conducted state and all of the holders 85 are brought into the electrically conducted state. Hence, when a portion of any of the holders 85 is grounded, all of the holder 85 can be grounded.

Further, the length of the holder 85 may be further prolonged to be supported by a number of the fixing apparatus 300. Further, the solar cell module 11 and 23 may be started to install from the house side of the roof and may successively be fixed by screws after finishing to arrange the solar cell modules 11 and 23 to the crosspiece. Further, grounding may be carried out after installing the holder or grounding may be carried out from the fixing metal apparatus.

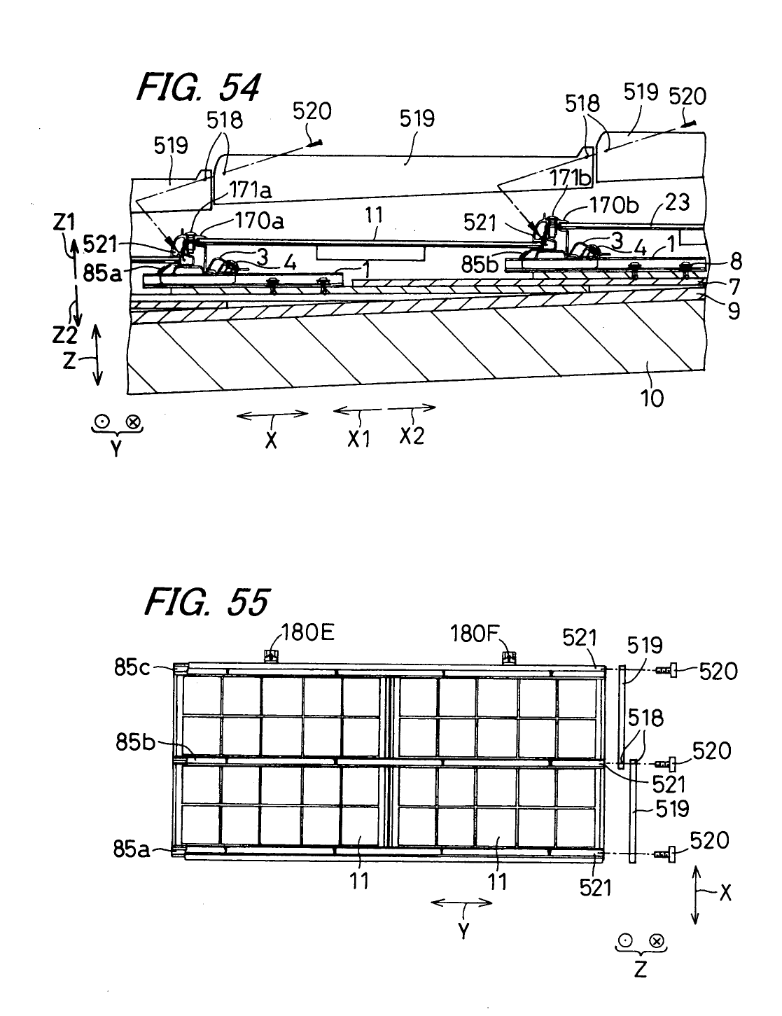

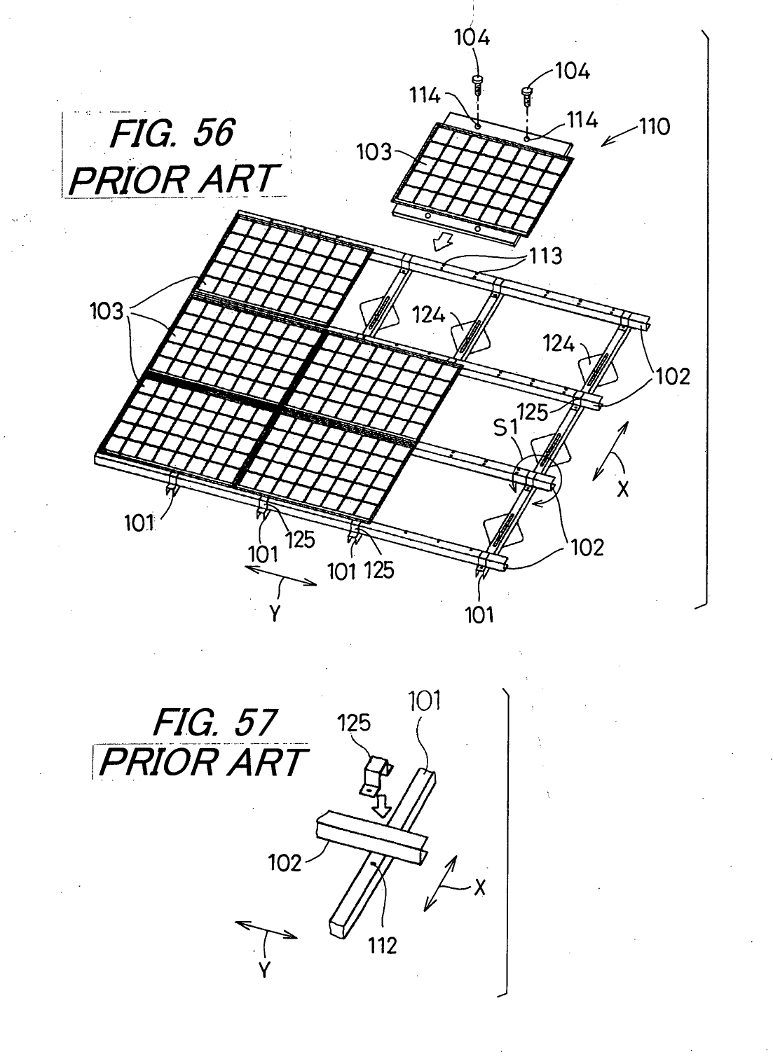

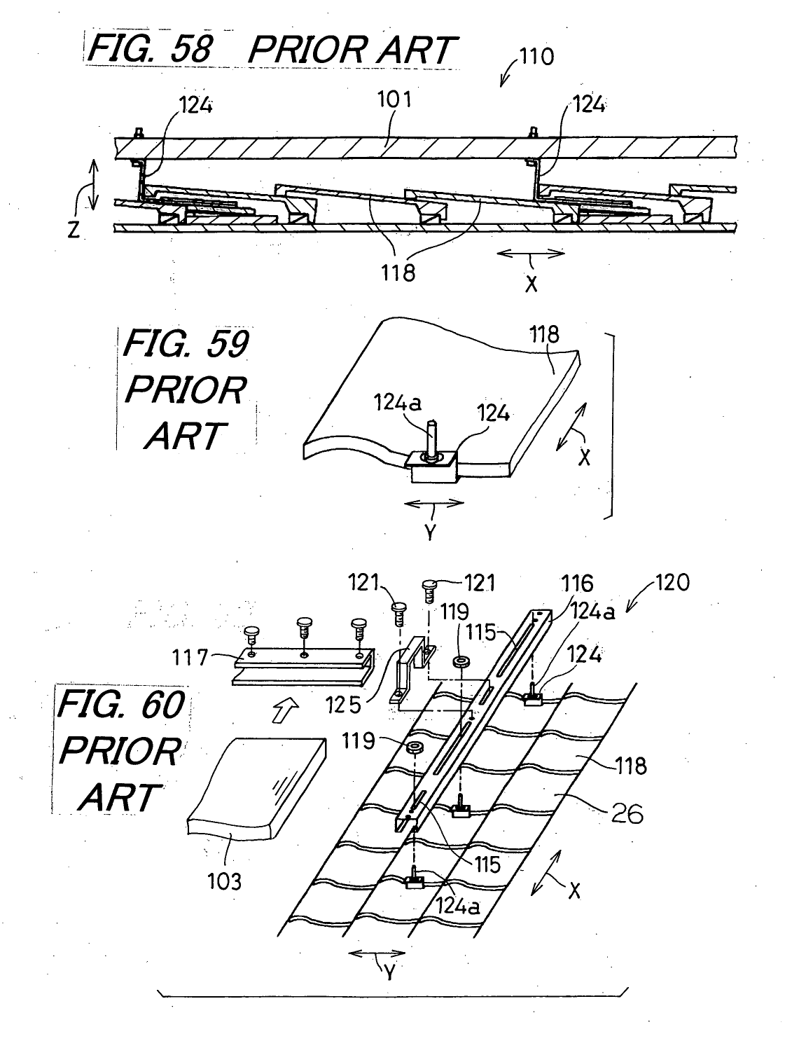

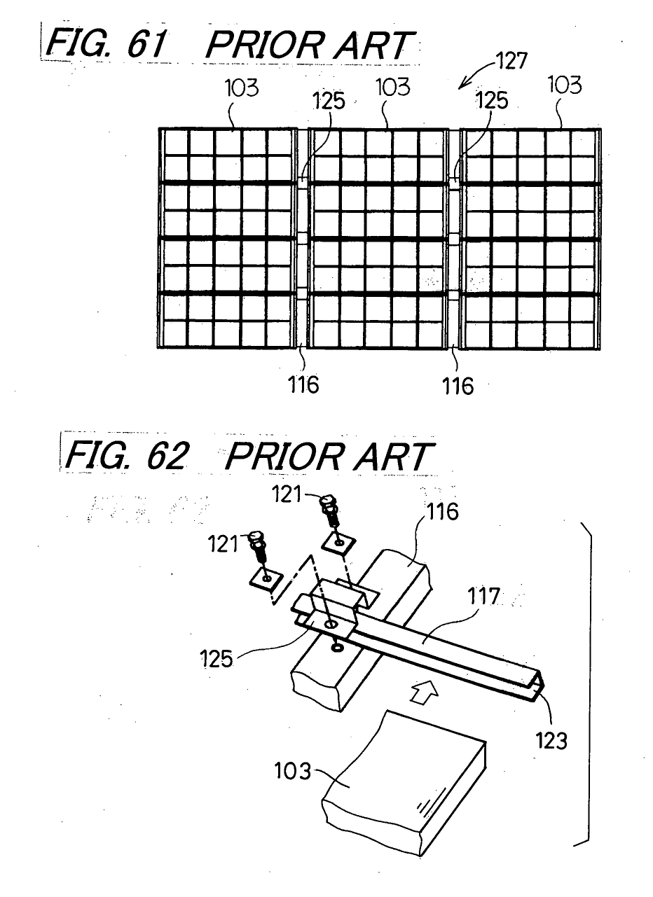

Further, an explanation will be given of an embodiment of a grounding method in which the frame of the solar cell module according to the invention is not utilized in reference to FIGS. 54 and 55. Similar to the above-described embodiment, there is provided the screw hole 521 for attaching the screw to the fixing cover 170 of an installed solar power generation apparatus, and side face covers 519 made of a metal are attached to the fixing covers (for example, 170a, 170b) on the adjacent holders by attaching screw 520, so as to cover the side faces of the solar cell power generation apparatus installed on the roof. At this occasion, when a periphery of the attaching screw hole 518 of the side face cover 519 is not coated, that is, has electrical conductivity, electric conduction is ensured between the fixing covers 170 on the adjacent holders by the side face cover 519 and when a portion of any of the holders 85 is grounded, all of the solar cell modules 11 and 23 and the holders 85 can be grounded. Further, there may be constituted a structure of breaking a coating (the insulating coating) by fastening the attaching screw 520 as in a toothed lock washer even when the attaching screw hole 521 is coated.

Thereby, even when the short side frames 501 and the long side frames 509 of the solar cell modules 11 and 23 are constituted by a resin or a nonconductive material, not only all of the solar cell modules 11 and 23 and the holders 85 can be grounded but also there can be provided a function of promoting an appearance of the solar power generation apparatus and preventing birds or the like from invading below the solar cell module 11 and 23.

Further, although according to the embodiment, there is provided the solar power generation apparatus arranging the plurality of holders in the house-eaves direction of the inclined roof substantially in parallel with each other, mounting each of the house side and the eaves side of the solar cell modules in the shape of the flat plate having the metal frames above each of holders disposed on the house side and on the eaves side and containing each of the house side and the eaves side of the solar cell modules to each of two recess portions formed by the holders and the fixing covers 170 covering the holders, particularly comprising fastening means 171 for pressing the solar cell modules 11 and 23 mounted above the holders between the fixing covers 170 and the holders, the invention is not limited thereto but pertinent methods and constitutions can be adopted in a range not deviated from the gist of the invention.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

What is claimed is:

1. A fixing apparatus for fixing an object to be installed which is installed to a building, comprising:
a base connected to the building and formed in an elongated shape;
a support member formed to be movable in a first direction constituting a longitudinal direction of the base by being guided by the base;
a holder formed to be movable in a second direction intersecting with the first direction by being guided by the support member, for holding the object to be installed; and
a displacement hampering member capable of hampering displacement of the support member relative to the base and displacement of the holder relative to the support member.

2. The fixing apparatus of claim 1, wherein the displacement hampering member fixes the holder to the base by pressing a portion of the holder against the base.

3. The fixing apparatus of claim 1, wherein the displacement hampering member is connected to the support member and the holder is pinched by the base and the support member by pressing a portion of the holder against the base.

4. The fixing apparatus of claim 1, wherein peripheral edge portions on both sides of the object to be installed can respectively be held by two of the holders respectively provided with an interval therebetween.

5. The fixing apparatus of claim 1, further comprising an installed object fixing member capable of fixing the object to be installed to the holder.

6. The fixing apparatus of claim 1, further comprising an installed object fixing member for fixing the object to be installed to the holder,
wherein the fixing member comprises a cover member brought into contact with the object to be installed from a side opposed to the holder and a pressing member for pressing the cover member to the holder.

7. The fixing apparatus of claim 1, wherein the holder is formed with a mounting portion for mounting the object to be installed and a connecting portion provided on a side of the building of the mounting portion and connected to the support member.

8. The fixing apparatus of claim 1, wherein the support member is formed with a supporting-member engaging portion in a rail-like shape extended in the second direction, the holder is formed with a holder engaging portion in a rail-like shape provided on a side of the building thereof and engaged with the supporting-member engaging portion and the supporting-member engaging portion and the holder engaging portion are engaged with each other.

9. The fixing apparatus of claim 1, wherein the base comprises:
a base fixing portion fixed to the building;
a base moving portion provided to be movable in the first direction relative to the base fixing portion by being guided by the base fixing portion and connecting the support member; and
a base coupling portion capable of hampering displacement of the base moving portion relative to the base fixing portion.

10. A fixing apparatus for fixing an object to be installed which is installed to a building, comprising:
a base connected to the building;
a holder directly or indirectly connected to the base and mounting the object to be installed;
a cover member pinching the object to be installed in cooperation with the holder;
a screwing member formed to be screwable to the holder for generating a press force for pressing the cover member to the holder by screwing to the holder; and
an interval adjusting member for screwing to retract the screwing member from the holder and moving the cover member to separate from the holder.

11. The fixing apparatus of claim 10, wherein the interval adjusting member maintains an interval between the cover member and the holder before pressing the cover member by the screw member wider than an interval therebetween after pressing the cover member.

12. The fixing apparatus of claim 10, wherein the interval adjusting member comprises a spring member exerting a force in a direction opposed to a direction of the press force on the cover member.

13. The fixing apparatus of claim 10, wherein the cover member is formed with a contact portion brought into contact with the object to be installed mounted on the holder in a state of separating from the holder to restrain the object to be installed from moving.

14. The fixing apparatus of claim 10, wherein the interval adjusting member is brought into contact with both of the holder and the cover member to electrically connect the holder and the cover.

15. A fixing apparatus for fixing an object to be installed which is installed to a building, comprising:
a base connected to the building;
a holder directly or indirectly connected to the base for mounting the object to be installed;
a cover member for pinching the object to be installed in cooperation with the holder; and
a screw member formed to be screwable to the holder for generating a press force for pressing the cover member to the holder by screwing to the holder,
wherein the cover member is mounted to the holder in a temporarily fixing state of capable of temporarily fixing the object to be installed in cooperation with the holder.

16. The fixing apparatus of claim 15, wherein in a state of being formed to be able to pinch two of the objects to be installed respectively on both sides in a vertical direction by the holder and the cover member and holding the two objects to be installed,
the holder is formed with a lower side mounting face for mounting an upper side peripheral edge portion of the lower side object to be installed disposed on a lower side, an upper side mounting face mounting a lower side peripheral edge portion of the upper side object to be installed disposed on an upper side and provided to be higher than the lower side mounting face, and a screw forming portion rising above the lower side mounting face continuously from the upper side mounting face and formed with a screw hole for screwing to a screw member,
the cover member is formed with a lower side press piece for pressing the upper side peripheral edge portion of the lower side object to be installed from an upper side and an upper side press piece for pressing the lower side peripheral edge portion of the upper side object to be installed from the upper side and provided on an upper side of the lower side press piece, and
the cover member can be fixed to the holder by pressing the lower side press piece against the lower side mounting face of the holder by a front end portion of the screw member in a state of capable of mounting the peripheral edge portions of the respective objects to be installed to the respective mounting faces of the holder, when a state of fixing the cover member is released by loosening the screw member, and the peripheral edge portions of the objects to be installed can be brought into a state of being able to be pressed by the cover member and the peripheral edge portions of the objects to be installed can be pressed by the cover member by fastening the screw member in the pressable state.

17. The fixing apparatus of claim 15, wherein the cover member is formed with a stopper portion for positioning the object to be installed.

18. The fixing apparatus of claim 15, wherein the screw member is formed with an unscrewed groove forming portion interposed by screwed groove forming portions in a front and rear direction.

19. The fixing apparatus of claim 15, wherein a front end portion of the screw member is formed to be larger than a remaining portion in a state of being screwed to the holder.

20. The fixing apparatus of claim 15, wherein the peripheral edge portions on the both sides of the object to be installed are respectively held by two of the holders respectively provided with an interval therebetween.

21. A fixing apparatus for fixing an object to be installed which is installed to a building, comprising:
a base connected to the building;
a guide member provided to be able to angularly displace around a predetermined angular displacement axis line relative to the base; and
a holder formed to be movable by being guided by the guide member, for holding the object to be installed.

22. The fixing apparatus of claim 21, wherein when the holder is guided by the guide member while maintaining a position of the holder, by angularly displacing the base relative to the guide member around the angular displacement axis line, a position of fixing the base relative to the building can arbitrarily be determined.

23. The fixing apparatus of claim 21, wherein a position of fixing the building and the base is changed between before and after pivoting the base by 180 degrees around the angular displacement axis line relative to the guide member.

24. The fixing apparatus of claim 21, wherein the angular displacement axis line is provided at a position other than a middle position in the longitudinal direction of the base.

25. The fixing apparatus of claim 21, wherein the base is provided with a pressing member for restricting displacement of the holder relative to the guide member by pressing the holder and the guide member when an angle made by the longitudinal direction of the base and the longitudinal direction of the holder is shifted by a predetermined angle or more.

26. The fixing apparatus of claim 21, further comprising a pressing member for restricting displacement of the holder relative to the guide member by pressing the holder and the guide member when an angle made by the longitudinal direction of the base and the longitudinal direction of the holder is shifted by a predetermined angle or more,
wherein the pressing member is interposed between the base and the guide member and when the pressing member is moved by the predetermined angle relative to the longitudinal direction of the holder, the holder is fixed to the guide member.

27. The fixing apparatus of claim 21, further comprising a pressing member for restricting displacement of the holder relative to the guide member by pressing the holder and the guide member when an angle made by the longitudinal direction of the base and the longitudinal direction of the holder is shifted by a predetermined angle or more,
wherein the pressing member is interposed between the base and the support member and when the pressing member is moved in a predetermined direction relative to the holder, the holder is fixed to a guide member.

28. The fixing apparatus of claim 21, further comprising a pressing member for restricting displacement of the holder relative to the guide member by pressing the holder and the guide member when an angle made by the longitudinal direction of the base and the longitudinal direction of the holder is shifted by a predetermined angle or more,
wherein the pressing member is formed with a projected streak portion.

29. The fixing apparatus of claim 21, further comprising a pressing member for restricting displacement of the holder relative to the guide member by pressing the holder and the guide member when an angle made by the longitudinal direction of the base and the longitudinal direction of the holder is shifted by a predetermined angle or more,
wherein the pressing member is interposed between the base and the guide member and is formed with a projected streak portion.

30. The fixing apparatus of claim 21, wherein the peripheral edge portions on the both sides of the object to be installed are respectively held by two of the holders respectively provided with an interval therebetween.

31. The fixing apparatus of claim 1, further comprising a side face cover member for covering side faces of the object to be installed and the holder,
wherein the side face cover member is brought into contact with the object to be installed to ground the object to be installed.

32. The fixing apparatus of claim 10, further comprising a side face cover member for covering side faces of the object to be installed and the holder,
wherein the side face cover member is brought into contact with the object to be installed to ground the object to be installed.

33. The fixing apparatus of claim 15, further comprising a side face cover member for covering side faces of the object to be installed and the holder,
wherein the side face cover member is brought into contact with the object to be installed to ground the object to be installed.

34. The fixing apparatus of claim 21, further comprising a side face cover member for covering side faces of the object to be installed and the holder,
wherein the side face cover member is brought into contact with the object to be installed to ground the object to be installed.

35. The fixing apparatus of claim 1, wherein a portion brought into contact with the holder of the object to be installed is formed to be electrically conductive.

36. The fixing apparatus of claim 10, wherein a portion brought into contact with the holder of the object to be installed is formed to be electrically conductive.

37. The fixing apparatus of claim 15, wherein a portion brought into contact with-the holder of the object to be installed is formed to be electrically conductive.

38. The fixing apparatus of claim 21, wherein a portion brought into contact with the holder of the object to be installed is formed to be electrically conductive.

39. A solar cell module installed to a building, comprising:
a solar cell main body; and
a metal frame mounted to a peripheral edge portion of the solar cell main body,
wherein the metal frame makes the solar cell module and a holder conductive to each other by being brought into contact with a portion installed with the holder of the fixing apparatus of claim 1 and a surface thereof excluding a face thereof on a side of being brought into contact with the holder is covered with an insulating coating.

40. A solar cell module installed to a building, comprising:
a solar cell main body; and
a metal frame mounted to a peripheral edge portion of the solar cell main body,
wherein the metal frame makes the solar cell module and a holder conductive to each other by being brought into contact with a portion installed with the holder of the fixing apparatus of claim 10 and a surface thereof excluding a face thereof on a side of being brought into contact with the holder is covered with an insulating coating.

41. A solar cell module installed to a building, comprising:
a solar cell main body; and
a metal frame mounted to a peripheral edge portion of the solar cell main body,
wherein the metal frame makes the solar cell module and a holder conductive to each other by being brought into contact with a portion installed with the holder of the fixing apparatus of claim 15 and a surface thereof excluding a face thereof on a side of being brought into contact with the holder is covered with an insulating coating.

42. A solar cell module installed to a building, comprising:
a solar cell main body; and
a metal frame mounted to a peripheral edge portion of the solar cell main body,
wherein the metal frame makes the solar cell module and a holder conductive to each other by being brought into contact with a portion installed with the holder of the fixing apparatus of claim 21 and a surface thereof excluding a face thereof on a side of being brought into contact with the holder is covered with an insulating coating.

43. A fixing apparatus for fixing an object to be installed which is installed to a building, comprising:
a base connected to the building and formed in a shape of an elongated rail;
a support member formed to be movable in a first direction previously determined at the base by being guided by the base;
a holder formed to be movable in a second direction intersecting with the first direction by being guided by the support member, for holding the object to be installed;
a displacement hampering portion for hampering displacement of the support member relative to the base and displacement of the holder relative to the support member;
a cover member for pinching the object to be installed in cooperation with the holder;
a screw member formed to be screwable to the holder for generating a press force for pressing the cover member to the holder by screwing to the holder; and
an interval adjusting member for screwing to retract the screw member from the holder and moving the cover member to separate from the holder.

44. A fixing apparatus for fixing an object to be installed which is installed to a building, comprising:
a base connected to the building and formed in a shape of an elongated rail;
a support member formed to be movable in a first direction previously determined at the base by being guided by the base;
a holder formed to be movable in a second direction intersecting with the first direction by being guided by the support member, for holding the object to be installed;
a cover member for pinching the object to be installed in cooperation with the holder; and
a screw member formed to be screwable to the holder, for generating a press force for pressing the cover member to the holder by screwing to the holder,
wherein the cover member is mounted to the holder in a temporarily fixing state of capable of temporarily fixing the object to be installed in cooperation with the holder.

45. A fixing apparatus for fixing an object to be installed which is installed to a building, comprising:
a base connected to the building;
a holder supported by the base and formed to be movable in a horizontal direction, for holding the object to be installed; and
a displacement hampering member capable of hampering the holder from being displaced relative to the base and the holder from being displaced relative to a support member.
